(19) United States
(12) Patent Application Publication
(10) Pub. No.: US 2003/0233278 A1
(43) Pub. Date: Dec. 18, 2003

(54) Method and system for tracking and providing incentives for tasks and activities and other behavioral influences related to money, individuals, technology and other assets

(76) Inventor: T. Thaddeus Marshall, Medford, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/375,460

(22) Filed: Feb. 27, 2003

Related U.S. Application Data
(63) Continuation-in-part of application No. 09/722,904, filed on Nov. 27, 2000.
(63) Continuation-in-part of application No. 10/047,426, filed on Jan. 14, 2002.
(60) Provisional application No. 60/360,347, filed on Feb. 27, 2002.
(60) Provisional application No. 60/361,794, filed on Mar. 5, 2002.
(60) Provisional application No. 60/364,237, filed on Mar. 13, 2002.
(60) Provisional application No. 60/364,448, filed on Mar. 14, 2002.
(60) Provisional application No. 60/370,518, filed on Apr. 4, 2002.
(60) Provisional application No. 60/394,827, filed on Jul. 9, 2002.
(60) Provisional application No. 60/403,166, filed on Aug. 13, 2002.
(60) Provisional application No. 60/413,270, filed on Sep. 24, 2002.
(60) Provisional application No. 60/414,860, filed on Sep. 30, 2002.
(60) Provisional application No. 60/416,135, filed on Oct. 3, 2002.
(60) Provisional application No. 60/416,288, filed on Oct. 4, 2002.
(60) Provisional application No. 60/418,413, filed on Oct. 15, 2002.
(60) Provisional application No. 60/421,170, filed on Oct. 25, 2002.
(60) Provisional application No. 60/422,042, filed on Oct. 28, 2002.
(60) Provisional application No. 60/427,787, filed on Nov. 19, 2002.
(60) Provisional application No. 60/429,596, filed on Nov. 26, 2002.
(60) Provisional application No. 60/430,542, filed on Dec. 2, 2002.
(60) Provisional application No. 60/433,921, filed on Dec. 16, 2002.
(60) Provisional application No. 60/439,306, filed on Jan. 9, 2003.

(51) Int. Cl. G06F 17/60

(52) U.S. Cl. 705/14

(57) ABSTRACT

Methods and systems for altering behavior in a variety of applications include recording information associated with an event related to a particular activity or field, determining a status of the event in connection with a rewards algorithm, calculating reward information in accordance with the rewards algorithm, and storing the calculated reward information. A recipient is notified in accordance with a notification algorithm of the calculated reward information. Incentives may be provided for participation in services plans, including professional services plans such as legal plans, adoption and use of types of funds, accounts and funds transfers, use of online services, and numerous other services. Rewards include the receipt of professional services and membership in services plans. Incentives for entering into transactions include offering of related services, including identity theft related services for events related to the transaction. Methods and systems for entering transactions include receiving first transaction request information from a transaction party in a first mode, prompting the transaction party for second transaction request information to be provided in a second mode, if the second transaction information is received in a suitable manner, then entering into the transaction, and otherwise terminating the transaction.

### RELATED APPLICATIONS

This application is a continuation-in-part of my co-pending U.S. patent application Ser. No. 09/722,904, filed on Nov. 27, 2000, and my co-pending U.S. patent application Ser. No. 10/047,426 filed on Jan. 14, 2002, and claims priority from my U.S. Provisional Patent Application No. 60/360,347, filed Feb. 27, 2002, No. 60/361,794, filed Mar. 5, 2002, No. 60/364,237, filed Mar. 13, 2002, No. 60/364,448, filed Mar. 14, 2002, No. 60/370,518, filed Apr. 4, 2002, No. 60/394,827, filed Jul. 9, 2002, No. 60/403,166, filed Aug. 13, 2002, No. 60/413,270, filed Sep. 24, 2002, No. 60/414,860, filed Sep. 30, 2002, No. 60/416,135, filed Oct. 3, 2002, No. 60/416,288, filed Oct. 4, 2002, No. 60/418,413, filed Oct. 14, 2002, No. 60/412,170, filed Oct. 25, 2002, No. 60/422,042, filed Oct. 28, 2002, No. 60/427,787, filed Nov. 19, 2002, No. 60/429,596, filed Nov. 26, 2002, No. 60/430,542 filed Dec. 2, 2002, No. 60/433,921, filed Dec. 16, 2002 and No. 60/439,306 filed Jan. 9, 2003, all of which applications are hereby incorporated by reference herein in their entireties.

### FIELD OF THE INVENTION

This invention is in the field of incentive reward programs.

### BACKGROUND OF THE INVENTION

A wide variety of alterations and modifications of behavior would be desirable in various fields. These fields include those as diverse as commercial transactions, employment relationships, national security, volunteering and other areas. Existing incentives, such as payment for services, charges for late payment, feelings of having contributed to a cause, fail to provide sufficient incentives. Behavior of individuals and organizations is best altered when desirable behavior is rewarded, and/or undesirable behavior results in a loss. Behavior is also best altered when each element of conduct can be evaluated and either rewarded or other responded to. However, existing methods and systems are highly imprecise and fail to provide sufficiently nuanced incentives.

### SUMMARY OF THE INVENTION

These methods and systems referenced and described herein and in previous patent applications are designed to influence behaviors related to the performance of various tasks and activities including those that are described herein and in previously referenced pending provisional and regular patent applications. These programs are designed to generate one or more benefits and efficiencies for one or more participants and/or for others and for any reason, including those set forth herein. The behaviors covered by these and earlier-described methods relate to tasks and activities that may be performed by and/or within prescribed time parameters and may be provided to influence or alter the status or location of assets and resources, including money, the timing and manner of purchases, the timing and manner of payments related to those purchases, the timing and manner of payments related to an unlimited range of goods and services that may variously occur as events separate from purchase events and others as described herein, the timing of the adoption and/or use of various technologies, alteration of the timing of the consumption of various resources, including energy, the reduction of consumption of resources, including energy, the acceptance of interruption in the supply of resources including energy, such as electricity and others, the adoption and/or use of preferred forms of energy or preferred energy consuming vehicles and devices and others, the time and attention of individuals in various interactions, transactions and circumstances. Programs may be developed to provide for purchases, payments, sending, shipping, receiving, production, consumption, altered timing consumption and other alteration in the status of goods and services. Programs can provide rewards in a nuanced manner so that appropriate resources are matched with providing of the incentives. The rewards provided by these methods also generate numerous competitive advantages and bottom line efficiencies and other positive results in ways that benefit participants, such as individuals, groups, companies, institutions and others, as well. For example, as described previously, the adoption of preferred timing and preferred methods for paying electricity bills may be rewarded in a program. If desired by an electivity service provider at any times of shortage or interruption in supply or by other interested parties, the degree to which electricity customers alter the timing of their consumption of electricity and/or limit their overall consumption of electricity during times of critical shortage may be included as added factors in a single promotion or rewarded with entries in sweepstakes, redeemable points and other incentives and benefits. Alternatively, the timing of a purchase of items at websites online and the particular method of shipping those items to the buyers once the purchases are completed may be coordinated and/or combined as factors in a single promotion as described herein and in other ways. Numerous other examples and combinations may be readily envisioned and are covered by these methods, including those that are described herein.

### Influence and Alteration of Behavior

In a method and system of the invention, an event is recorded. The event is the item to be influenced, and may relate to a wide variety of events. An individual, account, business, or other information may be associated with the event. A status of the event is determined. If the event is to be considered in an awards or incentive algorithm, the status information is provided to the algorithm. Using the algorithm, rewards or incentive information, such as a point value, is determined. This value may then be stored, and added to an account of an individual, group, business, or other organization. The methods and systems of the invention provide incentive programs for the reward of points and other forms of credits to alter or influence, encourage and otherwise affect behaviors of individuals and/or businesses at or within any preferred times or time-frames in any manner that may be desired and for any reason and under any circumstances, including those that are described herein. Alternatively, the methods and systems of the invention may also provide for the deduction of points and other forms of credits. For example, credits may be provided to alter behavior of individuals that may or may not occur at or within prescribed time parameters, at or near particular physical locations, on or by preferred communications networks and for any reason deemed desirable. The tasks, activities, transactions and events that are described herein may variously that take place offline, online, over telephone networks, in particular physical locations and in other ways, including as described herein. Programs, including sweepstakes and points programs are provided to reward the performance of one or more specified tasks and activities that may or may not involve the award of credit in small quantities and in small increments and credit in large quantities and in large increments individually and over time that may be planned or unplanned. All of the programs described herein, including one or more component elements of all of the programs may be interchanged and otherwise commingled in and with other programs and other parts of other programs that have been described previously.

In previous applications, programs, systems and methods are provided for encouraging the performance of tasks in a particular manner and/or at a particular time, or before or after a certain time. The tasks and activities that may be performed include payments, such as bill payments by any time and by any manner that may be preferred by any party that may be desired as described herein and in previous patent applications, the timing of purchases, the transfer of funds, the provision of legal services and others will be influenced in ways that generate benefits and efficiencies for participants and others.

The inventions may be implemented in a wide variety of technologies, including technologies that may not yet be commercially developed or available. These programs systems and methods are provided, in some cases, for encouraging desired behavior on the part of various businesses and individuals. Where reference is made herein to an individual, such references may be interchangeable with groups, companies and/or other entities or other interest parties and others. One or more of these methods or components of these methods described herein may be combined and/or exchanged with any of the methods described in earlier pending patent applications and programs. For example, if a description refers to performing the task of paying a bill or making a purchase at a particular website online for a reward consisting of points, it will be assumed that other forms of rewards, such as sweepstakes entries and other redeemable points described herein and in previous patent pending applications may be replaced interchangeably herein as may be desired to create programs to accommodate particular needs and situations, including those described herein.

### Payments Submitted by Preferred Times and Methods

For example, it is described within the aforementioned pending patent applications that there are a very large number of tasks and activities of various types which, if performed in a specified manner and/or at specified times, are of enhanced value to one or another party involved in the task or activity and others. For example, there are a very large number of periodic and recurring payments of bills and settlements of accounts made by individuals and entities and rewards may be provided for any reason deemed desirable by program participants. In certain cases, though not in others, bills and accounts may be subject to due dates and may permit the payer a customary period of time in which to remit payments before late fees, interest charges and other penalties are assessed for late payments. As described previously, in certain cases, the earlier payment of certain bills and settlement of accounts would enable the recipients of payments to benefit from the use of money that is received earlier than may occur otherwise, including within billing cycles, and in other contexts and therefore would be of significant value. Some of the rewards that may be provided include cash, discounts, waiver of fees, entries in sweepstakes redeemable points and others. Some of the tasks and activities that may be incorporated in a program include purchases, payments of one or more bills that may or may not be subject to due dates, making payments related to those purchases as well as payments at preferred websites and over preferred telephone networks and by other methods, possibly within prescribed time parameters. The bills may be paid by, on or in advance of due dates by offering incentives such as points, entries in sweepstakes and others. The task of paying bills may be performed at preferred websites and/or over other networks such as telephone networks on or before stated due dates by offering incentives as described above. The payment of bills at particular websites at or within prescribed periods of time may be rewarded with cash, redeemable points, entries in sweepstakes and other incentives. The payments may be submitted over preferred telephone networks and by other methods and may occur at particular times or within prescribe periods of time. The payments may be related to one or multiple purchase events. The payments may be paid directly or paid to third parties in advance of due dates, on due dates and irrespective of due dates by preferred payment methods including electronically, with credit/debit cards and others through special points promotions (e.g. 500 points per recurring bill, double bonus points and others), sweepstakes entries and other incentives, the purchase of goods and services at particular websites, over telephones and by various combinations of these and other forms of communications at particular times or within prescribed times, together with the use of preferred payment methods, including particular credit and debit cards, by offering various other forms of incentives described therein and herein and previously.

These methods may involve tasks and activities that include time-sensitive purchases, the payment of bills related to those purchases, the payment of bills that are subject to due dates based on the timing and methods used to pay those bills and others as described herein and previously. For example, rewards may be provided for the submission of timely bill payments that may be subject to due dates in any manner that program sponsors may desire, such as by electronic methods.

In addition, as described in my previous patent applications, alterations in the timing of payments by even small transactions, when repeated, can result in significant costs. As noted in the foregoing applications, there are a very large number of periodic and recurring payments of bills and settlements of accounts made by individuals and entities. These bills and accounts permit the payer a customary period of time in which to remit recurring payments before late fees, interest charges and other penalties are assessed for late payments. In certain cases and not in others, the offer of incentives to achieve earlier payment of bills, such as recurring bills would enable the recipients of payments to benefit from the use of those funds that are received earlier within billing cycles, such as within recurring billing cycles, and would, thus, be of significant value. However, competitive concerns and, in some cases, legal and regulatory concerns prevent payees from unilaterally shortening the period of time in which individuals may make payments without incurring late fees or other penalties. In addition to the timing and methods for the receipt and/or submission of payments to or from individuals and others from any source and under any circumstances including those described herein and previously, changes in the methods for performing the task of making any form of payments, such as the use of electronic bill payment techniques, are also desirable to payees and others for various reasons. For example, issuers of credit cards and other payment cards find altering practices of consumers to inspire the greater use of credit and payment cards to be quite desirable. Techniques for encouraging accelerated payment are often crude, such as offering a flat discount for payments by dates certain. There is also competition among providers of bill presentment/payment and other statement of account/payroll/payment-related service providers that desire to attract and retain customers and inspire them to adopt preferred payment, preferred accounts and various bill presentment and payment-related technologies. Rewards may be provided for the performance of various payment related tasks and activities to generate competitive advantages and other benefits for participating and others. These methods provide programs for payments to and from individuals, consumers, small businesses, employees and others, companies and others under various circumstances as described herein may be rewarded in these and all previously described methods and systems. Those programs, systems and methods are applicable to any tasks and activities related to the payment of money, the transfer of money, the retention of money, possibly minimum balances, payments related to purchases, periodic payments, including payments on loans, such as home mortgages, credit card accounts, travel card accounts, utilities, various services, such as cable television, Internet access, and others in general, including any type of account activity or billing activity requiring or generating a payment from one party to another party for any reason. Incentives may be provided for furnishing or generating or consuming a product or service or for meeting thresholds related in some manner to a product or service, including in all of the various ways that are described herein and incentives may include providing points programs for adopting and repeatedly demonstrating desired behavior. Those thresholds may involve quantities, timeliness, quality, length of customer relationship or other membership and other factors for any reason. In one aspect of the invention, an incentive is created by a payer for adhering to terms and conditions set by the payer. In one example, a condition is the providing of invoices, claims or other requests for payment in a particular manner or format. In another example, receipt of bill payments in a convenient manner, such as by electronic payment or preferred payment cards may be incentivized. Otherwise stated, the payee is benefited by compliance by the payee (or payee agent or other third party) with conditions specified by the payer. The particular details of placing the payee in such a better position may vary widely. Either the payee may receive some value not otherwise available, or avoid a cost that the payee may otherwise incur. The value may include any item of value, and the cost may include a cost of any kind, including those set forth herein. The cost may be the loss of something of value available only on condition of complying with the conditions. Incentives are provided particularly for complying with the payer's conditions on more than one occasion, and/or on consecutive occasions, and over periods of time. Examples of goods and services that may be prepaid in this manner among others include telephone services, legal services, postal services, such as by purchases of stamps, purchases of postage for postage meters, airline tickets and other reservation-based travel and other methods. Other examples include purchases of travel-related services, such as airline tickets, accommodations, such as hotel and motel rooms and the like that may be purchased in advance of the use or consumption of these and other products and services.

### Movement of Money by and Between Parties

Incentive rewards may be provided as to transfers of assets of any type, including money, between and among individuals, businesses, and others. Incentives may be provided for a transfer using a particular intermediary. Both the sender and recipient of a transfer may be provided with incentives, such as for the use of particular financial service providers. These rewards may be applied to all of electronic bill payments, electronic payments by and between parties, electronic money transfers by one party between and to preferred accounts for any reason, so that any or all of those will provide inspiration and motivation for influencing and altering behavior and changes in these methods by which such tasks and activities including payments and other electronic money transfers may occur by and between parties, accounts, etc. these methods provide inspiration for influencing and altering behavior and changes in these methods by which such tasks and activities including payments and other electronic money transfers may occur by and between parties, accounts, etc. Banks desire to attract and retain customers by providing various services including online bill payment services and other money transfer activity. Others may desire to increase the overall number of transactions such as electronic money transfers and possibly to increase the percentage of customers with accounts that may have preferred balances and others. There has been an increase in competition among financial institutions and other companies that provide services relating to money transfers and other electronic wire transfer services, particularly involving individuals who transfer money electronically to and among family members and friends, who may or may not reside in other countries. There is also an increasingly competitive market for money transfers, including transfers by, between and among businesses and individuals. Providers and others desire to create loyalty among consumers of such money transfer services. Certain companies offer programs that provide discounts to preferred customers who enroll in certain wire transfer programs and engage in wire transfer activity, possibly on a recurring basis. In another embodiment of the invention, any of the methods and systems described in this application and in any of my applications referenced herein may be employed to provide incentives and rewards for the separately accomplished advanced payments for the use of the service or product. Programs may be provided to track and reward the performance of tasks and activities that may include, but is not limited to, the payment or other transmission of money from one party to another party for any reason, possibly by preferred times and by preferred methods, including those described herein and in previous patent filings. In certain cases, the assets may be money in accounts that may be moved by one party in ways that alter the status of the money and remain within and under the control of one party. In certain other cases, the money may be transferred by one party to another party, possibly within prescribed time parameters. For example, the movement of money from one person to another person by electronic methods and an individual may be rewarded for movement of funds from one account to another account for any reason that may be desired, including for reasons specified herein may be rewarded. Changes in the methods by which money and other assets are managed, transferred and otherwise altered may be desirable for a number of reasons. A variety of technologies are available that provide alternatives to cash and checks. Magnetic stripe cards and chip cards are available for a variety of specialized purposes, such as mass transit fares, telephones, parking meters and taxicabs. More widely usable digital wallets are also available. The adoption of these and other alternate payment techniques, including electronic bill payment methods, wireless toll payment techniques, wireless payment techniques, automated payment methods at check-out lines in retail locations and others would generate benefits, but many not yet be available, may be available but has progressed slowly or stopped for various reasons.

In another variation, additional tasks, activities, events and other actions that may be incentivized, tracked, measured and rewarded by individual or multiple methods and programs include the movement of money from one account to another account, the transfer of money from one party to another party and other tasks and activities may be provided entries in sweepstakes and other rewards. Minimum account balances, retention of funds for prescribed periods of times and others will benefit from rewards.

### Movement and/or Retention of Money by one Party

An event may be the retention of money in one account or the transfer of money under the control of a single party, as distinguished from transfers.

In the context of the movement, retention or other alteration in the status of assets such as money, the amount of funds involved in other types of transactions, the time, and repetition of the transaction, may also be considered as factors in rewarding individuals from time to time. The transmission or other transfer of money, whether to another account possessed by the transferor or otherwise may be in any manner, including money orders, cash cards (which generally represent a prepaid account that is debited as purchases are made but may include other approaches), debit cards (generally linked to a bank account), payment cards or devices linked to a bank account or credit card account, or other manner of transmission. The method and system of providing points, sweepstakes entries or other items of value contingent on the performance of certain tasks and activities may be made contingent on the transmission, deposit and/or withdrawal of funds by certain methods and by optionally meeting other conditions, such as time of day, day of week, date ranges, and other method that alters the status of funds including fund transfers, deposits, withdrawals and others. The amount of funds and the length of time that funds are maintained/transferred or received may be considered in rewarding individuals from time to time.

### Advanced Purchases and/or Payments

The methods and systems described in this application and in any of my applications referenced above may be employed to provide incentives and rewards for the purchase in advance of the use of the service or product. It will be understood that this method is a method involving movement of money or other funds or credit, wherein the movement or delivery of funds is a purchase, and a factor in the algorithm is the timing of the purchase. Examples of services that may be prepaid in this manner include electricity consumption, telephone usage other than prepaid service, postal services, such as purchases of stamps for usage at a later time, purchases of postage for postage meters, and other methods. Other examples include advance purchases of services ranging from prepaid legal services to travel-related services, such as airline tickets, accommodations, such as hotel and motel rooms and the like.

### Accelerated Payment Accounts

In one method of the invention, two or more accounts are made available by a payee in connection with the same debt. A first account is a conventional account, and a second account is an accelerated payment account. The conventional account provides for payments to be made in a conventional time. The accelerated payment account provides for payments to be made earlier, with additional incentives provided to payers who select the accelerated payment account. In addition or as an alternative, the conventional account may provide for a first payment method, such as by check, while the accelerated payment account may provide for payment to be made by one or more specified method, such as pre-approved electronic funds transfers.

### Other Adjustments to Conventional Payment

Rewards that may be provided and when referenced herein include entries in sweepstakes, redeemable points, goods and services in prescribed amounts, discounts related to goods and services, cash, and other rewards described in previous patent applications. For example, purchase transactions may take place separately and occur in advance of, contemporaneously with, or subsequent to the acquisition, consumption, use or other access to or enjoyment of benefits associated with goods and services. For example, a continuing difficulty in enhancing use of the Internet as an accepted method for placing orders, making purchases, engaging in auctions, buying and selling stock, making or otherwise submitting payments including bill payments as may be desired and others is widespread due to concern regarding the security of data transmitted across the Internet. Potential purchasers are reluctant to provide bank account and credit card information to Internet retailers for various reasons including the risk of identity theft or other fraud, for example. Furthermore, consumers without credit cards may find it difficult to place orders. Concerns about security also discourage the use of the Internet for other purposes. A need exists to provide a program to reward individuals for adopting any preferred payment method and any preferred dates for payments, as well.

### Separated Communication of Transaction Components

A need exists to provide enhanced security for individuals who engage in transactions. The transaction may be a purchase of goods or services, registration, completing a survey, applying for a loan, job, government benefit or other item, by way of example. The device may be of any type, including a personal computer, cell phone, or PDA. The activity may be a reservation of a product, service or other item or a partial payment or other down payment or consideration that secures the transaction. The transaction is then completed as a purchase, submission, or other item.

For example, purchase transactions may take place separately and occur in advance of, contemporaneously with, or subsequent to the acquisition, consumption, use or other access to or enjoyment of benefits associated with goods and services. For example, a continuing difficulty in enhancing use of the Internet as an accepted method for placing orders, making purchases, engaging in auctions, buying and selling stock, making or otherwise submitting payments including bill payments as may be desired and others is widespread due to concern regarding the security of data transmitted across the Internet. Potential purchasers are reluctant to provide bank account and credit card information to Internet retailers for various reasons including the risk of identity theft or other fraud, for example. Furthermore, consumers without credit cards may find it difficult to place orders. Concerns about security also discourage the use of the Internet for other purposes. A need exists to provide a program to reward individuals for adopting any preferred payment method and any preferred dates for payments, as well.

In the method, first transaction request information is received from a transaction party in a first mode. In response, the transaction party is prompted for second transaction request information to be provided in a second mode. If the second transaction information is received in a suitable manner, then entering into the transaction, and otherwise terminating the transaction. The first mode may be a device communicating over a network with a network resource. The transaction may be a purchase of goods or services, registration, completing a survey, applying for a loan, job, government benefit or other item, by way of example. The device may be of any type, including a personal computer, cell phone, or PDA. The network, an example of a first mode, may be the Internet, and the purchase may be accomplished by communication between a client and a server using the World Wide Web, that is, a purchase at a website. The purchase is made by commands from the client device to the server. A record of the purchase is created, with the first transaction request information, such as the item, quantity, and the like, shipping address, or other information depending on the nature of the purchase. In the method of the invention, second transaction request information, such as the making of payment is-separated from the transaction either in time, place, or method of communication. The second transaction request information may be made over the same communications network at a later time, by another communications medium at the same or a later time, at a designated physical commerce location at a later time, or otherwise.

In addition, in the same way that programs may be designed to accommodate a separate the purchase and payment process, the rewards redemption process may be separated. The items may be available for redemption and, for example, individuals may be required to call a separate telephone number or access another website with a code to complete the redemption process and in other ways. The items may be available by any desired means such as by mail if appropriate, such as concert tickets and sneakers or items may be made available at particular physical locations for redemption, so as to increase overall consumer traffic in stores, as well.

### Status of Accounts and Types of Payment

Incentives may be provided based on one or more factors such as the status of an account as described herein. The status may be considered in calculating the rewards and/or based on the opening and/or maintenance of the account. Various combinations of accounts may be included. Various types of accounts, including deposit accounts, credit accounts, and others, may be included.

### Adoption and/or use of Electronic and Real Currency

A need exists as described in previous patent applications that will be satisfied with rewards for criteria that include movement into and movement out of preferred forms of fund retention as well as the length of time of retention within all existing and future forms of fund retention, including those as yet undiscovered or not yet commercially available. A need exists for programs that provide for and accommodate new forms of currency, credit and other values.

A need exists, as noted above, for programs that may be employed in connection with incentives for use of digital currency, for preferred types or providers of digital currency, and/or for preferred types of currency. For example, a provider of digital currency may provide points for an incentive rewards account, sweepstakes entries, or other rewards, for the purchase, replenishment, spending, or other tasks and activities related to digital currency. Also, a need exists, as noted above, for businesses that make and receive payments in more than one currency to provide rewards and other incentives for the use of a preferred currency. Numerous variations and various circumstances may be envisioned.

The methods described herein and in previous patent applications include movement into and movement out of preferred forms of fund retention as well as the length of time of retention within all existing and future forms of fund retention, including those as yet undiscovered or not yet commercially available. These methods also cover any new forms of currency, credit and other values. The adoption, use, retention and amount of new forms of credit and forms of currency may be related or tied to other incentives, such as discounts on purchases and other benefits. These benefits may include entitlement to discounts if specified factors are met. The benefits may also include benefits at the redemption stage. These methods may be combined or coordinated with other methods described herein.

### Adoption and use of Preferred Techniques such as Accurate Billing

A need exists for incentives may be provided through points programs for accurate and prompt reporting of information within an organization. For example, in various types of commercial relationships, a payer may benefit from the submission of invoices, requests or claims in a specified format and payment in a specified manner or time. For example, medical insurance providers receive and process a very large numbers of claims from physicians, hospitals, and other providers, and make a large numbers of payments, as well. Uniformity in the manner in which claims are submitted and the manner in which payment is accepted would be of value to medical insurance providers and others, for example. The same may be said, for example, of large commercial, government, and non-profit entities that receive large numbers of invoices from numerous vendors and others. Adherence to uniformity in the manner of bill presentment and the manner of payment acceptance is of value to such entities, for example. Thus, an algorithm may provide for incentives based on meeting format, timing, and other criteria set in accordance with a rewards program. Other examples of arenas where incentives may be provided may be envisioned.

### Securities-Related Transactions

In another invention, in one embodiment of the inventions any of the methods and systems described in this application and in any of my applications referenced above may be employed to provide incentives and rewards for tasks and activities related to securities transactions. Programs may be provided with rewards for the purchase, sale, option, or other securities-related activities, possibly providing rewards, bonus rewards and the like for electronic methods for purchases and sales of securities and other activities. “Securities” has the broad meaning ascribed to that term by the U.S. Securities and Exchange Commission, and includes, by way of example, such instruments as stocks, bonds, mutual fund shares, warrants, options, puts, futures contracts, trading indexes, and derivatives of such instruments. Activities related to transactions may include the purchase or sale for one's own account, the transfer between or among accounts, the providing of instructions for the purchase and sale based on price or other triggers, preferences for electronic methods may be provided. The acceptance of statements electronically and other valuable tasks and activities may be rewarded, provided bonus points and other desirable benefits.

### Postal and Package Shipping and Delivery

In another invention, there has been an increase in competition among mail and package delivery providers. A need exists for programs, including rewards for adoption and or other use of preferred processes and methods for shipping, receiving mailing, use of postage meters, online methods for purchasing postage and other postal-related tasks and activities. Rewards may be provided and factors and variations that may be considered may include rewards for each package sent within a given time frame, the weight or number of items shipped or received, the manner of shipment or receipt (e.g., critical delivery or express delivery instead of ground delivery or other standard delivery, overnight among others may be rewarded, for example) and other factors. As is the case for all of the methods including those described herein, a reward may be provided to a shipper or recipient or payer if an item capable of being tracked such as by referencing a bar code, postal code, zip code or other identifier, is randomly selected.

### Adoption and/or use of Efficient Interactive Processes

In another arena, a need exists for rewards to inspire individuals to receive marketing information as part of the process of providing information in a distinct manner or at a distinct time. Various modes of presentation of marketing information and advertising, both now known or as yet not commercialized or not yet discovered, may be employed, including as described herein and previously.

Rewards may be provided in the context of a rewards program for customers for minimum use of the time of live telephone representatives. The necessary information may be provided by keypad or voice recognition.

Background profiles may be provided and described in greater detail in one or more of my co-pending applications incorporated by reference above. Regardless of the use of a background profile, suitable marketing information is identified, so that an appropriate marketing presentation may be provided to each customer.

Incentives may be provided for being provided with the marketing presentation, as described in more detail in my prior co-pending applications.

### Adoption and/or use of Preferred Electronic Forums and Technologies

In another aspect of the example, a reward is provided to a third party related to enrollment in a program of compliance with terms and conditions. In general, there is an arrangement involving a first party and a second party, a recurring activity involving performance of some type between the first and second parties, and involvement by a third party related to the arrangement. The third party is furnished with benefits in exchange for encouraging the agreement or performance of one of the first and second parties to comply with specific terms and conditions.

### Incentives for Customers, Membership and the Like

As described herein and previously, tasks or activities that may be rewarded may include such items as payment of bills by preferred times and by preferred methods or the length of membership in a program and others. For example, after every month of membership in a program, the consumer may receive a number of chances in a sweepstakes, which number is equal to the number of months of continuous membership, possibly demonstrated by continued payment of membership fees, for example. In one example, the prize in a sweepstakes associated with a services plan such as a professional services plan that may include certain professional services, possibly for a period of time of enhanced benefits or reduced or no cost in a prepaid plan.

### Services as Rewards

Services may be provided as rewards in incentive programs or may be available for purchase. These services may include professional services that may be provided in a points program, possibly with the amount or value of services that may or may not vary with points accumulated and/or earned. Services may be provided in the form of memberships and may be re-oriented and provided on a per event basis rather than a time frame for protection paid for on a subscriber basis. For example, the payment of one dollar for per event coverage that may provide specified legal protection to persons who engage in preferred transactions and events, such as time-sensitive purchases at websites. Such purchase may be as a reward, or may be available generally to persons who engage in transactions on a per event basis. The redemption of points and/or prizes that may be awarded through direct redemption, through random drawing sweepstakes drawings and through other methods described in my prior filings and others that are known to exist elsewhere may result in the entitlement to a variety of free or discounted services being provided to participants and/or premium levels of service being provided over and above standard services.

### Legal Services and Other Services

In one variation, membership in the rewards program described herein or any other programs described in any of my prior filings may itself entitle participating members to free or discounted goods and services such as legal services similar to existing programs. Unlike existing programs, the previously accumulated/earned points may be redeemed through relationships with one or more attorneys, including attorneys who may or may not specialize in particular areas of law such as immigration law, and/or may or may not have specific language capabilities, and who may be part of a network of attorneys who may be retained and incorporated in a rewards program on a free and/or discounted basis. For example, once point thresholds that may be established by program administrators have been reached, some or all of those points may be redeemed for specific legal services, tasks and activities, such as the filing of a legal document, the preparation of a will, etc.

### Identity Theft and Other Fraud and Abuse

Identity theft is the fastest growing crime in the U.S. The growth in identity theft rates has and will continue to hamper the growth in overall transactions online. If the fear of being a victim of identity theft can be reduced, companies that market goods and services online will benefit from an increase in the overall number of transactions. Alternatively, various credit card providers provide damage protection to individuals in the form of limits on financial losses if credit cards are lost or stolen and misused. In addition, companies are offering a package of non-legal types of support services such as assistance to victims of identity theft and other services. These companies often charge yearly fees to participants ranging from $50 to $80 dollars per month. Identity theft is the fastest growing crime in the U.S. with the number of victims increasing each year. The average losses associated with identity theft can average thousands of dollars and hundreds of hours of lost time and attention per ID theft-related event in order to deal with the distractions associated with the consequences of identity theft. The amount of losses and damages associated with certain transactions, including online purchases, auctions, etc, is increasing and may easily exceed tens of thousands of dollars per event. The ability to pursue potential defendants across various geographic regions can be efficiently achieved by providing membership in a prepaid legal services plan that maintains a relationship with a network of law firms with a presence to pursue litigation throughout numerous geographic areas, if necessary. The offer of insurance products alone or identification assistance services alone provide limited assistance to victims of ID theft as no legal assistance has thus far been provided and certainly no legal services have been provided coordinated with non-legal assistance on a coordinated basis. For example, several companies presently offer services, including third party telephone assistance to assist victims of identity theft to deal with creditors and others for prescribed periods of time, email alerts regarding scams, email notification regarding changes in credit profile status, firewall protection from hackers and other services. The offers a subscriber-based service that provide limited online mediation services to deal with disputes arising out of online auctions at websites has been attempted. Alternatively, from the standpoint of individuals engaging in transactions with credit cards and in other ways will inevitably face higher risk of identity theft and other harm and will come to need identity theft-related legal services and other assistance that may include various non-legal benefits including possibly being shepherded through the credit bureau reporting process and others processes. These issues represent serious concerns to law abiding citizens including members of the immigrant population who are often targets of fraud as well as others. The provision of programs and rewards for engaging legal services can be created to inspire greater engagement in online transactions and greater participation in prepaid legal services and other programs. If provided through payment card providers, it will be in their interests of those companies to promote awareness of the benefits in a comprehensive ID theft protection and/or legal protection program or other service. Access to legal plans or entitlement to the performance of legal tasks or activities may be provided as a benefit that may be made available to payment card customers who will be appreciative of the access to legal services in various ways and who will remain contented credit card customers. For example, once the legal service is provided to individuals or ID theft-related services are provided or a real estate settlement takes place, possibly in combination with ID theft protection provided as a benefit, a legal service provider will have access to the individuals in order to educate them about the merits of legal services available under legal plans. The ID theft protection program itself as described in greater detail herein may be incorporated so that payment card customers will be protected from ID theft, possibly if certain balances or other criteria are met. Companies that sponsor such a program and that may pay for the access by their customers and/or their own employees to the legal services that are available in a plan.

### ID Theft Surveillance and Legal Services Program for Certain Markets

Certain individuals are at higher risk for identity theft and/or would suffer greater damage in the event that they were ID theft victims due to the nature of their employment, their property, hobbies and for other reasons. A combination of services including surveillance of credit profiles as well as the provision of attorney representation and services that may be provided in the event of legal entanglements stemming from certain occupations that require an excellent credit profile or credit rating. A need exists for the combination and/or coordination of certain legal services with certain non-legal services including those related to guarding credit profiles and a legal plan that provides protection to individuals will benefit covered persons. Various levels of legal and non-legal services may be provided at different rates that may include services such as surveillance and monitoring of credit-related activities, freezing account activities in certain circumstances, notification of relevant parties and agencies and others.

### Document Transmission, Receipt, Preparation and Authentication

One aspect of the present invention is a method for providing incentives for receiving information from companies such as insurance companies, financial institutions and other entities in electronic form. There have been some efforts to entice customers to accept bills online at websites in the past. The acceptance of other more substantial documents, such as insurance policies, a monthly record of cancelled checks and others that are provided by mail at great cost would benefit from adoption of electronic bill payment methods, together with a wide variety of other financial transactions and documentation that may be generated in financial transactions and other processes that are presently completed using paper documents. By way of example, the information may be in the nature of images of cancelled checks of account holders and periodic statements. A points program or other program may be provided in which account holders who receive information in electronic form rather than paper form become eligible for benefits. A program may also include disincentives for account holders who elect to receive original paper checks or other documents in paper form. Documents that are sent, received, shipped, or otherwise transmitted by preferred methods such as electronically, may be rewarded. The use of paper copies of insurance policies, paper checks for payment, and the return of paper checks or paper copies of paper checks by a bank to the account holder, are examples. A further example in the context of banks and other financial services providers is the providing of paper account statement on a monthly or other periodic basis. Banks and other financial institutions could save significant sums by avoiding the need to provide such paper records. However, at least a segment of consumers are likely to resist the loss of paper records. Banks are attempting to implement a process known as check truncation. In this process, when a check is presented to a bank, generally by the depositor, the check is digitized. The paper check is not further processed; rather, further processing relies on the information captured from the paper check. The use of check truncation would save banks substantial amounts in check processing costs. Incentives may also be provided for making use of document-related services, such as document preparation, notarization and authentication.

### Adoption and/or use of Preferred Electronic Forums and Technologies

In another invention, in certain types of transactions, a third party may or may not be involved at various points such as possibly in the initiation of the relationship. In another aspect of the invention, an arrangement involving a first party, a second party, a recurring activity involving performance of some type between the first and second parties, and involvement by a third party related to the arrangement, may provide for benefits to the third party to encourage performance of conditions related to the recurring activity. An example of an arrangement is a loan to a consumer for the purchase price of an automobile, in which the recurring activity is a periodic, often monthly, payment of interest and principal. The principal parties are the lender and the borrower. The third parties may include automobile dealerships and loan referral services, such as parties operating websites that provide information on loans available from a variety of lenders. The lender may provide incentives to the automobile dealership and/or the loan referral service if the consumer agrees to make payments for any reason and in a manner or time frame that may be deemed relevant or desired by the lender or by others.

For example, loans for the purchase price of an automobile are typically proposed and negotiated at an auto dealership. The lender is not directly involved in the initiation of the loan. However, thereafter, the borrower makes periodic payments to the lender or the lender's designee. The lender may benefit from agreement by the borrower to agree to a particular timing or manner of making those periodic payments. However, the automobile dealership has no incentive to promote the use of such manner of making payments, so long as the automobile is sold. Numerous other examples of other programs are described herein and in previous patent applications that are designed to generate benefits and efficiencies as well as reduce inefficiencies ranging from customer resistance to the adoption of preferred behaviors, such as payment of bills or other money transfers by preferred methods and/or on or within preferred dates or ranges of dates within which to adopt and/or use preferred techniques, preferred technologies, and other factors that may be related to the performance of tasks and activities as described herein. In another arena, there are well known communications networks that have been installed within vehicles that have a communications system with global positioning system (GPS) tracking capabilities. However, these systems have experienced slow subscriber growth rates. Additionally, even when customers do subscribe to these types of services, the customer renewal rates have been very low. Moreover, these systems have traditionally relied upon revenues generated from customers who are expected to pay recurring fees for access to the system and for access to various features that may be made available such as telephone airtime and others. A need exists to enable the system operators to generate increased revenues and retention rates as well as new revenues from sources other than consumers.

### Trading Index-Related Tasks and Activities

Engaging in any trading index related tasks and activities such as acquiring home equity or price insurance protection in a plan or in any form that may be provided may be rewarded. For example, a transaction structured as a put/option method for measuring risks and assigning price values to provide home equity price protection and other index-related transactions may be created, factored and/or rewarded.

Protection and benefits in programs may be provided in the form of services including protection such as in a program that provides ID theft protection, legal plan membership, various forms of legal services, insurance etc, may be paid for on a fully or partially accelerated basis over a term that may be shorter than the underlying payment schedule that may be generated such as loan periods or other payment schedules that may be provided. For example, if an individual obtains home equity or price protection insurance and legal plan membership, possibly in a bundled plan, for a combined fee that may be paid in advance of the purchase or other transaction, contemporaneous to the purchase or other transaction or at a later time apart from the purchase or other transaction including those related to real estate such as a purchase, lease, rental and other establishment of relationships that generate payment schedules, payments for the combined services may be rewarded. The time and/or attention, volunteerism-related tasks and activities or other capabilities or other tasks and activities may be provided by participants in lieu of fees

Accelerated payments may be provided and/or rewarded and combined for home equity or other purchase price protection. In addition, for example, legal membership for a prescribed period of time such as during the length of a loan period may be provided and/or combined with a rewards program such as a bill payment sweepstakes, among others described previously and otherwise. As in the case of other tasks and activities that have been described herein and previously, participation in any form of financial transaction including acceptance of insurance plans, legal plans, medical plans, dental plans and others that may be rewarded in various programs.

### Real Property Equity/Price Insurance

Although various forms of insurance such as title insurance, flood insurance and others are available to protect parties who acquire real estate, the purchase or other acquisition of real estate carries the risk that the value of the property in question may fall over time, possibly below the purchase price. In cases in which individuals acquire real estate through means other than a purchase, such as through probate proceedings, individuals may desire to secure the future value of the property for various reasons. It is believed that if homeowners knew that their investment was protected at least to the extent that they would be made whole up to the point of the purchase price, an incentive will be created to invest further in properties and maintain them

Recently, certain pilot programs have been undertaken to provide home equity insurance to purchasers within certain geographic areas. Various financial risk management tools such as put options strategies are being employed as a means to entice coverage and protection from a decline in value as a tool for risk management for homeowners who purchase homes within certain geographic areas. Some of the factors that may be considered in formulating an acceptable pricing structure include real estate price indexes, game theory, derivatives and others. It is hoped that these strategies or others can create a sufficiently structured trading environment so that parties will be enticed to settle in preferred targeted areas, such as those designated as urban renewal zones and for an endless variety of other reasons.

A need exists for a mechanism that may consist of and/or be coordinated with put options strategies and other tools designed to manage risks related to protecting particular properties, for example. Rewards may be provided within this environment at many levels including participation, adoption, use, consumption, recommendation, referral and others. In addition, once these methods are in place, the methods that are available or contemplated to assure price protection related to real estate purchases must be made economically attractive enough to entice prospective homeowners into paying for the protection as well as attractive enough to entice speculators and other willing participants and possibly others, such as third parties.

### Legal Service Plan Participation and Legal Insurance Pricing Index

Inasmuch as risks may be assessed in providing various price protection, such as home equity price protection and others, individual pose a risk for needing legal insurance and others that may be considered as factors and may influence the rate assessed to provide legal protection to individuals. Various Services are known to exist that track various forms of data relative to business relocation and the termination/utilization of services relative to movement of business in prescribed time parameters.

The programs described herein may be combined and/or coordinated with one or more other programs described herein and previously. For example, participants who acquire home equity insurance or engage in other transactions related to protection against a decline in property value or the value of other assets that may be envisioned, such as put/options transactions and others may be combined with legal plan coverage, legal services, access to a bill payment sweepstakes related to one or more payments for mortgages, title insurance, property insurance, legal insurance, and other benefits and rewards programs to entice prospective homeowners, speculators and others.

Moreover, all other forms of trading other indexes may be provided rewards and may combine price or other equity protection at a more favorable price than if these and other services are offered or provided separately for the assessing and measuring of and pricing risk may consider factors related to certain areas of economic activities such as the volume of business relocations and other data that may or may not be based in part on various background profile factors such as income, level, occupation, geographic location of residence or employment, type of vehicle, type of vehicle or transportation that may be utilized, as well as an unlimited range of other factors that may be deemed relevant and assigned values that may be included in the programs described herein.

### Per Event Fees for Provision of Services

Individuals who engage in preferred tasks, activities and transactions including online auctions, online purchases, offline purchases, electronic bill payments, electronic bill payments on or before a due date and others may be provided with credits or services provided, possibly as a requirement to receive benefits and/or automatically. For example, access to services such as ID theft protection and recovery programs may be provided if individuals perform preferred tasks or engage in preferred activities.

### Legal Services and Other Subscriber Services

In another aspect of the invention, a rewards program is provided for subscribing to a plan such as a prepaid services plan, including membership in a legal services plan. For example, subscribers to plans who pay membership fees by meeting specified criteria that may include prepayment of prescribed allotments of service may receive rewards, either directly or in the form of sweepstakes entries, points that may be redeemed for items of value such as goods and services, direct discounts in lieu of points, the use of accounts to retain balances and others. One factor that may in particular possibly increase the value of rewards and/or the number of points is the renewal of participation or other continuation of involvement in a plan. All of the various methods and systems relating to incentive rewards programs described in my co-pending applications incorporated by reference above may be employed in connection with this program.

In another invention, access to various types of services, such as, for example, legal services for immigrants, is highly desired, but often expensive and uncertain. In addition, there have been efforts by certain credit card providers to generally offer benefits to existing members that may include referrals to attorneys who may provide free or discounted legal services to existing card members. Prepaid legal services represents one way for consumers to enjoy access to the services of attorneys by paying a membership fee, usually on a monthly basis, with varying prices affording various levels of services. In addition, there have been efforts by certain credit card providers to generally offer benefits to existing members that may include referrals to attorneys who may provide free or discounted legal services to existing card members. Alternatively, within the prepaid legal services field itself, a significant difficulty in retention of customers has been identified and the acquisition of new customers faces challenges, as well. Customers generally enter into prepaid legal services plans with payment on a monthly basis or for other periods of time. The percentage of members in prepaid legal plans who allow their memberships to lapse by failing to make payments, particularly at various some points during the first year of membership as well as at other times, is very high. Some efforts have been attempted by providers to furnish additional hours of representation by trial attorneys in the event that a need for a trial attorney arises with limited success in increasing member retention levels. There is thus a need to encourage customer loyalty in prepaid legal services programs at particular points in time and over the life of the legal services program relationship. A competitive need exists for the creation of a comprehensive rewards system and network that may include a money transfer and rewards program that can serve the needs of individuals who participate in a rewards program as well as the companies that desire to compete more effectively and increase the volume and frequency of electronic transfers for any reason including to pay bills and may include prepaid legal service providers, as well. A need also exists for a specifically targeted rewards program that is more effectively tailored to the needs of specific groups of individuals, including, for example, immigrants who may reside in one country and who have a need to regularly transfer money to family members, businesses and other recipients who may possibly be located in other countries or other areas. “Immigrants” as used herein means any person who originates from one country and works in another, regardless of whether the move to the other country is intended to be temporary or permanent. Procedures to provide legal protection to persons at risk of identity theft, fraudulent transactions that may be generated on internet-based forums and other tailored legal services plans and different forms of pricing such as per event legal protection are envisioned.

### Online Auctions

In another variation, auction-related tasks and activities including those specified may be rewarded with sweepstakes entries and other incentives. Programs may be provided that generate benefits that may include providing access or preferential access to professional services such as legal services, possibly for prescribed periods of time or prescribed tasks and activities or based on other considerations. For example, frequency of auctions and/or achievement of threshold levels of number or size or other factors related to auctions apart from bids irrespective of actual successful bids, sales and other auction-related tasks and activities may be rewarded with credits that may translate into benefits that include membership in or other access to legal services, service plans such as prepaid legal services plans, online dispute mediation services and/or other benefits. For example, if a seller selects coverage for each single separate transaction to be completed, a single fee may be assessed rather than a monthly subscription fee in return for providing prescribed services in the even that a need is deemed to exist for such services arising out of the covered event. For example, if a party fails to provide payment for goods received by the party, legal services may be provided including in forms as described herein, possibly within prescribed time parameters.

### Dispute Resolution Services

In another invention, providers of certain services that relate in some way to transactions between two or more persons other than the provider find that disputes often arise between such persons. For example, online auction service providers, such as eBay, find that disputes frequently arise between actual or prospective sellers and actual or prospective buyers. Providers of online payment services, such as PayPal, also find that disputes often arise between payers and payees related in some manner to the subject matter of the payment. Various attempts have been made to assist in resolution of these disputes. Examples include mandatory blind-bid settlement efforts to value damages, and furnishing, directly or through a third party, online dispute resolution services. Online dispute resolution services typically provide an opportunity for all parties involved in a dispute to submit written statements, and then provide a resolution. One method of marketing and payment for such services is for those who anticipate disputes, such as frequent users of online auction services, to purchase in advance membership in a program that provides a limited or unlimited number of dispute resolutions of this type. One difficulty that has been encountered by providers of the dispute resolution service is a lack of clarity in the written submissions. A need exists for programs and rewards.

### Privacy Waivers

In another invention, there is resistance to the adoption and/or use or acceptance of invasive methods and technologies including those that involve tracking and rewarding individuals and others. Factors and the basis for rewards may include a waiver of some measure or degree of privacy, possibly for prescribed periods of time, within specific controlled settings and others. A need exists to entice customers and others to accept methods for conducting a range of transactions that result in privacy waivers. For example, rewards may be provided for privacy waivers and for acceptance of various methods for tracking persons, including GPS, wireless payment technologies, body implants may be rewarded to facilitate encouragement of positive behaviors and enable tracking and rewarding of individuals in the various circumstances described herein and in previous patent filings and in other circumstances. For example, as will be described below, agreeing to accept GPS in vehicles, including rental vehicles, conformity with driving laws, reduced traffic penalties and others may be rewarded.

### Legal Rights Waivers

A need exists to reign in costs related to lawsuits for damages related to business activity. A program may provide legal coverage to participants who are willing to waive certain legal rights, possibly for prescribed periods of time such as loan periods and other time frames that may be desired. Such waivers may include agreeing to forego certain types of claims completely, agreeing to a forum other than court, including various types of alternative dispute resolution, such as arbitration, particularly binding arbitration, and/or agreeing to limits on awards of damages.

### In-Vehicle Communications Technologies

In another invention, the communications and GPS capability of various systems are services that experience low customer retention rates. The adoption, retention, use and payment for such systems, possibly by preferred methods and/or on preferred dates may be rewarded. Other opportunities exist for partnering with operators of physical commerce locations such as chain stores and other commercial establishments that may benefit from the ability to extend targeted offers to individuals in their vehicles who may be detected in close proximity to certain commercial establishments. The GPS systems provide the vehicle location to a service, and this location information may be employed for this purpose and rewards may be provided.

### Mapping Functions

In another variation, mapping functions from computers, in vehicles and by other means for obtaining directions will be incorporated in various ways including as requested by customers and/or as may be offered by a system administrator. Special offers may be provided in response to a request for mapping and route information.

### Altered Timing, Reduced and Increased Energy Consumption

In another invention, these programs, systems and methods are applicable to the use of any resource, product, service or technology. By way of example, these programs, systems and methods are applicable to the use of energy and technologies related to the use of energy. These programs, systems and methods may be applicable to cause users to increase or decrease their overall use of energy, to adopt a particular source of energy, such as renewable energy, to increase or decrease use of energy from a particular source, to adopt, increase or decrease the use of a particular energy delivery system, and to alter the timing of consumption or use of energy.

### Adoption and/or Use of Preferred Energy Consuming Vehicles and Devices

In another invention, these programs, systems and methods are of use in vehicles, devices, appliances or technologies that use preferred forms of energy, among others. The use of particular categories of vehicles, devices, appliances, or technologies may be incentivized.

### Electronic Database Searches and Other Services

In another invention, there are services that provide various services such as search results, including searches for certain data related to finding information, including legal information and others. Increasing competition and delays in the receipt of payments from individuals who subscribe to the service highlight the need for rewards program.

### Discrete Dynamic Personal Discount Pricing

In another invention, at least one website has published information pertaining to sales at major retailers prior to public release of this information. The website has since stopped posting the information regarding future price discounts to be offered by retailers, but there is still a demand for such information. In addition, although attempt to reward customer loyalty through various rewards programs are well known, the proliferation of price comparison technologies and search engines that offer price comparisons for consumers reduce the need for consumers to actually visit particular retailer websites to view products and/or product pricing information resulting in lost advertising opportunities and reduced sales online and/or offline at particular retail establishments. These efforts also have failed to align discounts to effectively maximize sales and/or to manage existing and/or planned inventories of retailers. A need exists for retailers to accommodate discrete discount pricing inquiries from consumers and to make discrete discount pricing offers to particular consumers different from generally publicized prices based on various factors including prior purchase histories, prior product search histories at the retailer's website and/or at other websites and elsewhere, the degree of willingness on the part of consumers to complete purchases within prescribed time and location-specific parameters, prior responses to prior discrete offers of discounts and other considerations so as to enable retailers to increase traffic to websites and/or particular retail store locations, to increase overall sales, to more effectively manage existing and/or planned inventories and to generate other benefits. In another aspect of the invention, a reward is provided in the form of access, possibly either at restricted websites or though other means, to information about discounts, sales and other information that may be of interest to prospective purchasers of goods and/or services, which information may not be generally advertised or available to the general public. The information may be intended for later advertisement or availability to the general public, or may never be advertised or made available outside of one or more particular store locations, for example. The reward may be in one or more forms of rewards in a program as previously described. The rewards may alternatively occur as the result of the performance of a desirable task and/or activity, for example as an immediate reward for clicking through successive pages of content (such as advertising content) that a sponsor desires the individual participant to view. Time and attention measures, either as described in my prior filings or other variations for measuring attention and time, may be employed and used to restrict access to information regarding rewards and/or to the rewards themselves. The inclusion of incentives in addition to discrete pricing offers, such as redeemable points, entries to win sweepstakes and the like to inspire customer participation in making discrete discount price inquiries would also increase the number of discount price inquiries as well as total sales.

In another invention, a points program may optionally be provided to reward participation in a pricing program. Points may be awarded not only for purchases, but for any task or activity in the process, including submission of an inquiry about a product, receiving a response (such as by initiating a contact or remaining online or on a phone call, among others), and carrying out the transaction proposed by the discount. Any of the methods and systems relating to incentive programs, including features related to accumulation and earning of points and to redemption and rewards, time sensitivity, methods for performance of tasks and activities and others as described in my prior filings that are incorporated by reference above, may be employed in connection with this program. In some cases, points may be accumulated, but not earned, i.e., not made available for redemption, until a certain number or volume of purchases are made, if desired. Random awards of points and bonus points may be provided in such a program. In another aspect of the invention, a method and system is provided for furnishing highly targeted discretely offered discounts to customers, particularly for retailers to provide such discrete discount offers to individual consumers. The method and system involves obtaining information about the consumer's preferences, obtaining information relating to existing and/or planned inventory needs of retailers, determining one or more desired or preferred products, optionally with restrictions on time, location and manner of availability for purchase or other availability such as rentals and other transactions if purchases are not the relevant form of transactions, and communicating the information to the individual. Security of the sale may be maintained by various means. For example, participants may be provided a unique identifying code to the individual or the communicated information, which code may be checked before completion of the transaction, for example. In another variation of the invention, a reward is provided in the form of access, either at a restricted website or otherwise, to information about discounts, sales and other information of interest to prospective purchasers of goods or services, which information may or may not be generally advertised to the general public at that time or at any point in time and under any other circumstances. The information may or may not be intended for later advertisement to the general public, or it may never be advertised outside of store locations, for example. The reward may be in the form of a reward in a program as previously described. The reward may alternatively occur as the result of the performance of a task or activity, for example, as an immediate reward for clicking through successive pages of content (such as advertising content at a website) that a sponsor may desire the individual participant to view or may be provided without requiring such action on the part of participating individuals. If desired, time and attention measures, either as described in my prior filings or other variations for measuring attention and time, may be employed and used to restrict access to rewards that may or may not have a limited use value such as information regarding upcoming sales and other information, access to advice deemed valuable such as legal and/or medical advice or other information deemed to have value for any reason.

### Email Forwarding for Rewards

In another invention, the activities rewarded by a method and program of the invention may include the forwarding of e-mail messages to others, including within specific times and in other ways.

### Postal and Package Shipping and Delivery

The adoption/use of preferred methods for mail, postage stamps, metered mail, postal meters and other purchase/payment processes related to mail, adoption of electronic means and other methods for transmitting, sending and/or receiving documents and other goods and services may be rewarded. The acts of providing mail or packages to a service provider may be events in this variation of the invention. For example, selecting a provider of delivery services may be decided based on the offer of rewards as described herein.

### Document Transmission, Receipt, Preparation and Authentication

Transmission of electronic messages and documents in electronic form, with enhancements, such as additional security, reporting to the sender as to progress and review, and the like is available. Such enhanced services are likely to require the payment of additional fees. Incentives may be provided to senders, recipients, and anyone involved in the process of sending such enhanced messages. Transmission of documents such as sending and/or receiving documents such as insurance policies and others may be accomplished using enhanced means to assure security. The methods and systems of the invention, as noted above, may be employed in connection with incentives for preparation and authentication of documents. For example, tax preparation services may provide incentives for use of their services.

### Text Messaging/Interactive TV Incentive Solutions

In another invention, although various incentive-based methods related to interactive television have been developed, interactive television has been slow to develop in most major markets and few have translated into a commercial success. However, the concept of sending text messaging for display on television programs using various means of communications including telephone-based technologies such as wireless telephones including particular phones such as celebrity phones described above so as to have those text messages appear on television screens has proven popular in various commercial markets. A need exists to enable interactive television content providers to coordinate the interactive behavior of consumers of interactive television who may engage in desirable tasks and activities such as sending and receiving interactive text messages that may be displayed on television broadcasts or in other various ways in conjunction with an interactive television broadcast such as simultaneously on websites and possibly at desirable times of the day, desirable days of the week and/or based on other criteria that may or may not include time-sensitive considerations.

### Award of Points at Outset

In another arena, individuals who register in any of the various programs may be awarded a prescribed number of points at the outset of the establishment of the relationship and/or at the outset of a particular promotion. Thereafter, if individuals perform or avoid the performance of one or more tasks or activities within prescribed times, the points and/or entries in sweepstakes drawings and other rewards may then become earned and available for use and or redemption in applicable promotions, subject to other program restrictions that may or may not be deemed relevant in given circumstances.

### Preferred Status

In another invention, a need exists for providing incentives only to individuals (including individuals, organizations, sites, and other groups) that have a preferred status as described herein. The preferred status may be available, for example, only to those who have a version of a product, such as a software product, that meets certain criteria. The criteria may include that the version be the most recent release of the software product, or a version no older than a certain limit. For example, all registered users of the most recent release of a software program may be eligible for certain benefits. Such benefits might include points related to certain activities online, access to content online that is otherwise unavailable, discounts on products and services, and other benefits. Tools might be included within the software to activate the benefits. Other examples of products and services eligible for such preferred status might include owners of the most recent model of a certain automobile, subscribers to certain levels of services, such as telephone services, maintenance plans, insurance plans, and other types of continuing services. This status may be applied to any service or product of any description.

The availability of such benefits may expire after a certain length of time, or when the next version of the product is available. For example, the preferred status may be available only if the consumer becomes a registered user of the next upgrade of the software within a certain period of time after it becomes available. The preferred status may remain available for a selected lifetime of a product, such as four or five years for an automobile.

### Celebrity Rewards Programs

In another invention, there are examples in the prior art in which earning rewards through the use of particular payment cards are associated with various groups and organizations such as sports teams and special interest groups. Other examples of payment cards associated with rewards involving celebrity-focused activities in the prior art include payment cards that from time to time offer rewards to individuals consisting of entries to win trips to special events such as sporting events that may include being accompanied by a celebrity such as a sports player to the event. Other examples of rewards associated with special interest activities that have been associated with payment cards in the prior art include using payment cards to earn entries to win a trip into space each time the particular rewards program related to a payment card that may be used to make purchases and complete other transactions so as to appeal to consumers who have a desire to win such a trip. However, a need exists for a loyalty program to be structured around and associated with or sponsored by a particular celebrity or a particular group of celebrities on an ongoing and sustained basis through incorporation of various products and services such as payment cards that may result in individuals earning rewards that are specifically structured around the sponsoring celebrities and/or around other celebrity-oriented activities and events that may be of interest to consumers. The invention involves a celebrity-focused rewards program structured around a potentially unlimited variety of tasks, activities, goods, services and preferred payment methods including, for example, electronic methods as well as a payment card that may be specifically associated with, or sponsored by a particular celebrity or a particular group of celebrities on an ongoing and sustained basis. The adoption, mere possession and/or the prescribed use of the celebrity-sponsored payment card associated with the celebrity rewards program may result in consumers earning various rewards that may be specifically structured around the sponsoring celebrities and/or around celebrity-oriented activities and entertainment events and other activities on individual occasions and/or on a recurring basis over time.

### Achievement of Health and Fitness Goals

In another invention, there are examples of promotions such as television shows that reward successful contestants with rewards such as vacations. Rewarding memberships such as health club memberships, possibly in conjunction with rewarding the timing of their payment of membership fees, may be coordinated with achievement and retention of established weight loss parameters and other fitness-related goals, time of visitation to health clubs, possibly such as during off-peak hours may be rewarded or provided bonus rewards and other benefits to inspire continued membership and at preferred times that balance demand. Other tasks and activities may also be rewarded.

### Public Service Rewards

In another invention, employment in certain occupations may be rewarded due to special considerations such as separation during times of need such as may occur from time to time involving military personnel, police, fire, civil defense and their dependents and others may benefit from a targeted rewards program and the good will that will be generated by providing bonus rewards or other preferred treatment, access to legal services based on their status and other factors.

### Conformity with Laws

In another invention, conformity with laws such as traffic laws, regulations and any other rules under various circumstances may be rewarded by interested parties. Avoidance of violations such as traffic violations may be provided in a program and rewards may be positive or negative in nature as described herein.

### Conformity with Desired Conduct Including Protocols

In another invention, this technique may of course be applied to other professionals. In another invention, a need exists for rewards and programs that may be employed to provide incentives and rewards for conforming by participants, such as professionals to established protocols, regulations and other desired behavior parameters. Other methods may be incorporated in a single program. For example, medical professionals may be provided with incentives to conform to various policies, procedures and protocols. Assessments may be reviewed over time and rewarded, possibly after the passage of a prescribed period of time when assessments may be performed, for example. Other variations may be envisioned. In another invention, medical providers may be provided benefits in a program for avoidance of improper disclosure of records such as medical records and for membership in a plan to provide protection in the event of violation of codes and other regulations, for example.

Services, including professional services, membership in prepaid plans and other use may be rewarded and may be provided programs and made available for point redemption.

In a further embodiment of my invention, any of the methods and systems described in this application and in any of my applications referenced above may be employed to provide incentives and rewards for conforming by professionals in connection with their practices with activities, policies and tasks determined by employers, clients, insurers and others. Points may be awarded on a highly granular basis for particular practices, such as for attorneys to perform such tasks as prompt compliance with requirements for submission of billing records, devoting time and effort to projects which are not counted as billable time, and other requirements.

### Volunteerism Online and Offline

As noted in my prior patent applications, volunteerism may be rewarded. For example, participants in neighborhood watch, online tutors and mentors, blood donors, listed organ donor participants, volunteers such as firemen, ambulance personnel and others who contribute a certain number of hours to various tasks and activities and others may be rewarded by interested parties such as government entities and others and for any reason. The time devoted to volunteer efforts and other considerations may be factors in a program and rewards, including payments may be provided.

### BRIEF DESCRIPTION OF THE FIGURES

FIG. 1 is a flow diagram of a process according to the invention.

FIG. 2 is a flow diagram of a process according to the invention.

FIG. 3 is a flow diagram of a process according to the invention.

FIG. 4 is a flow diagram of a process according to the invention.

### Detailed Description of Embodiments of the Invention.

### Influence and Alteration of Behavior

This application describes below a series of methods and systems generally designed to inspire desirable new behavior and to influence existing behavior by individuals, groups, businesses and other entities and alter the status of assets. The influencing of behavior may be accomplished by any interested party including a government agency, businesses, groups and/or individuals who may desire to achieve specified goals. These methods may be incorporated without causing negative reactions or offense by individuals and others that may occur in some cases, through the assessment of penalties that may include direct monetary penalties or other punitive actions against individuals and others. Requests for alteration and the extent of the alteration may or may not be known to targeted individuals or groups in advance of the requested alteration in timing or nature of behavior. The method of the invention also provides for rewarding desirable behavior in a highly granular manner by the award of small numbers of points for minor modifications of behavior, incentivizing repeated modification of behavior by withholding rewards until the desired behavior has been repeated or providing additional increases in award amounts for repeated behavior, and for arranging a wide variety of available awards for which points may be redeemed. The requests may relate to the performance of specified tasks and activities that may have greater value if performed in another way or at another time, place or context that may or may not be time-sensitive. The requests may relate to providing incentives in programs for the singular or repeated modification of behavior by withholding rewards until the desired behavior has been singularly performed or repeated or by providing additional increases in point award amounts for singular or repeated behavior in real-time or at a later point in time, and for arranging a wide variety of available prizes and awards and categories of prizes and rewards for which points may be redeemed randomly, at prescribed times and in greater or lesser prescribed amounts as may be deemed desirable by the offeror of points or by the individuals, groups and others. The method, system and program may be applied to any value-generating tasks and activities, including those described herein and previously. Incentives may be provided for furnishing a product or service, or for meeting thresholds related in some manner to a product or service. Those thresholds may involve quantities, timeliness, quality and other factors. The method, system and program of the invention, a wide variety of incentives may be provided for compliance. Governmental sponsors of a program may provide tax incentives, such as credits or deductions that are available for redemption. Incentives may also be provided in the form of making available barter opportunities, auctions, trading opportunities or other marketplaces in which exchanges can be made as well as various services and other circumstances as described herein.

All forms of incentives may be awarded in all of the various described methods including discounts on related and unrelated services, sweepstakes entries, redeemable points and all other items of value and credit forms that may be deemed valuable now or in the future. Others include methods and points programs including the possibility of receiving enhanced or bonus values over baseline values involving individuals, selected groups of individuals within a community, entire communities of individuals and others that may or may not include geographic considerations as a factor in the offer or award of points and other factors.

One or more of these programs may be implemented through an intermediary, among others may provide the service of communicating by and between the individuals who participate and the entity that is otherwise involved in an interaction, transaction, coordinated tasks and activities, disparate tasks and activities with the individuals, groups and others. The intermediary or other point administrator may also award points and arrange for redemption of points as needed so that individuals, groups and others may control the dispersion of personal data in various ways such as on a permission-only basis and/or on a by-invitation-only basis and across multiple companies, organizations, existing technology infrastructures and existing activity infrastructures. Points may awarded as described herein and previously based, in part, on any algorithm, and may include enhanced rewards for multiple individuals and groups participating in and doing so on a consistent or inconsistent basis over time involving selected tasks and activities and other behavior, occurrences and events, including those events described or referenced herein. Selected and defined groups of individuals and assets may be formed that may each enter or be entered into a single event such as a transaction or into multiple transactions.

The methods and systems of the invention as disclosed in my prior co-pending application may provide benefits to a third party based on the performance of the task or activity by one or more actors. This principle is described in my co-pending application. An additional example of this extension of the benefits is awarding benefits, not to the person performing the activity but to a third party. For example, benefits may be provided to family members for the performance of tasks and activities of participants. The benefits may include vouchers, discounts and other rewards that may even be enhanced, reduced or otherwise made available, optionally contingent on participants performing various tasks or activities as may be deemed desirable.

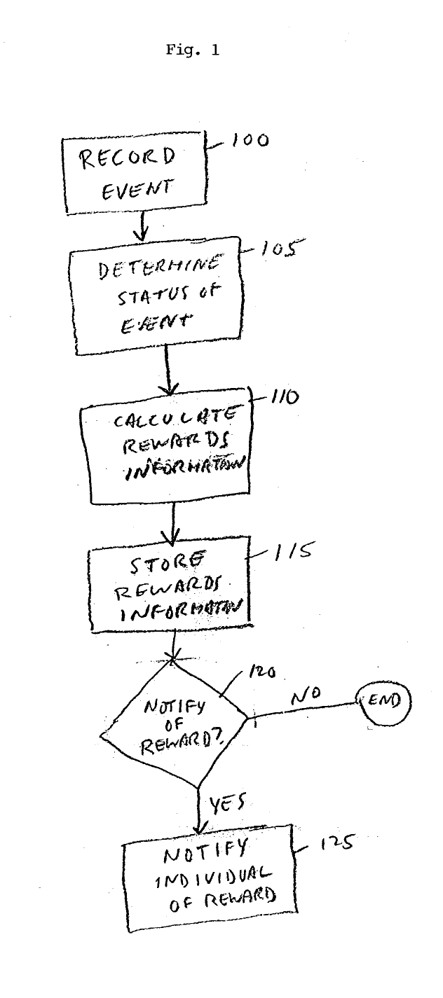

In general terms, these methods are described with reference to FIG. 1. In FIG. 1, a process flow is illustrated for a method of the invention. The process flow commences at 100 with recording of an event. A wide variety of events have been describe previously and described below in various embodiments of the invention. An event is typically an action taken by an individual who is enrolled in a rewards program. However, an event may be in the nature of an action taken by another. Depending on the event, various types of information are recorded as to the event. In the case of a payment, information such as date, time, amount and account number are recorded.

The next step is the determination of the status of the event in relation to a rewards algorithm, as indicated by block 105. The process makes the determination of whether the event is to be taken into account in connection with the rewards algorithm. If required information, such as the identity of the individual, is absent, the event may not be taken into account, and the process will end. If the status is determined to be relevant, then the event information is passed to the rewards algorithm.

The next step is the calculation of a rewards amount in accordance with the determined status and a rewards algorithm, as indicated by block 110. The awards amount will be determined as a numerical value, which may be referred to as points. The algorithm may include a wide variety of factors, including both information related to the event itself, and other information. The other information may include prior performance by the individual, background information about the individual, and other information. This information may be obtained from databases and processed in accordance with the rewards algorithm.

The process flow then proceeds to storing the reward information. The calculated reward information may be stored in a suitable memory location in computer equipment used with the method.

A notification algorithm is then consulted to determine if an individual is to be notified of a reward, as indicated by block 120. A notification algorithm may provide for notification under any criteria. Such criteria may include numbers of points, date information, or other information. If no, then the process flow triggered by the event is at an end. If yes, then the individual is notified of the reward. The notification may be in the nature of notification simply of a number of points. The notification may also indicate that awards may be redeemed. If the rules of the rewards program call for automatic redemptions and rewards, such as a higher level of service or benefits, then this will be indicated in the reward notification. Notification may take any desired form of communication, including by periodic statement, posting to an electronic location, such as a secure portion of a website, paper communications, telephone, e-mail, and any other form.

### Payments Submitted by Preferred Times and Methods

In one aspect of the invention, a method is provided for altering behavior related to use of money, including recording information associated with an event related to money and an identified individual associated with said event, determining a status of the event in connection with a rewards algorithm, and calculating reward information in accordance with the rewards algorithm, and notifying the identified individual of the calculated reward information.

These methods may be used in connection with bill payments, so as to encourage the adoption and continued or other prescribed use of alternate method of payment of recurring bills. Methods such as payment through a website, authorizing checks by telephone, and other methods, may be encouraged through these techniques. The use of new forms of funds and new or preferred accounts to pay bills on a continuing basis may be encouraged, apart from the initial adoption. The form and length of loans and other credit instruments and other factors including those described herein and previously may also be incorporated in any and all incentive solutions.

In one example, a condition is the receipt of bill payments by certain dates or specified periods of time following bill presentment. Thus an event is the receipt of a bill payment, and a status may be the period of time prior to the due date that the bill payment is received. These dates may or may not include stated due dates or other dates that are earlier than stated due dates. Alternatively, the condition may be the adoption of a particular bill payment method, such as the authorization of an electronic transfer of money to the payee, for example. Otherwise stated, the payer is placed in a better position by payment of bills earlier within recurring billing cycles, including prior to the stated due date, or by complying with other or additional conditions. The payer must meet specified conditions for payment. The particular details of placing the payer in such a better position may vary widely. Either the payer may receive some value not otherwise available, or avoid a cost that the payer may otherwise incur. The value may include any item of value, and the cost may include a cost of any kind. The reward is thus either value or a cost. The value may be in the form of points, for example. The cost is also calculated, in which block 110 would be the calculation of cost information, and block 115 the storing of cost information. The cost may be the loss of something of value available only on condition of complying with the conditions. Incentives are provided particularly for complying with accelerated payment conditions on more than one occasion, and/or on consecutive occasions. These methods may be combined or coordinated with other methods described herein.

### Movement of Money by and Between Parties

In a method of the invention, the event may be a transfer of money. The transfer may include generally any and all transfers for any reason, including in fulfillment of any form of legal obligations that may be owed by transferors or owed by other third parties, or for reasons of family obligation or goodwill and/or as acts of charity and for other reasons. Recipients may include family members, including relatives of any separation, friends, business contacts, charities, and others, who may or may not reside in other countries. These methods are also intended to apply to the transfer of money for any reason to any recipient directly and/or indirectly, including family members and/or to businesses and other entities, possibly in other countries, that may or may not be owed money by third parties, including family members or that may desire to establish a credit account or other form of relationship with one or more individuals for any reason that may be desired in particular circumstances involving transferors, transferees, the transmitting agency and/or on or more other third parties, including third party beneficiaries. The reward algorithm may take into account events associated with more than one individual. For example, two members of a family may be enrolled in an incentive program, and both may receive points when both use the same service when one transfers money to the other.

These methods may be incorporated in the business-to-business context. For example, a business may reward its customers with a points system for engaging in funds transactions, such as early payment or payment in a particular manner, including by ways other than a sweepstakes redemption approach that may be offered in a business to consumer context. The rewards may not be sweepstakes entries, but items of value to a business, such as additional goods or services without charge, preferred pricing, additional benefits, a preferred status for the receipt of future offers and the like.

These disclosed methods for offering rewards may apply to individuals, families, groups, businesses, charities, and/or other sponsoring organizations that may have any connection to, or interest in the transfer of funds by any methods and for any reason and may incorporate consideration of one or more individual background profile factors described in prior filings. The transfer of funds may be for any purpose including the payment of bills, sending money to one or more individuals, including friends and/or family in any location including remote locations, including one or more locations in other countries. In the cases of the transfer of money, there may be a variety of purposes for transferring funds including the payment of bills by and to individuals and businesses, the sending and receiving of funds by and to individuals and businesses and other third parties over various forms of electronic networks and by other means. The incentive may be provided to a transferor or a transferee, or to a designee of either. The benefit may be sponsored by an funds transfer agency selected by the transferee, once selected by the transferor, and may include either end point or one or more intermediaries.

In another aspect of the invention, an incentive program may be provided with respect to electronic transfer of money between individuals through an entity such as a business entity, intermediary or other infrastructure that may accommodate the processing of money generally and other payments and for any reason. The use of the appropriate intermediary constitutes a status of an event that qualifies for processing in the algorithm of FIG. 1. Incentives may be provided both to a payer that sends money or other value for any reason to a payee for participation when deemed appropriate. Both individuals and/or other participants, such as businesses or other entities may receive points that may be redeemed for some item of value such as a sweepstakes entry, or the payer and payee may separately receive points in conjunction. Such points may be combined with other programs, or may be redeemed for-some item of value such as a sweepstakes entry and/or other credits and/or rewards. If desired, the number of points may be adjusted for any delays, whether inadvertent, intentional, planned or unplanned, between deduction of the funds from the account of the payer and crediting of the funds to the account of the payee and in other ways.

According to one aspect of the invention, behavior to be rewarded is the adoption of a fund retention or transfer method. The conditions of the program may include time constraints to accumulate or earn points or rewards. Fund retention methods may include such items as magnetic stripe cards and chip cards, either for general purpose or limited to specific businesses or coalitions of businesses. Such cards have been used by large mass transit systems for many years, and are gaining increasing use for purchases such as taxicabs and parking meters.

Alternative methods for transferring funds by and between individuals may include the use of wire transfer networks, ATM networks, other methods that may be located in particular commercial establishments and the adoption of other preferred methods and locations to accomplish the fund transfers and others that may entitle participants to rewards and/or points and/or bonus rewards and/or bonus points. Other factors that may be employed in the algorithm of FIG. 1 to influence entitlement to rewards and other value in addition to previously described methods and variations may include consistency of participation; amounts transferred; locations of origin and/or receipt of the transfer and/or transferor; the background profile status of transferors and/or transferees in the network or program, such as whether the recipient is a program participant and/or the recipient's record of participation; the performance by the sending and/or receiving participants of any desired tasks and/or activities such as making purchases at specified locations at either end of the transfer; maintaining minimum account balances and an unlimited range of other considerations that may be deemed relevant or valuable.

The points that may be accumulated and/or earned in this program and in all other rewards programs previously described in prior filings including all bill payment activities that may be combined in a single account and/or program. In addition, other conduct may be considered and points may be accumulated and/or earned and/or redeemed in all of the various ways that were previously described. Beneficiaries of redemption may include participants as well as other selected individuals such as family members and other individuals, businesses, charities and other groups, as well.

It may be deemed necessary for participants to meet and/or exceed certain thresholds, such as a minimum number of transfers, a minimum amount of funds transferred, a minimum account balance and other factors, in order to obtain, accumulate, earn and/or redeem points that may be available through the program, possibly within variable time parameters, such as within selected time frames that may change from time to time.

The method and system of providing points, sweepstakes entries or other items of value contingent on certain activities may be made contingent on performing specified transactions related to funds. Such transactions may include payments, transmission, deposit and/or withdrawal of money by certain methods including as described herein and by optionally meeting other conditions, such as time of day, day of week, date ranges, and other method that alter the status of money, funds stocks, bonds, technologies and other assets. Any change in possession or control of funds or other value may be a transaction which may be subject to the methods and systems described above.

Assets other than money may be subject to incentives in accordance with the embodiments described above. Various assets including money, money in accounts, certain account balances, technologies, vehicles, membership plans and other assets may be coordinated in various ways depending upon applicable circumstances. A provider may make such a selection or status a requirement or may make this option available for later selection. The redemption may or may not require consent of a holder for each asset. A benefit may be, for example, a membership in a services plan, such as a prepaid legal services plan, which membership may be used by any of the card holders or other designated persons. For example, this benefit may be marketed as an option for a group of relatives and/or friends to obtain such accounts so that a services plan, such as a prepaid legal services plan is available for any of the relatives and/or friends to use. The actions of any one person in the group may be deemed an event, and the benefit will be available to all upon obtaining a sufficient number of points, for example. It will be appreciated that this type of arrangement may be extended to accounts in which points or the equivalent may be redeemed for any specific type of reward, or for a variety of rewards. Other variations may be envisioned. These methods may be combined or coordinated with other methods described herein.

### Movement and/or Retention of Money by One Party

An event may be the retention of money in one account or the transfer of money under the control of a single party, as distinguished from transfers.

In the context of the movement, retention or other alteration in the status of assets such as money, the amount of funds involved in other types of transactions, the time, and repetition of the transaction, may also be considered as factors in rewarding individuals from time to time. The transmission or other transfer of money, whether to another account possessed by the transferor or otherwise may be in any manner, including money orders, cash cards (which generally represent a prepaid account that is debited as purchases are made but may include other approaches), debit cards (generally linked to a bank account), payment cards or devices linked to a bank account or credit card account, or other manner of transmission. The method and system of providing points, sweepstakes entries or other items of value contingent on the performance of certain tasks and activities may be made contingent on the transmission, deposit and/or withdrawal of funds by certain methods and by optionally meeting other conditions, such as time of day, day of week, date ranges, and other method that alters the status of funds including fund transfers, deposits, withdrawals and others. The amount of funds and the length of time that funds are maintained/transferred or received may be considered in rewarding individuals from time to time.

In one example, the event may be the purchase of such items as special or general purpose magnetic stripe cards and chip cards, and/or the use of such cards. Points may be provided only for the initial adoption of a particular type of payment or fund retention method, and the points may be made contingent on the timing of the adoption. The algorithms for the reward of points may set certain conditions for the accumulation of points and certain conditions, such as repeated use, for the earning of points. Points may be awarded based on the number of purchase or use transactions, on the dollar value of such transactions, or based on any other formula desired by a program provider.

The reward may be based on the timing and/or method for the movement of funds. For example, the movement of funds from a bank account to a chip card within a certain time window may result in the accumulation or earning of points. Funds may be moved from a credit card account or other loan account to a chip card or other form of digital money, and the timing of that movement may be rewarded if within specified parameters. In general, the timing of the movement of funds from one account or device to another account or device may be rewarded if within certain parameters.

The length of retention of funds in a given form may be rewarded. For example, the retention of funds over a certain time in a chip card may be rewarded. Alternatively, the rapid use of funds on a card may be rewarded, to enhance consumer acceptance. The retention of funds in other types of accounts may also be rewarded.

The specific use to which methods such as chip cards and the like are applied may be rewarded. Specific methods of transferring funds, such as by an Internet transaction as opposed to in person or by telephone dial-up, may be rewarded. The specific manner of spending funds on chip cards or other similar items, the place, or the type of item purchased may be rewarded. Manners of spending funds may include, for example, in a store, or in a device, such as a parking meter or vending machine. The place of spending funds may include by way of example in a particular store or class of stores, or with a type of device. The nature of items purchased may include, by way of example only, food items, restaurant services, taxi fare, clothing items, parking, and other goods and services. These methods may be combined or coordinated with other methods described herein.

### Advanced Purchases and/or Payments

In another embodiment of the invention, any of the methods and systems described in this application and in any of my applications referenced above may be employed to provide incentives and rewards for the purchase in advance of the use of the service or product. It will be understood that this method is a method involving movement of money or other funds or credit, wherein the movement or delivery of funds is a purchase, and a factor in the algorithm is the timing of the purchase. Examples of services that may be prepaid in this manner include electricity consumption, telephone usage other than prepaid service, postal services, such as purchases of stamps for usage at a later time, purchases of postage for postage meters, and other methods. Other examples include advance purchases of services ranging from prepaid legal services to travel-related services, such as airline tickets, accommodations, such as hotel and motel rooms and the like. Airlines may provide additional incentives, beyond price incentives, for purchases sufficiently far in advance of ticket usage. For example, airlines may provide additional points in an existing program for purchases of tickets in advance of the advance purchase requirement for the least expensive ticket, for example. This method may be made as granular as desired, such as by providing an additional reward for each day in advance. For example, if the lowest cost ticket for travel on particular routes requires purchase 45 days in advance of travel, a reward could be provided for each day earlier than 75 days in advance of travel a purchase is made. In the alternative, this technique may be oriented to reward the latest purchases prior to the occurrence such as purchases of tickets for time-sensitive transportation such as bus tickets or airline tickets. These methods will tend to improve cash flow for airlines and other travel service providers.

In addition, in light of prior filings related to redemption of points in various ways that may be a factor in how programs are structured, the listing or display of items that may be available for sale with special codes or other identifiers can enable calculation of a number such as by using a formula that would then enable consumers to know the amount of points necessary for redemption without directly listing that information. In addition, in the same way that I separate the purchase and payment process, the rewards redemption process may be separated. The items may be available for redemption and, for example, individuals may be required to call a separate telephone number or access another website with a code to complete the redemption process. The redemption values may be a factor related to the listed price at any point in time so that the number of points necessary to obtain the item may be simply calculated based upon the listed sales price. The items may be available by mail if appropriate, such as concert tickets and sneakers or items may be made available at particular physical locations for redemption, so as to increase overall consumer traffic in stores, as well.

### Other Adjustments to Conventional Payment Methods

The methods and systems for altering the timing of payment, for separating payment events from purchase events, may include providing incentives for adoption of prepayment for services, in addition to accelerated payment of bills based on prior payment for goods and/or services. Prepayment means furnishing funds in advance of provision of goods or services that generate bills. Prepayment may mean obtaining a service for a specified duration, or a specified quantity of goods and services. A duration may be, for example, a period of membership or duration of right to participate or to use services and others. Points programs and sweepstakes entries as described in my prior co-pending application may be employed to encourage prepayment. Distinct types of accounts, as described above, may be provided for either prepayment or payment based on later billing. Budget plans and other forms of payment that may be based on estimated consumption levels or other criteria, under which a set periodic fee is prepaid for a specific quantity or duration of goods or services, may be encouraged through the use of these methods. Bonus rewards such as enhanced prize values and others may be furnished based on any of the above factors, and may be based specifically on the amounts prepaid or quantities or duration for which prepayment is made as well as possibly based on other factors.

In a system and method for providing incentives for adoption of preferred timing and methods for the payment of bills, incentives may be provided for the timing of the payment of bills at certain periods prior to the last day within a billing cycle for payment prior to the imposition of fees, costs and penalties. Alternatively, payments may be processed by other companies and within that context, alternate payment deadlines may be established in a setting that may not involve the ultimate recipient of the bill payments in question. In either case, as individuals are increasingly able to select a precise date for the payment of recurring bills and as individuals actually select the last day for payment of recurring bills prior to the imposition of costs and penalties may be subsequent to the date that is termed the existing due date, even causing payments to be received by the existing due dates may be made the subject of incentive offers. For consumers who enroll in an automatic bill payment plan, which typically deducts either the total amount of a periodic bill or the amount of a loan payment, on a certain day each month, the consumer may be provided with multiple offers of incentives to select one or more earlier payment due dates within a particular billing cycle. Incentives may be offered in ways that may require the early payment of bills by certain dates or the payment of bills by certain methods for a prescribed number of times during certain time period.

In the arena of payment card activity set forth herein and in previous descriptions set forth in previous patent filings, a payment method such as a payment card provider that offers customers an opportunity to redeem points for access to legal services or legal plans will desire to promote awareness of those benefits. The rewards in the nature of legal services or legal services plans that may include ID theft prevention related services and ID theft recovery-related services and/or other legal or quasi-legal tasks or activities as benefits that may be bundled in a services plan. For example, credit report surveillance and legal services relevant to repairing the credit profiles of individuals who are victims of ID theft may be provided. Such benefits that may be available, in a rewards program related to credit card activity, for example, to all or certain credit card customers who will benefit from the added security provided in the form of legal or quasi-legal services. Once legal service is provided to individuals, such as those who obtain a will or receive ID theft prevention or recovery services, those individuals are likely to see the benefits of such a plan and to choose to remain as long term participants whether or not payment for the benefits are provided by customers or companies that benefit from participation through payments into the plan or other methods of support or contribution. In certain selected circumstances, membership in the plan may be priced differently depending on the circumstances presented. For example, an individual may be presented with the opportunity to obtain price insurance alone at a certain price that if combined with ID theft protection under a legal and quasi legal services plan will attract more individuals than either service offered alone. As a participant benefit, such members may receive the services of an attorney at a real estate settlement, and the benefit may include ID theft protection provided as a benefit. A legal service provider will have access to the individuals in order to educate them about the merits of legal services available under legal plans. Moreover, the ID theft protection program itself as described herein may be incorporated so that credit card customers will receive the ID theft protection benefit without payment of an additional fee, possibly if certain balances or other criteria are met. The imposition of minimum purchase requirements, minimum balance, direct payment, maintenance of other accounts such as checking accounts as well as the performance of other tasks such as meeting minimums for a prescribed period of times may or may not be required as a condition of receipt of benefits in a program. For example, customers who adopt and/or use their payment cards in a prescribed ways such as by making a minimum number of purchases with their credit cards may be rewarded in various ways including with extended ID theft legal service protection and other benefits.

### Accelerated Payment Accounts

The methods described herein and previously may be incorporated separately or combined with the embodiments of the invention set forth herein and below in various ways including in an accelerated payment account as described herein. For example, two or more accounts are provided by a payee. A first account may be a conventional account. A time period may be provided for the payment of bills within an established grace period, for example. The account may be an account for payment of bills for products or services, or an account for the repayment of loans, leases and other similar activities. This time period may be a conventional period. Typical time periods for payment of bills vary, but are typically twenty to thirty days from the bill date for many types of bills. For loan accounts, penalties for late payment are often only imposed if the bill payment is received more than a certain period of time, such as fifteen days, after a specified payment date. A conventional type of loan account would provide such a time period.

A second account provided by the same payee is an accelerated payment account. In the accelerated payment account, a cost or other penalty may be imposed if payment is not received within a shorter period of time than in the conventional account. For example, if a conventional account provides 25 days from the bill date for payment without a penalty, then the accelerated payment account may provide 15 days from the bill date for payment without a penalty. These time periods are of course merely exemplary as are the circumstances in which programs may be implemented. The accelerated payment account also provides a benefit to the payer, which benefit is not available to the payer in the corresponding conventional account. The benefit may be the award of points, sweepstakes entries, enhanced rewards and prizes related to other incentive-based activities or other benefits as described in my co-pending applications incorporated by reference above, or any other type of benefit. The benefits may be conditional or immediately earned, or require redemption by an affirmative act by the payer. The cost for late payment may be a late fee, interest charges, or loss of the accelerated payment account. The penalties for late payments would not be the loss of the described benefit, as the accounts would no longer be distinguishable.

The accelerated payment account may feature the same grace period, but require a distinct payment method, such as electronic transfer of the money, possibly including transfers from a preferred account. In this embodiment, the payment of mortgage accounts by direct deduction from a bank account is excluded from the scope of the invention, though other methods such as sweepstakes programs and other rewards are not.

The accelerated payment account may have alternate payment features, such as electronic payment after certain specified types of transactions, or after account balances reach certain thresholds.

It will be understood that these alternate accounts need not be represented by distinct accounts having distinct account numbers. For example, the status of an account may be changed between conventional and accelerated payment.

In an example, a credit card issuer may make available both a conventional account and an accelerated payment account. The conventional account may provide for payment within 25 days of the bill date to avoid late charges and, if the balance is paid in fill, interest charges. The accelerated payment account may provide a benefit not available in the conventional account. The benefit may be points or other benefits in an incentive program of any type, or other benefits. Benefits include points redeemable for entries in sweepstakes drawings, points directly redeemable for items of value, enhanced rewards and prizes related to other incentive-based activities and others. If desired, the right to redeem points may be conditioned on maintaining the account for a certain prescribed period of time, a certain number of billing cycles, a certain prescribed payment amount, or other criterion to encourage greater use of the account. The accelerated payment account may provide for payment within 10 days of the bill date to avoid late charges, and, if the balance is paid in full, interest charges. The payer will continue to obtain the benefits of the accelerated payment account, even if payment is not made within the required 10 days.

Of course, the time periods and type of account are merely exemplary. This method may be applied to utility bills, loans, bills for services, and other types of bills that may or may not be subject to a due date or other payment deadline. This method may be applied to both consumer loans and bills and to business loans and bills. For example, for a loan account, an accelerated payment account may impose a penalty if the payment is received even one day after the stated due date, while a conventional account imposes the penalty only if payment is received more than a certain time period after that due date, such as ten or fifteen days.

In an accelerated payment account, additional benefits may be provided for payments in advance of the stated due date. These benefits may be awarded based on a formula that increases the benefits for each day that the payment is earlier, each second day, or other time period. Thus, an incentive may be provided for increasingly early payment, for example as described herein and previously. By providing a formula that is responsive in a granular manner to earlier payment of bills that may be subject to due dates or other parameters, the payer is provided a further incentive for early payment.

The accelerated payment account may also require payment in a certain manner. For example, payment by pre-approved electronic transfer may be required as a condition of the accelerated payment account. The time period from the bill date to the date of the automatic transfer may be shorter than the corresponding time period in a conventional account. Other payment options, such as payment by telephone approval of an electronic transfer, or by online authorization of an electronic transfer, the use of a credit or payment card may also be additional or alternative conditions for an accelerated payment account.

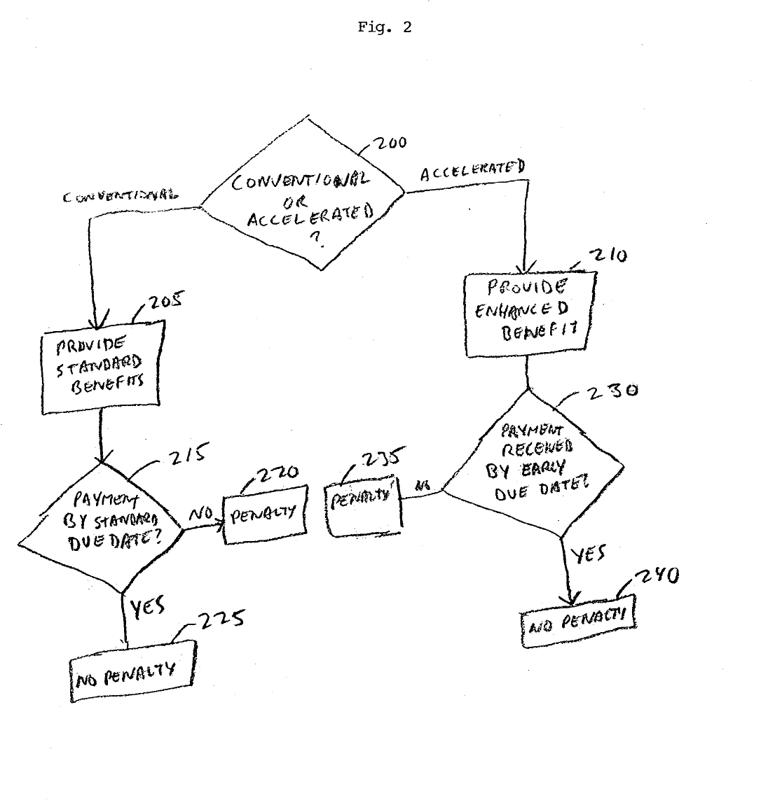

Referring to FIG. 2, the payee or prospective payee will thus select between a conventional account and an accelerated payment account in advance. As indicated at 200, a selection is made. If the conventional account is selected, standard benefits are provided. If the accelerated account is selected, as indicated at 210, enhanced benefits are provided to the individual. If payment is not received by the standard due date in the conventional account, then a penalty may be imposed, as indicated by block 215 and 220. If payment is received by the standard due date, later than the early due date, then no penalty is received, as indicated by block 225. If, as indicated by blocks 230 and 235, payment is not received in the accelerated account by the early due date, then there is a penalty. If payment is received by the early due date, there is no penalty, as shown by block 240.

The customer's selection will govern the conditions and timing of payment for multiple payment cycles in the future, unless changed by the payee or payer. For example, when applying for a credit card, a consumer may select either a conventional card account or an accelerated payment card account. Similarly, when contracting for utility service at a new residence, a consumer may select either a conventional utility billing account or an accelerated payment account. These selections will remain as a default over numerous billing cycles until affirmative action by payer or payee to the contrary occurs. The same selection may be made for loans, leases or other types of accounts by both consumers and businesses.

The payee may target the offer to customers selected on any particular criteria deemed to be of importance.

The use of particular manners of payment may serve as a substitute for payment at an earlier time than payment by other manners. For example, a payee may reward payment provided in a particular manner, in addition to or separate from rewarding earlier payment in a manner selected by the payer. Alternatively, a type of payment may be treated as if received earlier. For example, a payment by electronic funds transfer may be given an award the same or similar to a payment that is made by check a certain prescribed number of days earlier than might otherwise be permitted. Other algorithms may also be developed for rewarding payment in a particular manner to accommodate industry-specific issues, or the particular market of interest, related to funds transactions such as the transfer, deposit, withdrawal and/or payment of money.

### Separated Communication of Transaction Components

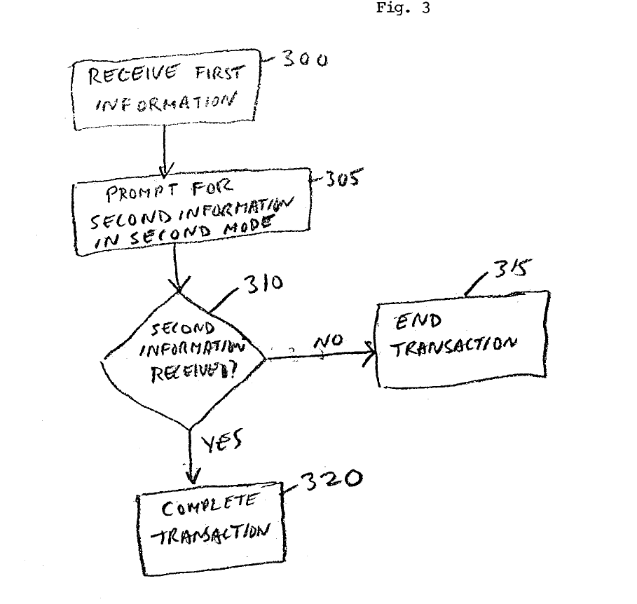

A method for entering into a transaction with enhanced security will now be described. In the method, first transaction request information is received from a transaction party in a first mode, as indicated by block 300 of FIG. 3. In response, the transaction party is prompted for second transaction request information to be provided in a second mode, as indicated by block 305. If the second transaction information is received in a suitable manner, then entering into the transaction, and otherwise terminating the transaction as indicated by blocks 310, 315 and 320. The first mode may be a device communicating over a network with a network resource. The transaction may be a purchase of goods or services, registration, completing a survey, applying for a loan, job, government benefit or other item, by way of example. The device may be of any type, including a personal computer, cell phone, or PDA. The network, an example of a first mode, may be the Internet, and the purchase may be accomplished by communication between a client and a server using the World Wide Web, that is, a purchase at a website. The purchase is made by commands from the client device to the server. A record of the purchase is created, with the first transaction request information, such as the item, quantity, and the like, shipping address, or other information depending on the nature of the purchase. In the method of the invention, second transaction request information, such as the making of payment is separated from the transaction either in time, place, or method of communication.

The activity on the website may be understood as a reservation of a product, service or other item or a partial payment or other down payment or consideration that secures the transaction. The transaction is then completed as a purchase, submission, or other item, when the individual submits the requested information as described below. If the individual fails to submit the requested information, then the reservation expires.

In one aspect of the invention, payment authorization is carried out at the time of the transaction, but through a different manner of communication. This different manner of communication is an example of a second mode. For example, the user may be provided a message from the screen display with instructions to call a particular telephone number to arrange for payment. The user may be prompted, either by a live operator or by automated interaction, to identify the transaction and provide payment information. Such payment information may include a credit card number, bank account number, digital cash device information, or other information. Alternatively, the user may be instructed to call the designated number, possibly within a selected period of time after the transaction as a condition of the transaction proceeding. A seller of goods, for example, may not commence fulfillment of the order until payment is received.

The obtaining of the payment information may be carried out by the seller, supplier of rewards or other party engaging, overseeing sponsoring or otherwise involved in the transaction. Alternatively, this task or activity may be carried out by another party. For example, a contractual relationship may be entered into between the party engaging in the transaction such as billers and others.

In an embodiment of the invention, the seller may initiate a contact by which payment information is provided. For example, the seller may cause a telephone call to be placed to a number provided by the user, and prompt the user to furnish the payment information. The call may either be automated or partially or entirely with a live operator. The call may be placed immediately or within minutes of the transaction and in other ways and at other times. For those users having a single telephone line shared by a computer and voice telephone, the call may be repeatedly placed until the line is available. Alternatively, the call may be placed within a certain time window after the transaction, for example. Such a call includes the prompt, and also constitutes the second mode. The payment may be authorized in some other manner, and the telephone call is only one option.

The buyer may be instructed to arrange for one or more payments at one or more physical commerce locations. A physical commerce location, as defined in my prior applications, is any physical location, such as a store, kiosk, cart, desk, department, or the like, where an individual must be physically present to engage in a transaction. Physical commerce locations also include vending machines, or other unattended devices, which may be used to accept payments, for example. The user may be directed to a particular single physical commerce location, such as a store or restaurant close to a location provided by the user. The user may alternatively be directed to any store or restaurant in a particular chain, either in a particular geographic area or otherwise, possibly within time specific parameters. Other identities of physical commerce locations may be selected. The user may provide information identifying the transaction, such as printed code information or an alphanumeric code, to a device or live attendant at the physical commerce location. The user then may provide payment, possibly by preferred forms, such as a particular payment method such as a payment card, for example. Preferably, the physical commerce location will accept payment for the prior transaction in any manner accepted at the physical commerce location. The physical commerce location may have access to information regarding the transaction, so as to be able to verify the payment amount in real time. However, this may be an optional feature. Physical commerce locations that accept payment may include banks, check cashing agencies, convenience stores, restaurants, and may include unattended machines, such as vending machines, or human operated transaction locations, such as bank teller windows or cash registers.

The user engaging in the transaction may have an individual background profile. Individual background profiles have been fully explained in my prior applications. The physical commerce location presented to the individual may be determined based on an algorithm including individual background profile items. By way of example, an individual whose individual background profile reflects gardening as a hobby may be directed to a garden supply store. An individual whose individual background profile reflects that the person has children may be directed to a toy store, or to a fast food restaurant. The individual may be presented with a number of choices of physical commerce locations, and the order in which those are presented may be determined based on individual background profile factors, among other factors. The owners of the physical commerce locations or their advertising agencies may provide consideration to have their locations featured exclusively or more prominently.

Incentives may be provided to individuals for visiting a particular physical commerce location, either at any time, or within a particular time window or at a particular time or otherwise in accordance with incentive programs described herein and previously. Incentives may be provided for engaging in other tasks and activities while at the physical commerce location. It is not essential that payment associated with the transaction be made in a single sum. For example, the website or a subsequent telephone or physical commerce location interaction may provide the user with the option of selecting periodic payments. By providing this option, it is possible that sales are enhanced. It also may be possible to influence the timing of demand by providing for periodic payments rather than a single upfront payment. Such spreading of payments may encourage repeat use of memberships, such as health club members, and use of season tickets to cultural and sporting events.

In an alternative embodiment of the invention, the user may be provided with the option of selecting to be billed, such as by postal mail, for a purchase. Incentives may be provided to select this option, or to select a different payment option, through a points program. The methods above may be applied to registration at a website as well. For example, a consumer may be reluctant to provide certain personal information over the Internet, but may desire the benefits of a registration which requires providing such personal information. The website may be configured to permit partial registration, provide an identification code to the individual, and permit the individual to provide the additional information together with the identification code by phone, postal mail, or some other means perceived as being more secure. These methods may also be extended to activities such as online bill payments and online loan applications, among others. Certain information associated with such payments and applications may be furnished in another manner, such as by telephone. For example, a consumer may arrange for a payment, but not provide any or all the digits of a bank account number, and only provide those remaining digits by telephone. Similarly, an online loan application may be completed except for certain information, such as some or all of the applicant's social security number. This information would be provided in the alternative manner.

In another embodiment, the individual may be provided with purchase information that may be used to authorize payment electronically from a trusted website, such as from the individual's bank.

Engaging in financial activities such as check cashing, wire transfers, and the purchase and receipt of money orders among others may be rewarded in accordance with the invention and incorporated with other rewards possibly related to discrete pricing or time-sensitive purchase-based rewards and others as described herein. These activities may also be combined with other activities in a single rewards program.

In another embodiment of the invention, the individual may be required to receive marketing information as part of the process of providing the second information in a second mode, such as in a distinct manner or at a distinct time. For example, if information is provided by telephone, the telephone call may include a sales presentation prior to furnishing an opportunity for the individual to submit the information. The sales presentation may be recorded, by a live operator, or a combination of those methods, and may be interactive. A visit to a physical commerce location may involve the receipt of printed marketing materials or being presented with a live in-person marketing presentation, a recorded audio, visual or audiovisual presentation, or other form of presentation. A visit to another location on a network may include the presentation of marketing information, such as on a series of screens or in a flash presentation, before the individual is permitted to furnish the additional information. Other modes of presentation of marketing information and advertising, both now known or as yet not commercialized or not yet discovered, may be employed and other examples may be envisioned.

In another embodiment of the invention, the individual may be provided with a choice of options relating to engagement in interaction or consumption or provision of information. The individual may be provided with the option of providing all information through the network, such as by providing credit card information at a secure website to complete a purchase. The user may be provided with one or more of the following options: immediate billing by another means, billing at the termination of the session, billing offline at a physical location. The user may also be provided with the option of selecting the combination of any of those with the option of selecting receiving a marketing or advertising presentation, either immediately or upon payment. Other options may include specified methods of presenting a bill, specified methods of payment, billing or payment at specified times or within specified time windows and other options. Various options, such as time and manner of payment and time and manner of presenting the bill, may be combined as options. Options may also include the type, length, timing, subject matter, and other variables relating to the marketing presentation. A reward may be provided for agreeing to receive the marketing presentation, and for following through on the marketing and the completion of the transaction. For example, the reward may be a reward in connection with any of the points programs and methods described in any of my prior applications. The reward may be a preference with respect to the transaction. The preference may be a discount in the price of goods or services purchased, additional goods or services, credits or coupons with the vendor with whom the transaction is processed, credits or coupons with other vendors, an upgrade in the quality of the goods or services, free or discounted goods or services available at a physical commerce location, and other items.

As an alternative, the user may be presented with the option of engaging in a specific type of non-marketing task, activity or other events, in order to have the opportunity to provide the second information in a second mode.

The timing of the performance of receiving the marketing presentation or engaging in the other task, activity or event may include a wide variety of times. Those may include in advance of completion of the online portion of the transaction, during the online activity, upon completion of the online activity, after the commitment to purchase or otherwise complete a transaction but before termination of the process to communication the commitment, after the commitment to purchase or otherwise complete a transaction but before termination of the communication or in-person interaction, before the communication of the separate information or other completion of the process, at the beginning of the process of communication of the separate information or other completion of the process, after the communication of the separate communication or other completion of the process, at a still later time, and in other manners online, through other communications media, in-person, combinations of one or more of those, at physical locations, at other times and in other variations. The user may be given the option of selecting one or more of these items.

As a further variation on the methods relating to separation of the purchases-related aspect of a transaction from the payment-related aspect of a transaction, the method may include leaving phone numbers alone and/or together with other information at websites such as “purchase codes”, requests for product codes related to “items of interest” apart from actual “purchase codes”. These methods may also include the offer of incentives such as sweepstakes entries for leaving phone numbers, email addresses, etc, and/or for requesting to be contacted to “market to me” or “explain it to me” or for any other reason so that consumers who may have an interest in products, services, information etc may be contacted by phone, by email or by any other means so that products, product demonstrations and/or any other type of information in any context may be communicated that may or may not lead to sales or other benefits depending upon the particular context and event.

In another variation of the invention, a temporary or permanent special purpose account with funds is created on instructions of the individual. The special purpose account may be, for example, a bank account or other account such as a credit card account. The special purpose account has a limit on the amount of money or amount of credit, so that the risk to the consumer of fraud involving that account is less than fraud involving typical credit card accounts, charge card accounts, or bank accounts. By way of example, a special purpose bank account may be created at the individual's bank, and the individual may direct the transfer of a selected amount of funds from another account at that bank to the special purpose account. By way of further example, a credit card issuer may provide a consumer with a special purpose credit card account with a relatively low credit limit selected by the consumer. For example, a consumer could select an amount which the consumer believes is the maximum that he or she would be likely to spend in online purchases within a certain brief time period. This amount could be the amount of funds transferred into, or a credit limit, on a special purpose account. Alternatively, an account or payment card may be subject to activation and/or deactivation when not in use by card-holders as a method to achieve added security related to unauthorized or fraudulent use. When individuals expect to use payment cards, they may be able to provide a code or other data to activate or deactivate the payment method in question such as a payment card. A consumer could provide offline instructions to a credit card issuer or bank to increase the amount in advance of an anticipated large online purchase. A special purpose account could be created for a limited period of time, such as a week or month, with the funds for a bank account returned to another account automatically at the end of the time period. Alternatively, the special purpose account could be periodically replenished with money from another account up to the selected limit. When the individual establishes or provides money or otherwise attends to this account, incentives could be made known for use of the account. These incentives could steer the individual to a particular site to engage in transactions, to the purchase of particular products, services or classes of products or services, or in some other manner may be replenished by, for example transferring purchases on a periodic basis to a general purpose credit card account with the same issuer held by the same customer, which general purpose credit card account may have a higher limit, for example. Alternatively, the available credit on the special purpose account could be raised periodically if purchases have been made. For example, these methods could be arranged so that at the beginning of every week, the special purpose account has an available credit of a selected amount.

It will be understood that use of the special purpose accounts may be combined with incentives to receive a marketing presentation or to be induced to perform other tasks or activities, as described herein in greater detail.

Incentives through a points program may be provided for the creation, use and replenishment of such special purpose accounts. A form of award may be the random award of funds deposited into the special purpose account, or a replenishment without a corresponding withdrawal from a conventional bank account. Similarly, an award could be providing payment on purchases made on a special purpose credit card account, or reducing a balance.

The methods above may be anonymous and/or non-anonymous and may be combined with methods described herein and previously and methods such as proxy purchasers, proxy payment providers and payment mechanisms involving anonymous accounts. Codes may be provided for proxies, and information connecting a vendor or other owner of a network resource such as a website so that, after a commitment to a transaction, but without payment, a proxy purchaser, proxy payment provider or anonymous payment mechanism, after receiving a separate authorization from the user, can proceed, and the payment can be matched to the commitment. Use of the proxy means that there is no need to supply payment information to the vendor. A separate shipping coordinator may be provided between proxies to connect separate codes so that product can be shipped to the shipping coordinator; the individual can then even make a purchase without providing address information, or without providing name information, except to the separate shipping coordinator. The vendor may, for example, ship a purchased product to a separate shipping coordinator, together with a code. The shipping coordinator matches the code to address information for the purchase, and ships the product to the purchaser. Alternatively, the shipping coordinator may be located close to a business or residence of the recipient; the recipient or an agent may physically pick up the shipped product from a physical commerce location of the shipping coordinator. The recipient may effect payment through the shipping coordinator, for example.

These activities may result in the award of points, in the enhancement of awards of points or bonus points, the enhancement of redemption or values of items and in other manners as described in my co-pending applications.

### Status of Accounts and Types of Payment

Incentives may be adjusted based on factors such as the status of an account. Status may include a type of account, such as a credit account or a deposit account, whether an account is interest-bearing or non-interest bearing, the interest rate, and any other factors related to the account. The algorithm may consider such status in calculating the reward available for an event, or the opening and/or maintenance of such an account may itself constitute an event. The payment may be combined into any existing account, such as a credit card account, a merchant's credit account, a home equity loan account, a personal line of credit or other account.

Incentives may be provided for the use of certain accounts or types of accounts, certain websites, and certain types of transactions, the use of preferred methods of payment, the use of preferred locations, and other factors. With respect to accounts, incentives may be based on the source of the funds provided for replenishment, and when the funds are paid into the account, for example.

### Adoption and/or Use of Electronic and Real Currency

The methods described herein and in previous patent applications include movement into and movement out of preferred forms of fund retention as well as the length of time of retention within all existing and future forms of fund retention, including those as yet undiscovered or not yet commercially available. These methods also cover any new forms of currency, credit and other values. The adoption, use, retention and amount of new forms of credit and forms of currency may be related or tied to other incentives, such as discounts on purchases and other benefits. These benefits may include entitlement to discounts if specified factors are met. The benefits may also include benefits at the redemption stage. These methods may be combined or coordinated with other methods described herein.

The methods and systems of the invention, as noted above, may be employed in connection with incentives for use of digital currency, for preferred types or providers of digital currency, and/or for preferred types of currency. For example, a provider of digital currency may provide points for an incentive rewards account, sweepstakes entries, or other rewards, for the purchase, replenishment, spending, or other tasks and activities related to digital currency. Also by way of example, businesses that make and receive payments in more than one currency may provide incentives for the use of a preferred currency. For example, a U.S. based business that fills orders from Europe may accept payment in either U.S. dollars or euros, but provide points to customers in Europe who provide payment in U.S. dollars. These methods may be combined or coordinated with other methods described herein.

### Adoption and/or Use of Preferred Techniques Such as Accurate Billing

A method for providing incentives for use of selected procedures for reporting of events will now be described. In this method, there is a step of recording information associated with an event, followed by determining a status of the event with respect to an incentive algorithm, and providing an incentive increment to an account if the event in accordance with the results of the algorithm. Incentives may be provided through points programs for accurate and prompt reporting of information within an organization. For example, units of organizations may be enrolled in a points program to provide incentives for accurate reporting of activities and membership, the accuracy of recurring billing submitted by individuals and entities for payment by other entities and others. Bills are counted as events, and evaluated by various algorithms. Other methods may be employed in conjunction with this method for detecting inaccuracies in billing such as scanning software that tracks and measures the degree of accuracy exhibited by participants.

In the embodiments of the invention described below, an incentive is created by a payer for adhering to terms and conditions set by the payer. The payer creates a program to provide incentives for the payee to adhere to certain terms and conditions. The terms and conditions may relate to the manner or timing in which requests for payment, such as claims and invoices, are submitted. The terms and conditions may relate to the manner or timing in which payment is made by the payer. With respect to the request for payment, the manner may include, by way of example, use of a particular paper or electronic form, completion of all required information on a form or otherwise for a particular claim or invoice, completion of all fields accurately in an electronic form, and use of electronic submission of claims or invoices. Other desired manners may be readily envisioned. The timing may include within a particular period of time after delivery of goods or rendering of a service. The timing may also include aggregating invoices or claims based on distinct deliveries or services into a smaller number of invoices. For example, an incentive may be provided for a physician to aggregate claims related to all patient encounters covered by a particular insurer over a particular time period into a single electronic communication. The time period may be, for example, one week or two weeks. Other time periods may be envisioned. The incentive may be provided to those who furnish services or goods to aggregate invoices as well. It will be appreciated that the payer's accounts payable and claims processing functions, as applicable, will be rendered more efficient by the cooperation of the payee.

It will also be understood that cooperation of a person or entity who submits a bill may benefit a third party recipient. For example, invoices may be sent by an outside bookkeeping or billing service, with payment going to a payee. In this event, the person who submits the bill, rather than the payee, may be enrolled in a program and receive the benefits associated with compliance.

The desired manner of payment may be electronic payment. A vendor, medical service provider, or other person, may be rewarded for accepting payment in electronic form directly to a bank account, for example. Other particular forms of payment may be desired. Alternatively, a payer may wish to alter standard payment timing, and reward payees for agreeing to the new timing. For example, a payer may wish to aggregate all payments to a particular vendor or other provider in a single periodic payment, when prior practice had been to direct a payment in response to each invoice.

An account or equivalent is provided for recording of compliance with the terms and conditions, and for tracking of the benefit available to the payee. The benefit may be the award of points, sweepstakes entries, enhanced rewards and prizes related to other incentive-based activities or other benefits as described in my co-pending applications incorporated by reference above, or any other type of benefit. The benefits may be made conditional or immediately earned, or require redemption by an affirmative act by the payee or others. In accordance with a rewards algorithm, rewards may be conditioned on repeated compliance with the terms and conditions set by the payer over time or over numbers of billing cycles, or based on numbers of submitted or compliant requests for payment. The amount of rewards may also increase for such repeated compliance. These methods may be combined or coordinated with other methods described herein.

### Adoption and/or Use of Efficient Interactive Processes

In another embodiment of the invention, the individual is required to receive marketing information as part of the process of providing information in a distinct manner or at a distinct time. For example, if information is provided by telephone, the telephone call may include a sales interaction prior to furnishing an opportunity for the individual to submit the information. The sales interaction may be recorded, by a live operator, or a combination of those methods, and may be interactive. A visit to a physical commerce location may involve the receipt of printed marketing materials or being presented with a live in-person marketing presentation, a recorded audio, visual or audiovisual presentation, or other form of presentation. A visit to another location on a network may include the presentation of marketing information, such as on a series of screens or in a flash presentation, before the individual is permitted to furnish the additional information. Other modes of presentation of marketing information and advertising, both now known or as yet not commercialized or not yet discovered, may be employed.

As noted, tracking may be conducted for usage of the time of live telephone representatives of a business. Rewards may be provided in the context of a rewards program for customers for reduced or minimum use of the time of live telephone representatives. Customers are required to provide identification information before being connected to a live telephone representative. This identification information will identify that the calling customer has an account with the business or otherwise, such as a significant potential customer, is appropriate for live telephone representative contact. The identification information provided may be in the form of an account number, customer name, social security number, address, personal code, or any other information sufficient to identify the customer. The information may be provided by keypad or voice recognition.

Upon receipt of the identification information, records associated with the customer retained in a database are identified. Preferably, a background profile is maintained associated with each customer. Background profiles are described in greater detail in one or more of my co-pending applications incorporated by reference above. Regardless of the use of a background profile, suitable marketing information is identified. The suitable marketing information may be provided to all callers at a certain time of day, or on a rotating or random basis. Preferably, there are a variety of marketing interactions available, and a suitable one is selected by extracting values from a background profile or other data regarding the customer, inserting those values into an algorithm, and determining a result which maps to a particular marketing interactions.

As a result of the request to speak to a live telephone representative, the marketing interactions is made to the customer. The marketing presentation may be entirely recorded, may be live, and or a combination of live and recorded. The presentation may optionally be interactive. The text of the marketing presentation may be provided to the telephone sales representative in real time, so that a live presentation may be provided. Other methods may be used to match a live presentation with a particular caller. The presentation and any subsequent requests of the customer to make a purchase or engage in other desired activity may occur during the same telephone connection, but before the customer is provided an opportunity to speak about the reason for the telephone call.

After receiving the identification information, the customer may be disconnected. A telephone sale representative may then be provided with instructions, such as through an onscreen message, to telephone the customer and to provide a marketing presentation. The telephone sales representative dials the number, confirms the identity of the customer, and provides the marketing presentation and record a response, such as an order, prior to addressing the question that prompted the call from the customer. Customers may be provided with marketing interactions, such as live, recorded, or a combination of live and recorded, marketing interactions, before being connected to a live telephone representative, or before the live telephone representative will address the question which prompted the customer's call.

The marketing presentation may follow the portion of the call in which a response is given to the inquiry that prompted the call. However, many customers may choose to terminate the call rather than attending to the marketing presentation. Alternatively, the customer may be prompted to provide the inquiry, and then the inquiry will be received. The customer is then told that there will be a delay while the information is retrieved, and provided the marketing presentation. The response to the inquiry may be provided only after the marketing presentation and any subsequent interaction, such as an opportunity to place an order, have been completed.

Incentives may be provided for being provided with the marketing presentation, as described in more detail in my prior co-pending applications. Quality measures of attention may be calculated based on customer responses provided during or after the marketing presentation as a condition of rewards, such as the earning or accumulation of points. The quality measure of attention may be a factor in the quantity of points or magnitude of other reward. The quality measure of attention is described in more detail in my prior co-ending applications, which have been incorporated by reference above.

The use of live telephone representatives may also be discouraged by the use of negative incentives in a rewards program. For example, the rules of a program may provide that the customer loses points, or must redeem points, in order to interact with a live telephone operator.

It will be understood that other activities, such as interactions with a representative at a physical commerce location, such as a teller at a bank branch, may be incorporated in this method so as to result in a marketing presentation. In general, if an enterprise has two or more means of interacting with customers or others, and one of those means of interaction is not preferred, a marketing presentation may be required for customers to employ that means of interaction.

The marketing presentation need not be confined to a telephone presentation. For example, the customer may be requested to create a computer connection, such as to a website, in real time, so that simultaneous computer and telephone interactions may be made. The customer may be required to complete an online presentation, with a requisite quality measure of attention, before a call will be returned. The online presentation may be selected depending on background profile information concerning the customer.

In another embodiment of the invention, the individual may be provided with a choice of options relating to the presentation of information. The individual may be provided with the option of providing all information through the network, such as by providing credit card information at a secure website to complete a purchase. The user may be provided with one or more of the following options: immediate billing by another means, billing at the termination of the session, billing offline at a physical location. The user may also be provided with the option of selecting the combination of any of those with the option of selecting receiving a marketing or advertising presentation, either immediately or upon payment. Other options may include specified methods of presenting a bill, specified methods of payment, billing or payment at specified times or within a specified time window and other options. Various options, such as time and manner of payment and time and manner of presenting the bill, may be combined as options. Options may also include the type, length, timing, subject matter, and other variables relating to the marketing presentation. A reward may be provided for agreeing to receive the marketing presentation, and for following through on the marketing and the completion of the transaction. For example, the reward may be a reward in connection with any of the points programs and methods described in any of my prior applications. The reward may be a preference with respect to the transaction. The preference may be a discount in the price of goods or services purchased, additional goods or services, credits or coupons with the vendor with whom the transaction is processed, credits or coupons with other vendors, an upgrade in the quality of the goods or services, free or discounted goods or services available at a physical commerce location, and other items, for example.

As an alternative, the user may be presented with the option of engaging in a specific type of non-marketing task, event or activity, including those described herein and previously.

The timing of the marketing interaction or time of engagement in the other task, activity or event may include a wide variety of times. Those may include in advance of completion of the online portion of the transaction, during the online activity, upon completion of the online activity, after the commitment to purchase or otherwise complete a transaction but before termination of the process to communication the commitment, after the commitment to purchase or otherwise complete a transaction but before termination of the communication or in-person interaction, before the communication of the separate information or other completion of the process, at the beginning of the process of communication of the separate information or other completion of the process, after the communication of the separate communication or other completion of the process, at a still later time, and in other manners online, through other communications media, in-person, combinations of one or more of those, at physical locations, and other variations. The user may be given the option of selecting one or more of these items.

It will be understood that use of the special purpose accounts may be combined with incentives to receive a marketing presentation or to be induced to perform other tasks or activities, as described above in greater detail.

### Securities-Related Transactions

In one embodiment of the invention, any of the methods and systems described in this application and in any of my applications referenced above may be employed to provide incentives and rewards for activities related to transactions in securities. In this embodiment, the event is a transaction related to securities. “Securities” has the broad meaning ascribed to that term by the U.S. Securities and Exchange Commission, and includes, by way of example, transactions involving such instruments as stocks, bonds, mutual fund shares, warrants, options, puts, futures contracts, and derivatives of such instruments and others. Events may include the purchase or sale for one's own account, the transfer between or among accounts, the providing of instructions for the purchase and sale based on price or other triggers, and other activities. The calculated rewards may be in the form of points that are directly or indirectly redeemable for goods and services of value, and/or for entries in sweepstakes and others. Algorithms for the awards of points, or other surrogates for value, including in all contexts set forth herein and previously and may take into account repeated and consistent requests for transactions by providing rewards that are enhanced or contingent on consistent use of the services, as explained in my co-pending applications with respect to other types of activities. The incentives may be funded by any interested parties including brokers, issuers, such as mutual funds and public companies selling stock to the public directly through DRIP programs and otherwise, securities clearinghouses, and others having an interest in such transactions and others. Holders of brokerage and mutual fund accounts may be automatically enrolled in such a program, or may be offered such a program separately. These methods may be combined or coordinated with other methods described herein.

These techniques may be used in particular in connection with trading indexes. These indexes may involve indexes related to real estate values. Indexes related to other underlying property may also be traded.

### Adoption and/or Use of Preferred Electronic Forums and Technologies

In another aspect of the example, a reward is provided to a third party related to enrollment in a program of compliance with terms and conditions. In general, there is an arrangement involving a first party and a second party, a recurring activity involving performance of some type between the first and second parties, and involvement by a third party related to the arrangement. The third party is furnished with benefits in exchange for encouraging the agreement or performance of one of the first and second parties to comply with specific terms and conditions. An example of an arrangement is a loan to a consumer for the purchase price of an automobile, in which the recurring activity is a periodic, often monthly, payment of interest and principal. The principal parties are the lender and the borrower. The third party may be an automobile dealer that makes the sale of the automobile to the car. The automobile dealer may be provided rewards to encourage customers to select a particular payment timing or manner that results in entry in a rewards program. The automobile dealer may be entered in a program as described above and in my co-pending applications, which provides for conditional or increased awards based on repeated participation. The automobile dealer may be rewarded only if the consumer selects a desired payment manner or timing. Other third parties, such as services providing referrals between consumers and lenders and/or between automobile dealers and lenders may also be rewarded for successfully steering consumers to select a desired type of payment manner or timing.

It will be understood that the above method is not confined to purchases of automobiles or to financing of purchases, but applies equally to other types of transactions. For example, other types of consumer loans may involve a rewards program for the retailer of items such as appliances, furniture, and high-priced electronics that are often financed. Any transaction where a third party may encourage one party to a transaction to engage in desired behavior on a repeated basis may be rewarded in this manner. It will also be understood that the conduct being rewarded is not confined to payments, but may include any type of recurring activity.

### Incentives for Customers, Membership and the Like

As described herein and previously, tasks or activities that may be rewarded may include such items as payment of bills by preferred times and by preferred methods or the length of membership in a program and others. For example, after every month of membership in a program, the consumer may receive a number of chances in a sweepstakes, which number is equal to the number of months of continuous membership, possibly demonstrated by continued payment of membership fees, for example. In one example, the prize in a sweepstakes associated with a services plan such as a professional services plan that may include certain professional services, possibly for a period of time of enhanced benefits or reduced or no cost in a prepaid plan. Members may have a number of chances to win equal to the number of continuous months of membership, fort example. As an alternative, a member may receive a percentage discount for each time period, such as month, calendar quarter, or year of continuous membership and payment, up to a maximum discount, among other variations.

As an alternative or additional incentive for membership in a professional services plan, including a prepaid professional services plan, discounts and other incentives may be provided to members who minimize their use of the plan's resources. Thus, the discount or other reward is greater as the amount of use of plan resources is avoided and/or decreases. Resources in such a plan are typically the time of the professionals and/or the performance of tasks and activities performed by the professionals that may be available under the plan. Algorithms may be provided, with such factors as numbers of requests, time of the professionals involved, dollar value of the services provided, and complexity of the services provided, to quantify the amount of use of resources. Those who are below a certain threshold of use of resources, and may or may not meet other qualifying criteria, would be entitled to items of value. In addition, the length of participation may be rewarded with single event-related services such as credits for an attorney to complete a real estate settlement within prescribed time parameters, for example. The value of those items could be further quantified based on the same or other factors and algorithms. Items of value provided may include discounts and points which may be redeemed for items of value. These methods may be combined or coordinated with other methods described herein.

### Services as Rewards

Services may be provided as rewards in incentive programs or may be available for purchase. These services may include professional services that may be provided in a points program, possibly with the amount or value of services that may or may not vary with points accumulated and/or earned. Services may be provided in the form of memberships and may be re-oriented and provided on a per event basis rather than a time frame for protection paid for on a subscriber basis. For example, the payment of one dollar for per event coverage that may provide specified legal protection to persons who engage in preferred transactions and events, such as time-sensitive purchases at websites. Such purchase may be as a reward, or may be available generally to persons who engage in transactions on a per event basis. The redemption of points and/or prizes that may be awarded through direct redemption, through random drawing sweepstakes drawings and through other methods described in my prior filings and others that are known to exist elsewhere may result in the entitlement to a variety of free or discounted services being provided to participants and/or premium levels of service being provided over and above standard services. Prizes in the context involving sweepstakes drawings and/or bonus rewards, whether random or planned may include a prescribed number of hours of services being provided to recipients during a prescribed period of time, possibly within a prescribed period of time, as one example. The participants may also be able to redeem previously earned points in exchange for various forms of services for themselves and/or for other identified parties including family members and other qualified participants and even other specified third party beneficiaries that may be deemed acceptable in various circumstances. By way of example, the services furnished may be legal services as described below. The tasks and activities such as legal services may be limited in various ways, including by field and/or by nature of the task or activity, and by number of hours and by other means. A sweepstakes may be provided in which points are redeemed for entries, and/or consumers are automatically entered, with a certain amount of prepaid professional services being received as a reward. The amount may be expressed as a task, time and/or value or parameter.

In general, if services are offered as a reward, there is a preference compared to standard services. Standard services means all of the terms and conditions for those who are not entitled to services as a reward, such as those who simply purchase the services. The preference may be, for example, in the nature of making the services available at no cost, at a reduced cost, with additional benefits, or otherwise in a preferential manner.

Other services such as professional services and products may be included and provided as benefits to participants in a program. For instance, participants and other qualified may include free or discounted products and services such as access to a legal service or plan, access to medicines, including prescription medications, medical devices, equipment and supplies and/or specified treatment, discounted and/or free access to medical plans and medical coverage, enhancements to medical plans and/or medical coverage at discounted or reduced or no cost, specified types of educational services such as language lessons, tutoring/mentoring and other social services and any other goods and/or services that may be deemed appropriate or desirable for specified periods of time and other benefits and rewards that may be desired by participants or others.

A service may be specifically marketed in connection with incentive rewards in the form of credits, points, bonus points or other measures that may be redeemed directly or indirectly and/or automatically for free or reduced-cost professional services. The points may be redeemed to offset all or a portion of the cost of a program that provides services for no additional cost or at a reduced cost, such as a legal services plan, dental services plan or full or supplemental medical services plan. For example, the service may be in the nature of a credit account, such as a credit card account, or a deposit account from which withdrawals may be made, such as a debit card account. The rewards may include legal services, medical services, dental services, and other forms of professional services across a range of industries.

In connection with a service of this type, rewards may be redeemed for individual tasks, for example. Examples of such tasks include the preparation of a will by an attorney, the conduct of a routine examination by a dentist, a routine medical examination by a physician or other tasks and activities. It will be appreciated that the services of assistants working under the supervision of a professional, such as paralegals, dental hygienists and medical technicians and others may be included in the professional services obtained. Rewards may also include no cost or discounted preferred status or status as a patient in medical and other professional services practices that charge a fee for such status. Preferred status may mean, for example, reduced or no waiting to see a physician or other professional or to speak to a professional, or priority in scheduling appointments.

It should be understood that prepaid or discounted memberships in such plans, paid or discounted enhancement in status in such plans, and/or discounted and/or no cost professional services, such as professional services may be made available as a reward for any type of task or activity. Any of the tasks and activities described in this application and in any of my prior co-pending applications, as well as other tasks and activities, may result in points or other credits that may be redeemed for such programs and services.

Access to professionals and various services at no cost or reduced rates may be limited in varying manners, including in manner of interaction, such as only in person, only online, only by telephone, or other forms of limitations. Thresholds in accumulation and/or earning of points may be imposed before providing this reward, and/or other thresholds in performance of any tasks and/or activity deemed to be part of the program. These thresholds may apply to various types of additional program rewards deemed appropriate and relevant from time to time.

In addition, one or more participants and/or family members of participants may be able to combine previously earned points in order to achieve specified redemption thresholds, if desired, so as to provide one or more participants with access to legal services or other services and benefits when needed, and participants may contribute additional cash or other tasks, activities and/or items of value, including referrals of other individuals into the network or merely referrals of individuals who may consider participating in the network by providing contact information or other information in order to achieve thresholds, as well. Other variations may be incorporated that may include enabling individuals who provide referrals of other individuals into the network to receive preferred access to the rewards program and other preferred treatment in various ways, as well. These methods may be combined or coordinated with other methods described herein.

### Legal Services and Other Services

In one variation, membership in the rewards program described herein or any other programs described in any of my prior filings may itself entitle participating members to free or discounted goods and services such as legal services similar to existing programs. Unlike existing programs, the previously accumulated/earned points may be redeemed through relationships with one or more attorneys, including attorneys who may or may not specialize in particular areas of law such as immigration law, and/or may or may not have specific language capabilities, and who may be part of a network of attorneys who may be retained and incorporated in a rewards program on a free and/or discounted basis. For example, once point thresholds that may be established by program administrators have been reached, some or all of those points may be redeemed for specific legal services, tasks and activities, such as the filing of a legal document, the preparation of a will, etc. Among other benefits of a legal services-focused rewards program being structured in various ways, once consumers enjoy the benefits of the performance of one or more such legal tasks and services as may be performed through the program, they may be more inclined to register for participation fully as a paying member in a prepaid legal services program. A direct level of participation in a prepaid legal services program though at levels less than standard terms of agreement may also be structured to target certain segments of the population. For instance, redeemable points redemptions and/or sweepstakes prizes and other forms of rewards and values may be awarded and restricted in various ways such as by limiting access to certain legal services and/or by limiting the free or discounted services to a certain number of hours of legal service entitlement beyond which the free or discounted legal services may end and standard or other calculated legal rates may apply. This will increase interaction between consumers of the participating services and attorneys and possibly lead to increased program participation by consumers who may become satisfied with the legal service that is provided, whether through a prepaid legal program or by other means such as through the fund transfer activities described above and by other means that may lead to initial and continued participation, the demand for additional legal services and the referral of additional cases to attorneys that provide the services apart from the program.

Bill payment incentive solutions as described in my prior co-pending applications may be applied to prepaid legal services plans and other programs described herein involving payments and other tasks and activities related to money. For instance, payments under such prepaid legal service plans are typically made in installments, such as equal monthly installments. Subscribers who make installment payments by a preferred method, such as through pre-approved periodic electronic transfer from a bank account, in preference to credit card or check payments and on or within prescribed times, may receive rewards. Subscribers who make installment payments on a due date or sufficiently prior to the due date, or prior to a later date after which the plan is cancelled or a penalty payment is due, and possibly for a specified level or amount of service may also receive rewards. Rewards may be in the form of entries in sweepstakes and other rewards. Points and rewards may be increased for consistent performance, such as for sufficiently early payment for a minimum number of consecutive payment periods.

In addition, the legal services may, by way of example, be in the nature of immigration law, estate planning, ID theft related prevention and recovery services and assistance that may include non-legal services and support that may or may not be coordinated with legal services and participation in a legal services plan, various administrative areas, such as services related to various types of licenses, permits and zoning, and other fields. Additional exemplary subject matter areas are set forth below, including online file sharing, elder abuse, elder rights, dog owners, motorcycle owners and operators, owners of firearms, users of cell phones, volunteers involved in providing neighborhood watch and homeland security functions as well as other desirable tasks and activities, participants in any of the programs described herein and previously and others. Legal services programs may be offered in such individual subject matter areas. Availability may be limited in various ways, such as to a certain amount of advice per year. In addition, the provision of services may be defined as separate tasks and activities that are available to be performed for and on behalf of participants regardless of the time and effort involved such as representation in traffic court hearings, for example. Triggering events may increase the amount of service available. The service may be offered together with an offering of goods or services believed to be of particular interest to persons in the relevant demographic. The attorneys involved in the rewards program may provide any form of legal services including immigration services, in particular, as well as other legal efforts of any kind generally desired by the population at large or believed by program providers to be desired by program participants. An incentive program may include a prepaid legal services card. The card may contains information such as an existing account balance, which may variously be expressed in such manners as points, time, or value of services and entitle the holder to the defined degree and level of services therein. A program participant may be randomly selected for the award of points, based on one or more criteria relating to points and participation. Various levels of legal service and/or non-legal services may be provided to individuals in a coordinated way to individuals based on the degree of risk of loss or damages or victimization facing individuals due to reasons such as their physical location, the nature of their employment as well as other special need situations that require that individuals maintain unblemished credit ratings or undamaged credit profiles. An incentive program may include a prepaid legal services membership may be in card form or in other forms. For example, a payment or loyalty card may contain information such as an existing account balance, which may variously be expressed in such manners as points, time, or value of services and entitle the holder to the defined degree and level of services therein. Imposition of minimum purchase or balance requirements may be included in a program and various and wide ranging tasks and activities may be included as a method for earning and redeeming credits earned or accumulated herein. A program participant may be randomly selected for the award of points, based on one or more criteria relating to points and participation. A sweepstakes may be provided in which points are redeemed for entries, and/or consumers are automatically entered, with a certain amount of prepaid professional services being received as a reward. The amount may be expressed as a task, time and/or value.

Prepaid plans, such as prepaid legal services plans and other prepaid goods and services may be provided as a reward for customers of services that refer parties to one another for a transaction. For example, online auction services may provide legal services or legal services plans as benefits for users who provide a certain level of usage of the auction service, for example. The threshold may be determined in any suitable manner, including, but not limited to, factors such as the length of adoption and/or use, frequency of use, dollar amount of transactions, overall number of transactions, service may be provided either at no cost or at reduced cost, or at a certain cost but with a higher level of benefits than otherwise available and other variations. Such factors as numbers of transactions, dollar amount of transactions, average dollar amount of transactions, frequency of transactions, payment methods and other factors may or may not-be involved in the calculation of the availability of such a benefit. For example, these plans may provide for legal services, possibly limited in various ways such as only assistance with written submissions in a third party dispute resolution procedures, for example, or other offers such as assistance in addition to other services. Such assistance may include drafting of the submissions, telephone consultation regarding form and content of submissions, review and commenting on submissions drafted by the individual, and other services related to the submission, for example. These methods may be combined or coordinated with other methods described herein. For example, legal service provided in a plan may be coordinated with services related to online dispute resolution programs or ID theft prevention and recovery services may be combined with purchase-based incentives.

A company that participates in the program by providing legal service plan coverage or defined services to their customers and/or employees who may benefit by receiving coverage extensions that may be calculated, in part, based upon the number of additional companies and/or the total number of additional individuals who are participants in the program at prescribed times that are deemed covered in a program, for example. Such company sponsors may benefit from having individual participants sign liability waivers related to damage claims stemming from potential future identity theft claims that may otherwise be brought against any companies that report data losses during relevant periods of time. A waiver of legal rights to pursue any potential future claims for damages, or potential future claims of certain defined types, against sponsoring companies, may be a condition to acceptance of benefits in a plan. Defined reasons subject to a waiver may include ID theft-related damage claims. Such waivers may not be applicable to other non-sponsor companies that may negligently handle personal data of identity theft victims including customers of companies, employees of companies and other individuals who may participate in the program. Alternatively, services that are offered to customers of companies may be enhanced and/or broadened based on factors such as whether certain promotion is undertaken by companies or membership criteria are reached.

### Identity Theft and Other Fraud and Abuse

An incentive program may provide as a reward legal and non-legal services specifically related to identity theft. These services may also be in the nature of one or both of identity theft prevention and recovery. Either both legal and non-legal, or only one, may be provided. Non-legal identity theft prevention include such services as frequent credit reports, reviewing and analyzing credit reports, credit card activity, bank account activity, and other account activity, using various algorithms to identify anomalies, and providing notifications either in the event of potential identity theft unauthorized use or periodically to indicate that no identity theft-related activity has been detected. Other sources that may be checked include various government offices and courts, such as to identify liens or other filings relating to real property, automobiles and other property, and/or the initiation of lawsuits. Algorithms may be used that identify such items as expenditures that are unusual in amount, frequency, merchant location, merchant type, nature (such as unusual cash advances), and other items. Increased frequency of examination and reporting may accompany a reported increased risk of an ID theft-related event. Such special or enhanced scrutiny may include more frequent reviews of information that is customarily checked, reviewing additional sources of information, and providing more frequent reports. An individual may be able to obtain enhanced scrutiny for his or accounts on request; the system may require a specific explanation, an explanation in writing, an explanation verified, as by affidavit, and/or information or documentation from third parties to confirm the problem.

A higher level of monitoring of credit profiles may be included if it is determined that grounds exists to believe the personal information of participants is at a higher risk for involvement in an ID theft-related event. For example, in cases when credit card providers and other related companies that share the personal data of credit card customers have determined that data security has been or may have been compromised due to a computer hacking event or for other reasons, all of the credit card customers who may conceivably be effected directly or indirectly may be placed on a higher level of scrutiny. Restricted access to accounts, such as restricting use of a credit card account to in-person transactions verified by photo identification, limits on individual transactions, refusals to process change of address requests, and refusals to process certain types of transactions, may be provided. More generally, either in such event, or at the user's option, a “no loan is authorized” list may be provided that lending institutions may refer to so as to confirm that the individual seeking financing are legitimate and financing may be approved, for example. Such a list may be used so that no additional loans or accounts may be opened in the name of the individual requesting or identified as being at risk. Preferences including additional access to benefits, access to services for free or reduced cost and in other ways due to the individual relying upon non-legal services to respond to identity theft-related events. Individuals who require a minimum of personal assistance in the event of an identity theft-related event or who agree to accept information online rather than by mail, such as legal agreements, legal briefs, and legal filings, insurance policies and others, for example, may be rewarded and receive benefits. The availability of the program may even be limited to individuals who agree to receive all information in electronic form. Legal and non-legal services may be combined by providing copies of information automatically to attorneys engaged to provide legal services. The non-legal recovery services may also include software designed to assist in organizing efforts to communicate with creditors and credit reporting bureaus, assistance with forms, such as affidavits, and the like. The availability of the services may be limited to those who have experienced identity theft or fraud, for example. Such limited availability renders the cost of providing the services subject to controls.

Although affidavits of loss have been known to be offered to consumers who become victims of identity theft-related events, these methods provide consumers with a new classification of at-risk persons if there is a basis to believe that the security of their personal data has been breached, at which point a notification of at-risk status will be provided to notify all relevant institutions that persons who are on the list should be subject to special scrutiny or denial of service pending clarification. For example, any loan application whatsoever on behalf of an n at-risk participant may trigger a contact inquiry by the ID theft prevention service provider to the participant to confirm the legitimacy of the loan application before funds are approved.

Reports in any form, including periodic reports, provided to recipients of the identity-theft related protection and recovery services, as well as the use of secure websites, may be used as opportunities to present marketing information. Other opportunities are presented when individuals transfer money into and out of accounts, to and from one another and in other ways. In these and other contexts, the service provider may accept marketing information and advertisements for fees.

A provider of identity-theft related services may provide a symbol, code, or other information for use by a service member or subscriber. This information signifies that the member or subscriber is entitled to the service. This information may be provided together with personal information in connection with purchases or other transactions, may be stored in databases containing personal information as a field, for example. In general, the fact of membership in the service can be associated as much as possible with the personal information. This association of the fact of membership will likely deter those planning to engage in identity theft or related fraud from use of such personal information.

Services related to identity theft may be offered and provided in combination with other services. Such services may include real estate price insurance offered. These services may be offered simultaneously for a combined price for purchase simultaneously with a residential real estate closing, and may be of interest to the real estate purchaser. The services related to identity theft may offered in connection with any other service offering a continuing service, and in particular in connection with services involving the disclosure of confidential information. These combined services may include credit card and other loan services, brokerage services, banking services and other financial services. The identity theft services may be offered in exchange for agreeing to account changes, such as agreeing to electronic bill payment, electronic receipt of statements, and other changes desired by banks and other financial services companies. These combined services may also include acquiring a so-called discount card from a retailer or other seller, or seeking other benefits. The identity theft service may be offered in connection with wireless, long-distance and other phone services, including initiating service or in connection with selected types of service. The identity theft service may be offered simultaneously with any initiation or alteration of a business relationship that may be requested by a consumer.

The legal and non-legal services related to identity theft may be offered in a number of forms. A program may provide rewards and may offer and incorporate broader non-legal goods and services for members who may be victimized. Each of the above-described problems requires rewards solutions that can increase customer retention rates. Rewards may be provided including access to legal services and other services, possibly at a discounted rate that may include factors such as frequency of engagement in online auctions and others. The exponential increase in the number of instances of identity theft require a more powerful set of tools to respond to identity theft and other scams that is provided by a prepaid legal service provider and others. The types and level of services provided to assist individuals who are at risk for ID theft to guard against losses and to respond and repair damage in the event of an ID theft or in the event of fraud and disputes arising from transactions that individuals who engage in online transactions are limited to the offer of alternatives that are presently offered with limited success.

Alternatively, various credit card providers provide damage protection to individuals in the form of limits on financial losses if credit cards are lost or stolen and misused. The provision of a defined legal plan or legal services in any form that provides for the needs of victims of ID theft will enable companies that possess personal data of their customers and that are at risk for claims for damages sustained by customers who become identity theft victims due to mishandling of personal account information or otherwise to obtain customer goodwill and reduce potential losses in the event that customer personal information is compromised. An approach that is available may include the support by companies that benefit from the provision of an effective ID theft victim recovery services plan provided to customers of companies who engage in tasks and activities including those related to purchases, electronic purchases, payments, electronic payments, electronic auctions, fund transfers, receipt of cancelled checks and other transactions electronically and an endless variety of other tasks and activities. Participation in a services plan may provide individuals with benefit from legal and/or non legal services, including those related to ID theft prevention and victim recovery services.

Certain services may be provided related to providing legal services and ID theft prevention and recovery services. In particular, the amount and timing of payments required in order to meet obligations arising from entering into contracts to provide such services may be estimated, and various risks and events that will affect the amount and timing of such payments may be taken into account. Obligations to provide such services to individuals, businesses, and groups of individuals and businesses may be sold and traded. Such sale and trading is similar to the sale and trading of various types of insurance and reinsurance risks.

### ID Theft Surveillance and Legal Services Program for Certain Occupations

The provision of ID theft surveillance and other services to guard against and respond to ID theft threats and consequences may be particularly helpful as a benefit for those in certain occupations. Such a reward will generate superior results and benefits for all participants in programs including companies that manage personal data of customers and employees, victims and others those who, for whatever reason are at risk to become victims of identity theft or who will suffer greater harm due to the nature of their occupations or other circumstances or for other reasons. The provision of legal and non-legal services will generate greater benefits compared to existing approaches that operate separately. This preferred approach will provide victims and potential victims of ID theft a fuller range of services including potentially necessary legal services and assistance that can be provided as needed to assist victims to be protected. The degree to which participants including companies and individuals comply with requirements to guard against ID theft may result in the receipt of benefits such as coverage in a plan through a pricing schedule that takes that information into consideration in a program. Participation in a program may also be a factor that determines the participation of individuals and companies.

The legal protections described herein may benefit immigrants and others who may be served by a legal services plan or legal services. The credits may entitle them to the receipt of certain immigration-focused legal tasks and activities, possibly for prescribed periods of time and in other ways that will entice immigrants to remain loyal to the fund transfer providers that adopt our service. There may be opportunities to earn redeemable points, bonus points and entries in sweepstakes drawings to win prizes and other benefits within the existing pre-paid legal services context and also beyond the provision of legal services, as well. Those individuals who frequently conduct transactions online such as auctions and who are therefore most at risk for encountering disputes stemming from the transactions and at risk for identity theft may be most receptive to the prepaid legal services. Alternatively, certain services may be provided at no cost in a legal plan such as identity theft protection, possibly for a prescribed period of time. Significant exposure will also be generated for a legal services provider under these methods. These methods may be combined or coordinated with other methods described herein.

The benefit for identity theft related services may be provided in any transaction.

Businesses that operate websites on the internet are often victimized by unscrupulous individuals who obtain goods and services. The fact that numerous transactions end on disputed terms makes clear the need for legal services targeted to serve internet-based businesses. For example, these businesses would benefit from legal services or plans that insulate them from ID theft damage claims. It is reasonable for individuals to take steps to insulate themselves from liability in the event of a loss of personal data of customers so as to address this problem. In the event that businesses fail to protect the personal profiles and personal information of their customers, businesses are exposed to legal liability for damages sustained by victims of identity theft, fraud etc. A legal services provider or legal service plan provider may offer a legal services plan designed to protect businesses and generate higher membership levels. Such a service will provide, for consideration set at the beginning of a defined period of providing the service, services as needed within specified parameters. The consideration may be a fixed fee, a periodic fee, or a fee calculated based on agreed factors. The service will customarily be provided for a defined period of time. In one variation, early adopters may be provided benefits in such areas as term, pricing, and other benefits based on later adopters. For example, businesses that enter into contracts for such services within a defined time period after introduction of the service may receive benefits based on later contracts and revenue of the provider. By way of specific example, if a business enters into a contract to receive such services in the first six months of the business, and the business meets revenue projections in the following six months, the business will receive reduced prices, term extensions, and/or other benefits. Other steps taken by companies to secure the personal data of their customers may be a factor and may provide enhanced benefits to companies that comply with identity theft-related standards for protecting personal information of customers, employees, and others.

A provider of identity-theft related services may offer to potential business customers the option of more than one business customer entering into a contract to receive such services. Pricing may be based on a formula in which the number of customers or other persons providing personal information to the business (or non-business entity, such as a charity or university) is a factor. To the extent that overlapping of customers of the businesses can be identified, all businesses entering into contracts simultaneously, and contingent on one another, or a single contract for several businesses, may receive a discount from the pricing otherwise available. Overlap may be shown, for example, by general statistical data, or, if permitted by privacy policies, comparison of randomly selected portions of lists of personal information.

Legal services may be provided in accordance with such a program as a means to offset the damaging effect upon the customer relationship that the loss of personal data or other corruption of personal or security-related data has upon victims. Companies that have access to sensitive data will benefit from the assistance of a single entity that may be responsible for processing claims related to identity theft at a variety of companies. All companies are at risk for legal claims for damages as victims of identity theft seek to hold negligent parties responsible for the loss of personal information that may lead to further damages.

Website operators and other companies may also provide their own customers with legal protection in the event of theft or loss of personal information of customers so as to limit exposure to damages. A provider of such legal or non-legal services may enter into a contract with a business to provide such services to the customer of the business. The business may pay all or a portion of the fees to the service provider. Referrals of customers from websites or from placement of advertisements on websites, among others may also generate additional legal services protection. Other rewards and benefits as described herein may be provided.

A further service that may be offered to website operators and other businesses is certain services in the field of patent law, and particularly services relating to allegations of patent infringement. Services provided may be a certain amount of legal advice in connection with allegations of infringement, for example.

If legal entanglements occur, individuals will benefit from legal services tailored to accommodate the needs that may be anticipated in such a scenario as a mistaken report of a person who is later deemed to be innocent of wrongdoing such as airline personnel and others, for example. Other examples may be envisioned including other areas of coverage in legal plans that have special legal needs such as repossession-related employment, bail bondsmen-related employment and others. For instance, a variation may provide for legal services adopted for individuals who own or have access to weapons such as guns through employment or through other activities such as operation of businesses in areas at high-risk for crime and/or other confrontations. These individuals will benefit from participation in a legal plan and rewards program that suits their particular need for legal services and other benefits. Rewards may be provided as described herein and previously.

Participation in the unauthorized copying of electronic files containing works protected by copyright, such as recorded music, computer software, and movies, activity is illegal and potentially exposes individuals to legal entanglements. In the event of claims that individuals have violated laws related to use of files, legal protection and other benefits may be provided within prescribed parameters. A service may be provided in which the organizations and individuals have their downloading and uploading of files tracked. Depending on the degree of compliance with various factors relating to downloading and uploading of files, various levels of legal protection may be made available. Other rewards and benefits as described herein may be provided and combined.

Certain legal plans are offered that are tailored to this area of the law. However, rewards and inclusion of ID theft prevention, monitoring and victim assistance as described herein may be provided so that participants such as the elderly who are at risk for various reasons may receive a greater overall level of protection. The same or a higher or lower degree of surveillance of credit reports and other tasks and activities performed by individuals that may expose them to identity theft may be provided for elderly persons concerned that they will be victims of scams and crimes. The need for legal services increases as people age and face decisions including creation of a will, admission to a nursing home, the legitimate assignment of powers of attorney to others, and others. Other rewards and benefits as described herein may be provided.

In another example, motorcycle owners and operators face a high-risk for sustaining serious injuries and becoming involved in other legal entanglements and thus would benefit from a legal services plan tailored to suit the risks faced by such persons. For example, motorcycle operators may receive legal services that may be provided possibly through the financing or purchase of the motorcycle with extra coverage for traffic infractions for certain models, for example. A legal services plan may be provided independently or in combination with other services such as motorcycle insurance, motorcycle financing and others. Other rewards and benefits as described herein may be provided.

Insurance companies routinely discontinue or deny coverage for certain or any insured such as families who own large breeds of dogs that are thought or known to be aggressive. The effect is to leave a significant number of homeowners without protection from lawsuits stemming from dog bite injuries to other parties. Many states have laws that declare dog-related injury claims to be a strict liability tort so that negligence is presumed to exist on the part of the dog owner for the injuries caused by dogs. Thus, a clear opportunity exists to target owners of any types of dogs, particularly those dog owners such as unprotected homeowners who have been dropped as covered parties by their insurance carriers due to their ownership of dogs. A program can provide a defined set of legal services to protect individuals from the risk of damage claims being brought against dog owners and for other reasons that are also relevant and valuable to dog owners, such as boat-related or hunting related services, for example.

In another example, the use of guns by individuals who defend their homes and property are at increased risk of being targeted for criminal and legal prosecutions stemming from the use of their guns. Consequently, a need exists for legal coverage to protect individuals from civil and legal harm. In some cases, legal work may consist of obtaining commitments from insurance companies such as home-owners insurance coverage to pay for the defense for participants who become involved in legal entanglements.

In another example, boat owners are at increased risk for injury claims stemming from the use or operation of boats. In addition, boats are often involved in incidents that result in damage to boats and the need to submit insurance claims to insurers of boats. A need exists for legal service to protect boat owners from these legal risks and others.

In each of the foregoing examples, products or services that are offered to members of the target audiences may be offered in combination with or simultaneously with tailored legal services plans. For example, products purchased primarily by an elderly population may be offered with an added benefit of a prepaid legal services plan offering only elder law assistance. Products purchased primarily by dog owners may be offered with the added benefit of a prepaid legal services plan offering only legal assistance related to dog ownership.

In another example, telemarketers that violate rules and regulations regarding contacting individuals who have registered for “do not call” lists and others as may be desired may be targeted for fines and damages. In addition to telemarketers, such businesses as creators of spam, junk e-mail, and other unsolicited electronic communications, and senders of unsolicited marketing faxes may be targeted. The program may provide certain legal representation at no charge or on a reduced fee basis or on another preferred basis for treatment as may be desired to demonstrate benefits of membership in a legal plan alone or in combination with other transactions such as put/options and other tasks and activities and other legal services depending on particular circumstances.

Alternatively, various credit card providers provide damage protection to individuals in the form of limits on financial losses if credit cards are lost or stolen and misused. The provision of a defined legal plan or legal services in any form that provides for the needs of victims of ID theft will enable companies that possess personal data of their customers and that are at risk for claims for damages sustained by customers who become identity theft victims due to mishandling of personal account information or otherwise to obtain customer goodwill and reduce potential losses in the event that customer personal information is compromised. An approach that is available may include the support by companies that benefit from the provision of an effective ID theft victim recovery services plan provided to customers of companies who engage in tasks and activities including those related to purchases, electronic purchases, payments, electronic payments, electronic auctions, fund transfers, receipt of cancelled checks and other transactions electronically and an endless variety of other tasks and activities. Participation in a services plan may provide individuals with benefit from legal and/or non legal services, including those related to ID theft prevention and victim recovery services.

Certain services may be provided related to providing legal services and ID theft prevention and recovery services. In particular, the amount and timing of payments required in order to meet obligations arising from entering into contracts to provide such services may be estimated, and various risks and events that will affect the amount and timing of such payments may be taken into account. Obligations to provide such services to individuals, businesses, and groups of individuals and businesses may be sold and traded. Such sale and trading is similar to the sale and trading of various types of insurance and reinsurance risks.

### Trading Index-Related Tasks and Activities

A variety of incentives related to trading indexes and insurance may be provided. These may include incentives to use products developed from indexes and insurance, alone or with other products. The categories described herein are offered as examples and may be combined in numerous ways including by combining various forms of insurance into one or more sets of parameters such as for a single price for a single stated set of coverage. Benefits and rewards including legal protection or access to legal services or legal-related services within defined parameters may be provided with or without additional rewards. An example of a legal-related service is a set of non-legal services for assistance in detecting and disabling identity theft and fraud. Various combinations of benefits and rewards may be provided from time to time as may be desired. For example, legal insurance including provision of an attorney to represent a party in a real estate transaction or settlement may be provided as defined in a plan or protection may be provided under a prescribed plan in combination with the provision of title insurance and others. Various services are known to exist that track various forms of data relative to business relocation and the termination/utilization of services relative to movement of business in prescribed time parameters. This information and other data may be considered as individual factors and/or in combination with other factors that may be considered to determine the direction of prices of properties within a covered area such as within a particular zip code and the risk that prices will decline. This price protection may be provided in a program that combines legal, legal-related services, including legal and legal-related services relating to identity theft, or other services in a coordinated program. A process may be provided and/or combined with other services for businesses. For example, companies that engage in unanticipated relocation for any reason may face penalties and costs such as premature lease termination fees and other negative consequences. Rewards may be provided in programs at many levels that may include access to legal services based on mere participation in the program, based on completion of various tasks and activities and/or the avoidance of undesirable conduct, among others, for example.

### Real Property Equity/Price Insurance

In order to entice participation by parties willing to either pay for the protection and/or to accept the risk associated with a drop in real estate values during the covered time frame, prices may consist of rewards that may be coordinated with put options or other methods.

Various programs and rewards may be provided to entice and enable parties to reach agreement for equity or home pricing protection in the form of insurance or through the use of put options and by other means. Rewards may include provision of legal services, discounts for any other services, fee waivers and all other forms of rewards described herein and in previously filed patent applications referenced herein. Variable amounts of services such as legal services may be provided to accommodate losses in property values during covered periods of time as may be desired. Equity or home pricing protection may be offered as a package, for a single fee, together with other services. These other services may include a requirement to provide legal services in certain circumstances, within defined criteria, and/or non-legal services useful in connection with preventing or ameliorating the effects of identity theft.

### Legal Services Plan Participation and Legal Service Insurance Pricing Index

A method for tracking and processing transactions that may occur in a process wherein legal services may be provided for individuals, businesses and others to protect participants against harmful financial and legal consequences in the event of unanticipated events including, but not limited to relocation, termination of employment, reduction in number of employees or other parameters, possibly related to the performance of tasks and activities. For example, in the event that a relocation of a company, one or more employees or is required for any reason, costs such as premature lease termination fees and other damages and consequences may be protected up to certain limits that may be provided in the form of money or services in lieu of money such as membership in a legal services plan, for example.

### Per Event Fees for Provision of Services

Individuals who engage in preferred tasks, activities and transactions including online auctions, online purchases, offline purchases, electronic bill payments, electronic bill payments on or before a due date and others may be provided with credits or services provided, possibly as a requirement to receive benefits and/or automatically. For example, access to services such as ID theft protection and recovery programs may be provided if individuals perform preferred tasks or engage in preferred activities. A purchase, payment or other task or activity may be accomplished through a website, possibly within prescribed time frames and/or possibly within other parameters deemed desirable or relevant. In addition, per event coverage may lead individuals to become subscribers, as well as to commit to other combined services such as legal protection in a plan combined with home equity or price protection insurance may be combined and provided in a program. The service may consider factors including real estate price index patterns within areas, business movement and relocation trends within prescribed areas, gaming theory, pricing of derivatives, including options, random selection ratios and other considerations including those set forth in previous patent filings, the nature of the task or activity that generates the event in question and other factors. A legal protection plan may be provided on a per event basis. For example, $1 or $2 dollars may be per each auction transaction, possibly for or confined to certain time parameters or on other grounds. The benefit may be in the nature of payment for legal services for matters arising out of the individual transaction. Such matters may include a breach of contract by another party, fraud by another party, defense against allegations of breach of contract or fraud, and legal or non-legal assistance in connection with identity theft resulting from information provided in connection with the transaction. If desired, numerous variations may be created so that, for example, if an individual pays for event coverage and completes multiple auction transactions such as timely purchases, auctions and others. In an alternative approach, fees for one or more other services may be waived, increased or decreased depending on whether services described herein are obtained by individuals.

### Online Auctions

Programs may be provided for online auctions and tasks and activities related to online auctions, online purchases and other online transactions. The transactions may involve tasks and activities that may include placing items for bid, bidding on items, successfully bidding on items, purchasing items, ordering additional services such as photo displays of goods and services being auctioned, for example, and performing other desirable tasks and activities. Points or other rewards may be provided for bidding, regardless of whether the bid is successful or a sale results. The transaction in funds may result from any underlying activity. Such activities may include placing items for bid, bidding on items, and purchasing items at auction. Points or other rewards may be provided contingent upon a for bidding, regardless of whether the bid is successful or a sale results. Incentives may be provided to individuals and businesses that sell goods and services on online auction services. These incentives may be preferably provided by the auction service. For example, a point rewards program could be provided for those who sell goods and services on public and industry online auction services, with points earning and redemption features geared to promote frequent use. Similarly, the service may provide a points program for successful bidders. Other benefits may be provided. For example, benefits for individuals may include such services as legal services. Protection and access to legal assistance may be available on a per event basis, such as $1 dollar per each online purchase to obtain assistance in the event of identity theft or other fraud stemming from the transaction in question. Protection and access to legal services may be provided, possibly on a preferred basis for individuals who engage in electronic auctions, timely purchases, payments and other tasks and activities. These methods may be combined or coordinated with other methods described herein.

### Dispute Resolution Services

In a related arena, these methods may be employed by providers of online auction services and online merchants that may provide incentives and rewards to participants who resolve disputes that may arise between actual or prospective sellers and actual or prospective buyers and others, for example. Online dispute resolution services may be combined with online or described legal service plans to coordinate protection of consumers including to protect against identity theft or take steps to deal with the legal consequences associated with that problem and others. Online fraud related to auctions, purchases and other transactions may be reduced if legal services or membership in legal service plans were coordinated with or otherwise combined with online dispute resolution services that may be provided to participants involved in disputes that will benefit from a resolution of the disputes. One method of providing rewards may be in marketing services or collecting payments through incorporation of previously described methods for such services is for those who anticipate disputes, such as frequent users of online auction services, to purchase in advance membership in a program that provides a limited or unlimited number of dispute resolutions of this type. One difficulty that has been encountered by providers of the dispute resolution service is a lack of clarity in the written submissions. Such submissions may include large amounts of extraneous details, exclude pertinent facts, and be presented in a disorganized manner. Review of online dispute resolution submissions and other services may be provided. These methods may be combined or coordinated with other methods described herein. A higher level of monitoring or scrutiny may be provided for individuals or associated accounts are monitored for possible facts that may lead to disputes or other negative consequences. Services including monitoring regarding major purchases such as vehicles, high cost items as well as special targeted caps on purchases that a flagged credit card account may be made online or in a given transaction without an independent verification that the transaction is authorized or appropriate safeguards may be provide in a plan. As described herein, elderly persons and others who are at heightened risk for ID theft or other fraud and abuse may be provided with the benefit of legal services plans.

### Privacy Waivers

There is resistance to the adoption and/or use or acceptance of invasive methods and technologies and techniques for tracking individuals and others who may engage in a certain tasks or activities that may involve a waiver of some measure or degree of privacy. A need exists to create enticements for customers and others to accept methods for conducting a range of transactions that result in privacy waivers. For example, rewards may be provided for privacy waivers and for acceptance of various methods for tracking persons, including GPS, body implants, wireless vehicle-based toll payment technologies and others may be rewarded to facilitate encouragement of positive behaviors and enable tracking and rewarding of individuals in the various circumstances described herein and in previous patent filings and in other circumstances. For example, as will be described below, agreeing to accept GPS in vehicles, including rental vehicles, conformity with driving laws, reduced traffic penalties and others may be rewarded. These methods may be combined or coordinated with other methods described herein.

### Legal Rights Waivers

A need exists to reign in costs related to lawsuits for damages related to business activity. A program may provide legal coverage to participants who are willing to waive certain legal rights, possibly for prescribed periods of time such as loan periods and other time frames that may be desired. Such waivers may include agreeing to forego certain types of claims completely, agreeing to a forum other than court, including various types of alternative dispute resolution, such as arbitration, particularly binding arbitration, and/or agreeing to limits on awards of damages. For example, an individual who agrees to accept legal plan participation will waive the right to sue companies that sponsor such plans as a condition of free or reduced cost access or other benefits. The services of a certain doctor or group of doctors may be made available, possibly at a different price or in combination with certain exclusive rewards and benefits that may or may not be available to others as well as other advantages that may be provided in return for individuals who accept limits to their legal rights such as caps on any claims for damages and other limitations pertaining to their on their right to sue doctors for any conduct or conduct that must exceed a higher standard only such as gross negligence or recklessness, for example.

Such waivers may be provided as a condition of the commencement or alteration of any relationship between an individual and a business or other entity. For example, by entering into a program offering benefits of any type, an individual may be required to agree to certain types of waivers. A waiver may be a condition of a points program, obtaining a higher level of service, or initiating a service relationship. Various degrees and types of waivers may be required by a single entity for different types of services. Service providers may offer price discounts or additional services to those who agree to waivers.

In another example, individuals who make purchases online and/or offline may receive benefits or be treated preferably by receiving access to legal and/or quasi-legal services to guard against and respond to identity theft. Other examples are contemplated and/or may be envisioned.

### In-Vehicle Communications Technologies

In one variation of the invention, customers may be offered rewards for membership and/or other adoption, activation and/or use and/or participation and/or access to vehicle-based communications/GPS systems in various ways. These communications systems provide generally continuous communication between a vehicle and a system administrator, with the vehicle providing location and possibly other information to the system administrator at all times. The adoption, activation, use and participation in such systems may be events to be considered by an incentive algorithm.

Any rewards may be offered in connection with use of in-vehicle communication technologies. Rewards may include in particular access to additional services available through in-vehicle communications systems, or to other services, such as legal services as described herein and others. For example, in another variation, access or other benefits may be offered to the service at higher or lower rates in contrast to current rates with the opportunity to reduce the rates in return for performance of one or more tasks and/or activities, possibly within prescribed time periods. Those tasks and activities may include any set forth herein or in my co-pending patent applications referenced and incorporated herein.

In another variation, customers are rewarded with anything of value such as points and other forms of credits for engaging in time-sensitive marketing-oriented interactions and/or interactions over the in-vehicle communications networks while customers are in their vehicles. These marketing interactions and/or interactions, which are events used in an incentives algorithm, may be at scheduled times, at unscheduled times, at random times, at particular times and/or for times that may be subject to minimum and/or maximum time limits and/or when customers are detected at or near particular physical locations and/or at other preferred times and under other preferred circumstances. By way of example, if a customer provides a minimum of 10 minutes for telemarketing interactions or a minimum purchase amount per week or month, then the customer will receive free or discounted service, for example. A customer may need to meet certain criteria, such as criteria in an individual background profile, in order to qualify for discounts. In another variation, coordination among differing modes of communication may or may not be utilized for providing marketing interactions. For example, digital radio may be employed to provide interactions, including in contest promotions, marketing interactions, and others in addition to telephone and through in-vehicle communication devices. Marketing interactions may be provided via selected radio stations, either alone or with other programming. Digital radio technologies may include opportunities for feedback to verify time and attention, as well as additional opportunities to interact with live representatives or automated response systems and by other means. In another variation, customers are rewarded for responding to offers to visit and/or to make purchases (perhaps with minimum purchase requirements) at particular physical locations, such as one or more stores among a chain of stores and others. These offers may be extended whenever the communications/GPS system detects the presence of customers within prescribed distances from one or more selected physical locations and on any other occasion that may be considered relevant by program participants. Responses to such offers are events for use in incentives algorithms.

The incentives may be offered to customers prior to the time that they actually initiate a trip. For instance, a customer may visit a particular website that may or may not be maintained by the system administrator and request a list of preferred locations that offer certain types of goods and/or services for sale that the customer has expressed an interest in obtaining. This interaction may take place at the beginning of a scheduled or unscheduled trip. Alternatively, customers may also indicate a desire or intention to visit one or more particular types of commercial establishments or other physical locations with the desire or intention to examine and/or purchase certain types of products, goods and/or services. In response offers may be extended to customers that include discounts for purchases and other tasks and activities completed including physical visits at one or more physical locations and with prescribed times as may be desired by program participants. Value may also be awarded if customers initiate contact with a system administrator from their vehicles or from any other location including from their residences or businesses locations and at any point in time. The system administrator may convey offers of value that may or may not be restricted to or contained in a list of possible physical locations that offer for sale the types of goods and/or services that the customer has expressed an interest in examining and/or purchasing.

Additional factors and considerations may be incorporated including those set forth in my prior patent applications related to offering priority service to customers within physical locations based on certain characteristics. For instance, customers who participate in this program may be entitled to preferred treatment within physical locations and in any other circumstance deemed relevant to program participants. In addition, customer who utilize preferred payment methods such as particular credit cards including those that are backed by automobile manufacturers to make purchases and to pay for their access to the communications/GPS network system itself may generate bonus rewards or other preferred treatment that may translate into reduced fees for access to the communications/GPS network, access to additional preferred features offered within the communications/GPS network, discounts on purchases made within particular locations, reduced cost for new vehicle purchases, vehicle repairs and an unlimited number of other benefits that may be made available over time that may be deemed relevant by program participants. The length of the customer relationship, membership or history of other factors the characteristics such as vehicle weight, the type of vehicle and other considerations may be used as a factor such as a background factor. Providing rewards and selecting a customer for offers and/or rewards at any point in the methods of the invention, may itself entitle the customer to preferred treatment such as at physical commerce locations or in other transactions, or may serve to reduce the number, duration or difficulty of other tasks and activities required to obtain preferred status. The type of vehicle may include the model, age and inclusion of luxury options. For example, preferred treatment may be available to all customers who own or lease a Cadillac no more than three model years old. A positive driving record that may be free of infractions or accidents may be considered as a factor in providing rewards as may others. It is also contemplated that coordination may occur between telephone, GPS and radio including vehicle-based radio capabilities, such as digital radio capabilities that may be included so that customers may be rewarded for being customers in good standing and/or for any other desired purposes involving this additional form of communication. The customer may be given the opportunity to permit a commercial type presentation at any time through the system. A response may or may not be required to indicate presence and attention (reactions). By opting for this access to customers by marketers/advertisers one or more times in a given time frame, possibly subject to limitations, may result in a value discount, preferred features or other benefits to the consumer.

Other types of interactions may be provided, such as requests for charitable contributions or involvement. Interactions may involve other types of information which an entity may desire to communicate to a customer; for example, a health care entity, such as a health maintenance organization, may provide health-related information, for example. These methods may enable system administrators to generate fees from telemarketers and/or operators of various commercial establishments including physical commerce locations based on the degree to which customers respond to offers to engage in marketing interactions over communications networks, make purchases or perform other desirable tasks and activities at particular physical commerce locations within prescribed program parameters.

In another variation, events for which customers are rewarded are responses to offers to visit and/or to make purchases, possibly with minimum purchase requirements and at one or more particular physical locations, such as one or more stores among a chain of stores and others. These offers may be extended in various ways. For example, offers may be extended whenever the communications/GPS system detects the presence of customers within prescribed distances from one or more selected physical locations and on any other occasion that may be considered relevant by program participants. Alternatively, customers may indicate a desire or intention to visit one or more particular types of commercial establishments or other physical locations with the desire or intention to examine and/or purchase certain types of products, goods and/or services. In response offers may be extended to customers that include discounts for purchases and other tasks and activities completed including physical visits at one or more physical locations and with prescribed times as may be desired by program participants.

Value may also be awarded for any reason including, for example, if customers initiate contact with the system administrator from their vehicles or from any other location including from their residences or businesses locations and at any point in time. The system administrator may convey offers of value that may or may not be restricted to or contained in a list of possible physical locations that offer for sale the type of goods and/or services that the customer has expressed an interest in examining and/or purchasing. Additional factors and considerations may be incorporated including those set forth in prior patent applications, such as may be related to offering priority service to customers within physical locations based on certain characteristics. For instance, customers who participate in this program may be entitled to preferred treatment within physical locations and in any other circumstance deemed relevant to program participants. In addition, customer who utilize preferred payment methods to make approved purchases and, possibly paying for their access to the communications/GPS network system itself may generate bonus rewards or other preferred treatment that may translate into reduced fees for access to the communications/GPS network, access to additional preferred features offered-within the communications/GPS network, discounts on purchases made within particular locations, reduced cost for new vehicle purchases, vehicle repairs and an unlimited number of other benefits that may be made available over time that may be deemed relevant by program participants.

The customer may be given the opportunity to permit a commercial type interaction, including when the customer is first starting the vehicle or the radio or at other times through the system. A response may or may not be required to indicate presence and attention (reactions). By opting for this access to customers by marketers/advertisers one or more times in a given time frame, possibly subject to limitations, may result in a value discount, preferred features or other benefits to the consumer. Other types of interactions may be provided, such as requests for charitable contributions or involvement. Interactions may involve other types of information which an entity may desire to communicate to a customer; for example, a health care entity, such as a health maintenance organization, may provide health-related information.

These methods enable system administrators to generate fees from operators of various commercial establishments including physical commerce locations and others based on the degree to which customers respond to offers to engage in marketing interactions over communications networks and/or visit and/or make purchases or perform other desirable tasks and activities at particular physical commerce locations within prescribed program parameters.

### Mapping Functions

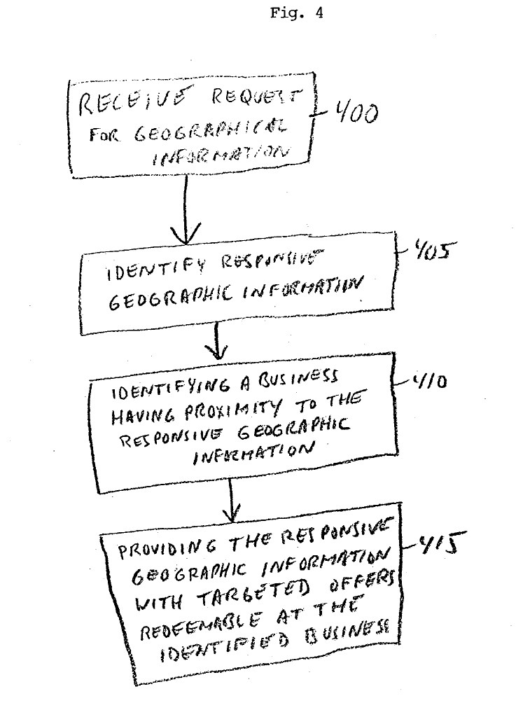

Mapping functions from computers and in cars and in other ways for directions and other purposes may be employed in a variation of the invention. As a request for a map provides targeted information about the future location of an individual, efficient, targeted offers may be provided. In particular, a method for providing targeted offers, as indicated by FIG. 4, includes the steps of receiving a request for geographical information, such as a map and/or directions, as indicated by block 400, identifying responsive geographic information, as indicated by block 405, identifying a business having physical proximity to the responsive geographical information, as indicated by block 410 and providing an offer associated with the provided responsive geographical information and pertaining to the identified business, as indicated at block 415. This method may be combined with an incentive rewards program, with rewards provided based on interactions that may be requested by customers and/or offered by the system administrator or others, possibly at suggested locations to visit and/or buy goods from, among others. For example, in response to a request for a map and/or directions, a map and/or directions may be provided via an in-vehicle communications system, including the location or directions to one or more physical commerce locations identified as being of potential interest.

Locations to visit and/or from which to buy goods and services may be provided. For example, in response to a request for a map and/or directions, a map and/or directions may be provided via an in-vehicle communications system, including the location or directions to one or more physical commerce locations identified as being of potential interest. A map or directions may be provided via the in-vehicle communications system based on customer location and stored information, possibly without the need to wait for prompting. A map or directions may be provided via alternate means, such as cellular telephone or PDA or other portable electronic device. Maps and directions may include reference to physical commerce locations near or along routes or destinations. Calculation of routes may include incorporation of roads that have physical commerce locations, according to algorithms that include such alterations under appropriate circumstances; the user may be rewarded specifically or otherwise for agreeing to such alteration of route determination. Mapping and route information may include the existence of specific offers that may be redeemed at identified physical commerce locations, such as discounts on all or specified purchases, or points or other rewards for purchases and/or visits or other tasks and activities. Alternative routes may be provided, with alternatives incorporating various physical commerce locations. Purchase codes, reservation codes, membership numbers and other identifiers may be provided to the customer through an in-vehicle communication system or other form of communication, while the customer is en route or at home, office, hotel or other location. Such codes facilitate efficient matching the customer to a particular offer, benefit, reservation, order, or other item, at a virtual or physical commercial location, such as discounts in stores or hotels, reservations at hotels or restaurants, ticket purchases, reservations of scarce goods, or any other item to which the customer may be conditionally or unconditionally entitled. These codes may be provided via the in-vehicle communication system, or other portable electronic device. This information may be recorded and individuals will be tracked based on date, time, amount of purchase, items purchased and other data supplied by third party commerce providers and/other information. This information may be similarly useful if telemarketing activity generates sales but customers do not provide account information over the phone.

In an alternative invention, a method and system is provided for furnishing to individuals, benefits that may be limited in time and limited in geographic location. The time and geographic location are selected in relation to information obtained by a service provider in relation to the planned location of the individual. Additional consideration, such as personal information, or additional personal information (e.g., income, account balances, family and hobby information from an individual whose address and other contact information is already on file) may be a requirement for the benefits or influence the level of benefits. The information in relation to the planned location of the individual may be information as to travel plans, such as reservations for accommodations or travel, purchase of tickets for travel, purchase of tickets for an event, such as a concert or sporting event, obtaining tourist information, payment of tolls, and other activities. The benefits may be discounts on goods and services, or points in a rewards program for the purchase of goods and services. By way of example, a travel reservation service enters into arrangements to offer discounts at business establishments in particular locations when an individual purchases tickets or makes accommodation reservations in those locations. When an individual purchases tickets for travel, the individual may be offered benefits at a list of business establishments located at a destination or stop along the route. The individual may be presented a list of such participating business establishments. The list may be selected based on location information stored in a database and compared to travel destination information. The list may be presented in an appropriate manner for the interaction with the individual and the travel reservation service, e.g., on a web page, or by being read by a customer service representative on the telephone or in person. The individual may be required to provide personal information before receiving the benefit, or the benefit may be provided as an additional incentive to user the service provider's services. The benefit need not be offered immediately at the time of traveling. For example, users of wireless toll collection systems, such as EZ PASS™ may be offered discounts or other benefits at particular establishments located near the exit and/or entrance locations regularly used. Similarly, purchasers of mass transit tickets may be offered discounts available during selected times of the day at retailers near selected stations. These discounts may be geared to providing an additional incentive for use of mass transit during times of relatively low volume, such as midday and weekends. Persons researching transportation or tourist information about a particular location, such as a web site maintained by a state or city tourism agency, may be offered time limited discounts in the relevant state or city, or other region.

In a specific example of the above, a method and system is provided for an incentive to individuals to furnish personal information in connection with receiving geographical information from a network resource. Computerized systems, accessible over the Internet using the World Wide Web http protocol, are known for providing geographical information. The information may be provided in response to information provided by an individual at a client computer, ordinarily completing an HTTP form, to a server. For ease of reference, these systems are referred to below as “map servers.” Depending on the type of information requested by the client, the map server provides a web page with geographical information. The geographical information may be a street map centered on a specified address, landmark, intersection, or other location and/or it may contain driving directions, including such information as roads to be taken, the mileage on each road, and the direction of turns from one road to another. The driving directions may include maps showing the route superimposed on maps for a particular location, and may show additional information, such as maps around intersections where the driving directions instruct the individual to make a turn. The geographical information is generally provided by these map servers to all who request them. Individuals may provide personal information and thereby be able to store maps and routes for later retrieval. In the method of the invention, an additional incentive is provided to individuals to furnish personal information to the operator of the map server or permit the acquisition of personal information from other sources. The operator of the map server enters into a business arrangement with one or more businesses having brick and mortar and other physical locations, and stores those brick and mortar locations. Other information relating to the business, including, for example, one or more fields indicating a type of business, may also be stored. Stored information may include whether the business is a restaurant, fast food restaurant, hotel/motel, automobile service station, automotive supply retailer, clothing retailer, general retailer, and a wide variety of other possible business types. These will be referred to below as “affiliated businesses.”

In the method of the invention, the individual is invited, such as through a text message, to furnish personal information, in exchange for obtaining coupons or other benefits that may or may not be time sensitive and may be redeemed at retailers and other locations at or near mapped locations or along routes for which driving directions are provided. Preferably, the coupons or other forms of credit may be used within a limited time after obtaining the geographical information from the map server. The limited time may be a period of hours less than a day, such as 6 hours, 12 hours, or 16 hours, may be a period of days, such as one day, two days, or three days, one week, or other lengths of time. If known, the specific location of the individual at the point when the initial incentive offer is extended may also be a factor that influences the value of the offer, the time within which to accept the offer and the time within which to redeem the offer, as well. For example, the individual's location may be obtained if the individual is using a cell phone, PDA, or other wireless device. The length of time may be selected based on algorithms that include any desired factors such as the type of business and the length of the route. For example, if a route taking approximately one hour is selected, the coupon may be available for use only that day and the next day. For example, if a contemplated route of 1000 miles is selected and a map is provided, the coupon or other incentive-based offers may be available for a measured period of time such as three days or a week. As the time-frame and/or the distance of the contemplated route increases, the time to redeem or otherwise use the coupon or other incentive or benefit may increase. The degree to which the location-specific incentive offer represents a departure from the planned and mapped route may also be a factor that affects the value of the incentive and/or the nature of the reward. For example, the value of the coupon may be calculated according to a formula in which the value increases in some relation to the increase in the distance from the planned route. In addition, the length of time within which the incentive offer may be extended may also depend on the business type. A coupon or other credit for a fast food restaurant along a route described by driving directions may have a relatively short duration, such as one day or 12 hours, as the selection of a fast food restaurant is an impulse purchase. A general retailer or clothing retailer located near a destination location on a route may result in a coupon available for a longer period of time. For example, upon submission of the form by an individual who is not identified as previously “registered,” the map server searches, according to appropriate algorithms, for locations of affiliated businesses near the mapped location or portions of the route. Selected affiliated businesses may be displayed, by a symbol designating a location, with appropriately associated text, on the displayed map in other ways. Alternatively or in addition, text may be provided on the displayed page indicating the distance to and location of the affiliated business locations. A variety of algorithms may be employed to select appropriate affiliated business locations. For example, all affiliated businesses within a selected distance, such as 1 mile, one-half mile, five miles, or other selected distance, of a mapped location, may be displayed. At this point, a message may be displayed inviting the individual to provide the personal information in exchange for a coupon or other benefit good for a limited time at one of the displayed businesses selected by the individual. The individual may then provide personal information, preferably in a web-based form furnished on the displayed page or displayed by the web server on a new page or in a separate window after the individual clicks on the page. After the personal information is received, it may be verified through appropriate verification algorithms, e.g., to confirm that the individual's personal information is not already on file, or to confirm that a postal address may be found in the map server's database. If the information is not verified, then the individual may be asked one or more times to complete the form correctly, or may be informed that the benefits will not be offered. If the information is verified, then the individual may be returned to the page displaying the map or route and one or more business locations. By selecting a business location, such as with a mouse click over the location, a coupon is furnished. A printable coupon with a unique serial number may be displayed for example, and the number also provided to the selected retailer for verification purposes. The coupon will indicate the expiration time, the business location, and the benefit, e.g., a discount or a free product or service. The individual then causes the coupon to print on the printer of the client computer system, and takes the coupon to the retailer to obtain the benefit. Other coupon-oriented techniques, either now known or developed in the future, may also be employed. The order of the invitation and the display may be altered. For example, the individual may be informed, at any point before display of the map, of the opportunity to obtain discounts or other benefits at businesses along a route or near a mapped location.

The individual may then be given the opportunity to complete the information in a displayed form on the page or in a separate window. If the individual does not provide the information prior to the point at which the map or route is displayed, then the map or route may be displayed without the affiliated business locations and information. If the information was provided in response to a prompt, then the individual may simply select the affiliated business of interest when the map or route, with affiliated business information is displayed. The individual may also be given a list of business types from which to select one or more for display. It will be understood that this method is not limited to communication over the Internet, and may be provided in communications to a content provider, or otherwise. In one aspect of the invention, the individual seeking geographical information from a map server may be invited, such as through a text message, or text on a web page provided by the map server or by other means of communications, to furnish personal information, in exchange for obtaining coupons or other benefits that may or may not be time sensitive and may be redeemed at retailers and other locations at or near mapped locations or along routes for which driving directions are provided. In one aspect of the invention, an individual engaged in travel-related activities and other activities related to being at a particular geographic location at a particular time, such as seeking geographical information from a map server, is provided invited, such as through a text message, or text on a web page provided by the map server, to furnish personal information, in exchange for obtaining coupons or other benefits that may or may not be time sensitive and may be redeemed at retailers and other locations at or near particular locations selected based on the travel plans or other expected locations of the individuals. The invention may be implemented as a business method or system, and one or more steps in the process may be carried out by computer software, stored on media readable by computer hardware and/or transmitted electronically, running on computer hardware and containing instructions causing the hardware to execute the steps of the method. The invention may also be embodied in a computer system having means, in the form of computer hardware and software, for accomplishing the steps of the method. It will be understood that a wide variety of technologies may be employed for the transmission and display of information. For example, maps and other images may be transmitted as e-mail, displayed on cell phones, PDA's and other devices having such capability, and in other manners.

A map or directions may be provided via the in-vehicle communications system based on customer location and stored information, without the need to wait for prompting. A map or directions may be provided via alternate means, such as cellular telephone or PDA or other portable electronic device. Maps and directions may include reference to physical commerce locations near or along routes or destinations. Calculation of routes may include incorporation of roads that have physical commerce locations, according to algorithms that include such alterations under appropriate circumstances; the user may be rewarded specifically or otherwise for agreeing to such alteration of route determination. Mapping and route information may include the existence of specific offers that may be redeemed at identified physical commerce locations, such as discounts on all or specified purchases, or points or other rewards for purchases and/or visits or other tasks and activities. Alternative routes may be provided, with alternatives incorporating various physical commerce locations.

Purchase codes, reservation codes, membership numbers and other identifiers may be provided to the customer through an in-vehicle communication system or other form of communication, while the customer is en route or at home, office, hotel or other location. Such codes facilitate efficient matching the customer to a particular offer, benefit, reservation, order, or other item, at a virtual or physical commercial location, such as discounts in stores or hotels, reservations at hotels or restaurants, ticket purchases, reservations of scarce goods, or any other item to which the customer may be conditionally or unconditionally entitled. These codes may be provided via the in-vehicle communication system, or other portable electronic device. This information may be recorded and individuals will be tracked based on date, time, amount of purchase, items purchased and other data supplied by third party commerce providers and/other information.

This information may be similarly useful if telemarketing activity generates sales but customers do not provide account information over the phone. In addition, a separated purchase/payment approach may apply in this context so that payment occurs at a later time in stores, and/or payments occur through a service provider, possibly through a billing function or through other means.

Preferred treatment, as discussed above, can include preferred levels of treatment from the in-vehicle communications service provider, and from other businesses to which customers are steered, for example. Such businesses may include physical commerce locations and online and telephone businesses, and may include stores, restaurants, hotels and others. Methods set forth in the applications incorporated by reference for rewarding customers for agreeing to reschedule or experiencing delays may also be incorporated. Such methods may be employed, for example, if a customer is steered to a particular physical location such as a hotel or restaurant which may be completely booked at the time of the customer's arrival. Alternatively, the customer may be rewarded if the customer simply learns, without going to the restaurant, that the hotel or restaurant is booked, and makes a reservation for a different time for the same restaurant or another available restaurant. These techniques may be extended to businesses other than restaurants. Rewards may be provided for other accommodations, such as selecting another restaurant.

The method of the invention may cause customers to be steered from the vehicle to physical commerce locations, telephone communications, online and other electronic communications for interactions, purchases, payments, money transfers and other purposes, as well as from computers, physical commerce locations or other communications means to in-vehicle communications.

Other means of communications, such as cell phones, PDA's or wireless computer communications, provided by entities other than providers of in-vehicle communications systems may be employed in lieu of or in addition to in-vehicle communications.

Various elements of a communication or transaction may be conducted through differing media, as described in my prior filings incorporated by reference above. For example, a customer may provide all of the information necessary for a purchase, but excluding an account number or code needed for payment authorization, via an in-vehicle communication system or other mobile communication method. The customer may complete the transaction through a different mobile communication method, a separate communication over the same communication method, through an interaction at a physical commerce location, via a network connection to a computer, or through some other manner of communication. The components of a transaction may be divided in other ways. The dividing of information between different media is not confined to purchases, and may involve other types of interchanges or communication conducted using in-vehicle communications systems.

Information regarding items available, such as discounts, locations available for discounted items, subjects of interactions may be provided via partly or fully automated techniques, in lieu of or in addition to live operators or in a variety of other ways. These methods may be combined or coordinated with other methods described herein.

### Altered Timing, Adoption, Reduced and/or Increased Energy Consumption

These programs, systems and methods are applicable to the use of vehicles, devices, appliances or technologies that use energy. The use of particular categories of vehicles, devices, appliances, or technologies may be incentivized and may or may not be incorporated with other programs and rewards such as legal services or access to legal plans. The purchase and use of particular vehicles, devices, appliances or technologies may be events that are rewarded in an incentive rewards algorithm. Coordination of tasks and activities and the coordinated use of individual assets may be incentivized. These methods may be combined or coordinated with other methods described herein.

The altered timing of consumption, reduced consumption, interruptions, increased consumption and adoption or use of preferred energy may be rewarded. Depending on the circumstances and preferences of participants, benefits and other rewards may be variously provided. For example, altering the timing of the consumption of energy, reduction in the consumption of non-renewable or other undesirable forms of energy, vehicles and/or devices that consume undesirable forms of energy and others may be events. Alternatively, events may include adoption, use and or increased consumption of preferred forms and types of renewable energy and other preferred forms of energy, for example. These applications, programs, systems and methods may also be provided for encouraging and discouraging the performance of certain tasks, and/or performance of those tasks in a particular manner and/or at a particular time, or before or after a certain time. For example, such programs, systems and methods are applicable to the use of any resource, product, service or technology. These programs, systems and methods may be applicable to cause users to increase or decrease their overall use of energy, to adopt a particular source of energy, such as renewable energy, to increase or decrease use of energy from a particular source, to adopt, increase or decrease the use of a particular energy delivery system, and to alter the timing of consumption or use of energy, interruptions among others.

Incentives may be provided through an award and redemption system and method of the invention to encourage efficient use of resources or conservation of existing resources in an organization and outside an organization and in other circumstances. An organization, such as a business, government unit or non-profit institution, may create an incentive program in which the use of resources, such as office supplies and communications bandwidth, are events. Use of such resources in an inappropriate manner, such as in excessive amounts, or during high demand times, results in deductions from a point account. Balances in the accounts may be redeemed for various items.

Incentives may be provided through a point award and redemption system and method of the invention to encourage efficient use of resources or conservation of existing resources in an organization and outside an organization and in other circumstances. Resources that are otherwise provided without charge, such as use of email, internet or broadband access, various office supplies and others may be the subject of deductions from a point account that can be redeemed for various items.

### Adoption and/or Use of Preferred Energy Consuming Vehicles and Devices

Vehicles and devices such as those that consume preferred forms of energy may be rewarded. Programs may be provided for factors such as type of vehicle, or those that consume renewable energy and for other reasons, for example. These may be combined or coordinated with my methods described in previous patent applications that involve providing rewards for interruptions, reduced energy consumption, altered timing of energy consumption and others. These methods may be combined or coordinated with other methods described herein.

Redemption of rewards may relate specifically to automobiles, such as credit towards future vehicle repairs including at particular auto dealerships or other repair stations, credit for future purchases of automobiles or related services, as well as redemption towards future purchases, priority access to limited availability of vehicles as well as other products and services and other variations. These methods may be combined or coordinated with other methods described herein.

### Electronic Database Searches and other Services

Various providers of electronic database services such as Lexis-Nexis and others provide various forms of search and information services to customers, including professionals who often pay a recurring base fee and/or a per request fee for access to the systems. Often, participants in such systems and services are then sent a bill that may not be paid by customers until several months after the benefits were provided to users of the database. Users of the system may be rewarded for paying bills by preferred dates and by preferred methods. Bill payments are events in an incentive program. Algorithms are designed so that customers are rewarded for paying their bills as desired and for using the service or requesting data and in other ways, for example. In addition, the adoption and/or use of the services may generate combined tasks and activities and combined benefits in a program. For example, rewards may be provided for adoption and/or use of database services, access or subscription to the services, payment of the bills related to the services, search requests, receipt of search results, and other desired tasks, activities, events and the like. Other variations may be envisioned. These methods may be combined or coordinated with other methods described herein.

### Discrete Dynamic Personal Pricing Program

A method for providing offers targeted to potential customers includes the steps of receiving a request pertaining to products or services, determining, in accordance with an algorithm, an offer, and communicating the offer to the requester.

Such a discrete dynamic personal pricing system and method includes receiving information from individuals, including possibly differentially informed and/or profiled individuals, correlating such information with product preferences that may or may not be made known to the retailer by the individuals in various ways including, for example, by having individuals enter product names, product categories or product codes and by other means, evaluating the preferences in view of information relating to current business needs, such as existing and/or planned inventory management needs online and/or offline at one or more particular retail locations, and discretely providing a personalized discount. The system and method may also be applied to services.

For example, in variations of the invention, this program may be furnished by individual retailers, by groups of retailers, and/or by third party administrators. The third party administrator may function as a conduit between consumers and retailers or may provide its own incentives to retailers for participation in the program. The consumer may be optionally enrolled in the program. Alternatively, the individual may simply be required to engage in one or more particular tasks or activities of value to a retailer, a third party administrator or others. Such tasks or activities may include clicking through an advertising presentation or providing personal information or information about product preferences or others. Information relative to products and services that may be of interest is collected from the consumer. This process may be carried out in a number of different manners. For example, surveys may be presented to consumers. These surveys may be presented on line, at websites or via other computer communications, via telephone, e-mail, or hard copy form and/or various combinations of one or more means. For example, a single paper or electronic form may be presented to individual consumers with a broad list of categories of items and/or a list of particular items that may be presented to consumers online at website, offline and by various other means, together with a list of one or more participating companies indicated. The individual may be provided an opportunity to check off the items that the individual is interested in purchasing, possibly indicating the time frame within which the individual desires to make the purchases and any other factors deemed relevant including, but not limited to, the distance the individual is willing to travel offline, the form of payment that may be used by the individual to complete purchases and range of other factors that may be deemed relevant in the particular circumstances. Rather than using a survey, the consumer may be prompted to enter a single product or category of interest. The program, rather than using a survey, may include an indication of the possible or definite availability of personal pricing on individual items or categories of items at a website, in a paper catalog, or in a physical store location. For example, an icon may be provided in an online catalog associated with a particular product or category. By appropriately responding, such as by clicking on the icon, the consumer may be provided with a request for personal information or an advertisement. Additional information of use to a retailer, such as the consumer's location information, may be requested. After the information is provided, the consumer may be provided with the personal pricing information. In another variation, the consumer must provide personal information before being made aware of the availability of the personal pricing program. The information, however obtained, may be provided to a single retailer, which then provides a reply. The information may be provided to multiple retailers in any number of manners. For example, a third party administrator may provide the individual's information to a number of retailers, receive replies from the retailers, and provide the individual with one offer, all the offers, or some number of the offers. The consumer may be provided a list of companies that participate in the program at some point in the process. The companies may be listed in a suitable manner, such as by ratings of desirability and frequency of offers, as determined by a third party administrator.

A list of participating companies may be made available to participating consumers that may or may not provide a score or rating of each participating company, possibly based on the degree to which those companies make appealing offers to participants and based on other factors.

In this context, as individuals provide a list of goods and/or services that they are interested in purchasing over time that may be presented to one or more companies, those companies may be rated and prioritized on a list and possibly made more prominent on lists based on several factors including the degree to which those companies respond with consistently better offers of discounts and other rewards related to the purchase of goods and/or services and other rewards. The companies may provide consideration to a third party administrator for higher or otherwise more prominent listings in such a program. This process of listing preferred companies based on various rating factors including the degree to which participating companies consistently provide the most favorable discount offers to participating individuals may provide companies with an incentive to extend the most valuable discount offers and other benefits and rewards to participating individuals so as to achieve a more prominent position on the list and/or a higher customer rating and/or a higher company score over time. In another variation, participating companies may be offered an opportunity to purchase a more prominent placement on lists that may result in a greater number of inquires from customers, as well. The reply may be made to the individual substantially in real time, such as in a matter of seconds or minutes during a session at a website of a retailer or third party administrator. Alternatively, the reply with the discount information may be communicated at a later time, such as on a return visit to the website, or in a separate mode of communication, such as by e-mail, postal mail, or telephone call or message.

In another example, the user may be presented with advertising information which must be viewed or heard before seeing the discount information. For example, the user may be required to click through one or more pages of advertising before obtaining access to the discount information. In a telephone interaction, the user may need to hear advertising material before the discount information is provided. The advertising material may concern the product on which the discount is to be offered, or may relate to another product or service that is related or otherwise is determined to be of interest to the consumer. The advertisement may be for a product on which a companion discount is available if both products are purchased, for example. The discount may be fixed, or may involve variations, such as declining over time after the offer is made, of varying amounts depending on the particular physical store location or mode of purchase or payment method, for example. The surveys and/or the survey results that are provided to individuals may or may not be surrounded by advertisements related to one or more participating retailers and/or other interested sponsors and/or advertisers. The survey results provided to individual participants may include links to websites or other referral information so that individuals may, for example, visit a website to learn more about a particular product or service or to learn about complementary products and services that may be included in the survey results provided to the individual by one or more participating retailers; A third party administrator may have available algorithms provided by several retailers which permit the third party administrator to calculate the discounts to be provided. The third party administrator communicates the discount and identifying information to the retailer in addition to the consumer, so that the retailer can process the discount when the consumer shops. The amount of the discretely offered discount that may be made available may vary according to the past conduct of the individual, and various characteristics of the offer. In general, individuals will receive superior discounts, in amount, products available, locations, payment options or terms, and other factors, based on their past participation and performance in the program and based on other desirable factors.

For example, a factor that may enter into the calculation of the amount of the discounts that may be offered by particular companies to particular individuals in this process may be whether the purchases of the discounted items are accomplished online rather than offline or offline rather than online as well as ordering online and picking up items offline at one or more particular retail locations as well as other variations as may be desired from time to time or on an ongoing basis by the retailer individually and/or on an ongoing basis with even greater discounts being provided to individuals who conform to the preferences desired by the retailer. A requirement that a discount be redeemed at a particular retailer's website provides marketing opportunities for that retailer. Another factor may be whether individuals participate in one or more other interactions, either on a single basis or on an ongoing basis, such as marketing interactions by telephone and/or online at websites or other forms of interactions of any type that may result in additional or greater discounts and other benefits being provided;

An additional factor that may determine the amount of the discounts that may be offered by particular companies or third party administrators to particular participating individuals may be whether the purchases of the discounted items are accomplished at one or more physical locations in preference to other physical locations. For example, retail establishments may offer increased discounts to individuals by taking into consideration factors such as distance from the location of the residence and/or zip code of the participating individual, the time involved to travel from the residence or general area of the individual to one or more retail locations that may have an excess inventory of the desired items that retailers are seeking to reduce and may do so by enticing participating individuals to travel to one or more particular retail locations rather than offline and vice versa.

Another factor that may influence the amount or nature or availability of the benefits such as discounts and/or other rewards offers individually and on an ongoing basis may include an unlimited range of factors including whether individuals have accepted email messages and other forms of communication and contact from one or more participating retailers or other entities, possibly regarding products and services, whether individuals have visited one or more websites of one or more of the participating retailers within prescribed time parameters and possibly navigated to certain sections of websites individually and on an ongoing basis, as well as performed other tasks and activities that may be deemed relevant by one or more participating retailers or by one or more other entities.

The failure to buy an item after the reduced or discounted price is disclosed may be tracked and applied to the background profile factor of the consumer provided that information. If an individual receives personal discount pricing information one or more times but if no purchases occur up to a prescribed point, additional information may be required to be disclosed to continue to participate such as additional personal information, or the performance of other tasks or activities of value.

Membership in an existing purchase program available through retailers may be factored into additional discounts, bonus discounts and/or more frequent availability of discount offers beyond those available to others who may not be members or membership in such programs may be a requirement for participation;

In one variation, a customer response rating may be developed that may represent a rating that may be the measure of the value of individuals who participate in the program based on their prior response to any and all offers that have been extended within the program, purchases following discrete price discount offers as well as other factors that may or may not be contained within individual background profile factors and possibly other considerations that may be deemed relevant to participating companies as they consider extending offers of discounts to participating individuals over time. As a single example, once survey results are provided to individuals, the extent to which those individuals respond directly by completing a purchase in any fashion deemed desirable or by navigating to a website and/or by clicking through various product information that may or may not be related to the products and/or services in question or by viewing any other information may improve the background profile score that may be assigned to those individuals over time.

Retailers may develop and consistently alter formulas to provide for better inventory management and better obtaining of loyalty of customers enrolled in the program. Formulas for determining the items to discount and the amounts to discount preferably incorporate recent or real-time information on inventory on particular items. Items which are moving more slowly than anticipated or desired may be the subject of more discounts or greater discounts until the inventory backlog has been reduced.

The history of inquiries of an individual consumer may be employed in an algorithm to generate appropriate items and/or discount amounts. The history of inquiries may be combined with other information about the customer, such as the history of purchases and other background profile factors, in generating an algorithm.

Random rewards may be integrated into the program in various ways. For example, each inquiry may have a certain probability of resulting in the award of the product inquired about or other products either for free or at a higher discount than may otherwise be available. The probability of the reward may be varied by individual based on the individual's history in the program and/or based on other factors.

At some point in the interaction, a second product which is believed to be of interest to the consumer may be presented. This may be a related product, or may be a product that is often purchased by purchasers of the first product. The second product may be presented at the time of response to the inquiry, after the discount information is provided, or at some other time. The second product may or may not be discounted. A discount may be provided on the second product contingent on the purchase of the first product.

In another variation of the invention, a reward is provided in the form of access, either at a restricted website or otherwise, to information about discounts, sales and other information of interest to prospective purchasers of goods or services, which information may or may not be generally advertised to the general public at that time or at any point in time and under any other circumstances. The information may or may not be intended for later advertisement to the general public, or it may never be advertised outside of store locations, for example. The reward may be in the form of a reward in a program as previously described. The reward may alternatively occur as the result of the performance of a task or activity, for example as an immediate reward for clicking through successive pages of content (such as advertising content at a website) that a sponsor may desire the individual participant to view or may be provided without requiring such action on the part of participating individuals. Time and attention measures, either as described in my prior filings or other variations for measuring attention and time, may be employed and used to restrict access to rewards that may or may not have a limited use value such as information regarding upcoming sales and other information, access to advice deemed valuable such as legal and/or medical advice or other information deemed to have value for any reason.

This process may be coordinated with large retailers and entitle customers who view advertising online at websites, possibly within previously described time parameters as discussed in my prior filings or otherwise, to get or gain access to information regarding future sales that may occur at stores offline and/or online at websites, and/or in other retail environments such as mail or telephone order catalogs and television shopping environments. This may entice retailers to coordinate access to certain information regarding future sales and specific products and services in ways that benefit all participants. Consumers may be required to watch an advertisement or perform other tasks and activities including those described in prior filings in order to become entitled to accumulate/earn various rewards including access to discrete offers of discounts, points and other benefits including direct access to valuable information regarding future sales and other special events, including promotions.

It may be determined that a need exists to restrict use of the discounts and sales information that may be disclosed earlier than when such information becomes available to the general public and to prevent it from merely being posted at message boards for all to see. Therefore, if desired, this information may be restricted in one or more ways including by giving participants specific codes or other specific information provided only to participants including purchase codes or other information that may be particular to only those individuals that participate so that by sharing information, no benefit is generated for others. Another variation may be to limit the sale or the codes to a certain number of persons or transactions. Another variation may include providing limited information regarding upcoming sales such as providing a broader list of one or more items, wherein only certain of the items may actually be placed on sale at the discretion of the offeror, a broader list of one or more stores where sales may actually take place, but limiting other valuable information such as the exact time of the sale, the exact list of sale items, the list of exact locations, the exact amount of the sales and other information that may only be provided to participants at a later time nearer to the actual sale with notification taking place by email, phone and/or by other means at a time closer to the event or by making that information available only at one or more stores so that individuals would need to visit the stores to obtain that information.

Additional variations may include providing participants who may click through an advertisement and/or watch an advertisement online at a website, participate in a live and/or recorded and/or automated interaction over the telephone, at a physical location and/or by other means as described in prior filings with preferential access to the sales-related information and/or preferential treatment such as within stores including providing special treatment at checkout lines and special attention and treatment by store representatives within physical locations. In addition, participants who perform any other desired tasks and activities, including all tasks and activities described in prior filings or who perform one or more desirable tasks and activities of any type may receive increased benefits over non-participants such as increased discounts, increased points and other rewards including all forms of rewards described in prior filings. One example of a desirable task to be performed to entitle participants with special access to upcoming sales information or other benefits may include registering to participate, accepting emails or other information by other means regarding other information that may be deemed desirable or relevant for any reason, by filling out a survey, possibly regarding those products and services that those participants may have an interest in purchasing at some point in time and, possibly to fill out a survey sufficiently in advance of a contemplated sale dates so as to enable the commercial establishments online and/or offline to plan their inventories and/or to make special offers of certain merchandise accordingly.

An individual may be provided the opportunity to select either particular items or categories of items which they would like to purchase. In response to the selection, for some select number of items, the individual may be advised of a definite sale, and other items may or may not be subject to a discount. In one variation, the individual may be informed that a certain number of items selected will be discounted, but not the particular items which will be for sale. Combinations of these may be used as well.

Positive and negative incentives may be provided based on the performance of the individual in this program. If it becomes known that the individual has engaged in discouraged behaviors, such as not responding, or notifying others of the information, the rewards may be reduced and/or discontinued. Rewards may be provided or enhanced for responding to the program in any manner deemed desirable. Visits could be an encouraged behavior, even if the individual does not purchase during the particular visit online at websites and/or offline at one or more particular retail locations, possibly within prescribed time parameters. Purchases of other items that may or may not be indicated as part of the discount offer promotion, but which are accomplished by individuals during a visit to a website and/or at one or more retail locations may also be a positive factor in a rating and/or profile and may result in additional benefits and rewards that may extend beyond the program described herein. Adhering to desired behaviors over time may provide rewards, which may include enhanced discounts over and those provided to the public in general, even during promotions. Participation may also generate offers or other preferred treatment even when discounts are not being made available to the public in general.

The existing status of participants including those factors described in prior filings and prior response to all offers may be considered as well including such factors as prior purchase histories and other factors that may or may not relate to the commercial establishment or other entity that may be planning the sale. For example, factors such as whether the individuals paid their bills to other companies that may or may not be directly involved in the sales activity by preferred methods and/or on preferred dates may be considered relevant and result in some form of preferred treatment of the participant at some level.

The methods may include providing lists on websites, offline and by other means that may be presented to participants that may include, among a variety of other considerations, including one or more participating companies, one or more categories of goods and/or services that may be the subject of offers, one or more tasks and/or activities that may be performed to obtain rewards including discounts and information regarding future discounts, one or more descriptions of the nature and extent of the discounts that may be made available to participants and others.

The nature and extent of discounts may or may not include time sensitive criteria and may or may not include other factors including, but not limited to, when the opportunities to participate may be available or when invitations and offers may be extended, what type of tasks and activities may be available to be performed, what type of rewards will be available to participants and other considerations.

The information as to the nature and extent of the discounts that may be made available may also include, if applicable, how long the tasks and activities may take to complete in order to earn access to information related to discounts and/or points that may accumulate up to a point that access to information is provided or discounts are earned. For example, the individual may be provided with an offer to watch a 2 minute commercial that may result in a reward of access to information pertaining to discounts directly and/or result in earning points that may accumulate until a reward including a discount is earned;

The use of the discounts may be time sensitive and may expire beyond a specified duration or point in time that may or may not correspond to points in time before or after information regarding sales and actual sales are made available to the public generally.

Once individuals begin to participate, they may generate quality of response ratings in all respects described in prior filings that may include those related to quality of responses to offers, quality of attention during interactions such as while watching commercials or performing other desirable tasks and activities, quality of responses to offers such as visits to stores and/or websites that result in presence in desired locations such as offline in stores and online at websites, quality of responses to discount offers in terms of actual purchases and other data that may be deemed relevant including information contained in background profiles, if relevant and other factors.

The discount information and other valuable information that may be deemed relevant and that may be displayed may vary depending on information in an individual background profile, and/or in accordance with responses to a survey. For example, the information may pertain to offers of discounts relating to particular items in which the individual indicates an interest, or to items which are the subject of pending discounts and mostly likely to be of interest to the individual, based on survey responses, profile information, and suitable algorithms.

In a particular embodiment of the invention, the individual is provided with one or more prompts to furnish information as to items which the individual may wish to purchase or may be of interest at that time or within a prescribed period of time in the future. In response to the responses from the individual designating one or more items that may be of interest, the individual may be informed that all or some of those items may be subject to a discount at that time or within a prescribe period of time at one or more locations offline and/or online. Information as to times, physical store locations, and the like may be provided at that time or at a later time by various means including by email and by other forms of communication. A manner may be provided for identifying the individual, such as through a code.

When the individual visits a specified destination, such as a physical commerce location, the individual may present the identifying information in one or more ways deemed acceptable in order to ascertain on which items and/or discounts are available and optionally the discount amount or percentage. For example, a kiosk may be provided in a physical store location with an input device (such as a keyboard or touch screen) at which the individual may input a code. After the individual inputs the information, the information as to the products subject to a discount, and optionally the amount or percentage of the discount and other benefits and rewards including bonus points based on participation, background profile factors and other rewards and benefits are provided to the individual, such as by a printer or by other means. As noted above, the visit, as indicated by the individual interacting with the kiosk, may be a factor in calculating rewards. The amount and number of discounts available may be calculated at the time the individual presents the code information and at other times and may be based on a variety of factors, including the individual's past compliance with the program and other profile factors. The amount and number of discounts may be entirely or in part random. The chances of obtaining a discount, or a greater discount than otherwise, or of obtaining a greater number of items on which discounts are available, may be influenced by individual profile factors, such as past compliance with the program, as well as other factors.

The availability of a discount on one item may or may not be made contingent on the performance of another desired or specified task or activity after the individual is given access to the discount or sale information. For example, the availability of a discount on an item of interest may be conditioned on the purchase of another item, possibly within prescribed time parameters, which may be related, or may require the individual to go to another department or location in a store or to a store within a prescribed period of time after access to the information is made available. For example, the purchase of a hair dryer at a discount may be conditioned on the purchase of a bottle of shampoo during the same visit to a store. In another variation, a program may assign ratings to individuals and businesses. These ratings may be based on a wide variety of factors, including such factors as the quality of products and services, charitable contributions, environmental records, labor relations, a history of accepting online dispute resolution processes and procedures, decisions and outcomes, possibly without further processes and any other factors that may be desired or selected. Businesses may be assigned negative and positive ratings. For example, participation in a plan by companies that experience a loss of customer data that renders customers at risk for being victims of identity theft may be provided and a benefit will include reducing exposure to damage claims by victims of identity theft. Individuals that participate in the program may be awarded points, or receive enhanced awards, for doing business with companies with favorable ratings. Individuals may be awarded points or receive enhanced awards for not doing business for companies with unfavorable ratings. Individuals may also be rewarded for ceasing to do business with a business that has an unfavorable rating, as well as for such specific acts as deregistering or terminating an account. Individuals may lose points for continuing to do business with a business that has a negative rating. Events will thus include interactions, such as purchases from or sales to, businesses that have ratings, and the refraining from engaging in such interactions.

These ratings may be employed continuously and/or only on a periodic basis, and possibly only as an enhancement factor. For example, individuals whose record of transactions shows suitable dealings with favorably-rated businesses and a lack of dealings with low-rated businesses may be granted a bonus at the end of a year or other cycle. This system may be employed for avoiding organizations, such as organizations that are engaged in activities, such as pollution and the like, that may not be deemed socially desirable and for other reasons. These methods may be combined or coordinated with other methods described herein.

### Email Forwarding for Rewards

The activities rewarded by a method and program of the invention may include the forwarding of electronic information, such as in the form of e-mail messages, to others. The messages may contain, for example, an advertising message that a sponsor desires to have communicated. The rewards may be adjusted depending on such factors as (1) those forwarding messages earlier or in other preferred circumstances may receive greater rewards; (2) those whose recipients demonstrate review of the message or other preferred conduct, such as linking to a website from the message, may receive a greater reward; (3) those whose recipients forward additional copies to others may receive a greater reward. As a further variation on methods related to forwarding of email messages, the program may specifically reward individuals who forward documents containing content such as news articles that already permit and accommodate email forwarding capabilities so that other persons may receive information that may be of interest to others.

A factor that may result in more or less rewards being offered and/or awarded in a given situation or of differing value and possibly longer term preferential treatment may include whether participating individuals also participated in or proceeds to participate in any other activity deemed relevant for any reason by program administrators or participants. The activity in question may be any tasks and/or activities that may be considered desirable or undesirable at or within any prescribed times and for any reason such as downloading music by preferred methods in contrast to downloading music by other methods that may or may not be deemed undesirable and, in some cases, possibly illegal.

### Postal and Package Shipping and Delivery

The adoption/use of preferred methods for mail, postage stamps, metered mail, postal meters and other purchase/payment processes related to mail, adoption of electronic means and other methods for transmitting, sending and/or receiving documents and other goods and services may be rewarded. The acts of providing mail or packages to a service provider may be events in this variation of the invention. For example, selecting a provider of delivery services may be decided based on the offer of rewards as described herein. In some cases, it may be desirable to conduct a coordinated approach that may be taken by an intermediary to assist other participants to achieve efficiencies. For example, a single program administrator may be combined into a single promotion among a number of package and mail delivery providers. For example, the offer of rewards may be provided to all customers within a targeted group or all customers of all participating entities such as Post Offices and others. Various categories of services and preferences related to the adoption and/or use of products and services may be rewarded, such as overnight, ground transportation, and other categories. These methods may be combined or coordinated with other methods described herein.

### Document Transmission, Receipt, Preparation and Authentication

Transmission of electronic messages and documents in electronic form, with enhancements, such as additional security, reporting to the sender as to progress and review, and the like is available. Such enhanced services are likely to require the payment of additional fees. Incentives may be provided to senders, recipients, and anyone involved in the process of sending such enhanced messages. Transmission of documents such as sending and/or receiving documents such as insurance policies and others may be accomplished using enhanced means to assure security. Any of these types of transmissions may be an event. Anyone who is involved in encouraging the adoption of such enhanced messages may also be provided with incentives. For example, an entity that maintains a marketplace or provides auction services may encourage buyers and sellers to adopt and use such enhanced messages.

One aspect of the present invention is a method for providing incentives for receiving information from financial institutions in electronic form. By way of example, the information may be in the nature of images of cancelled checks of account holders and periodic statements. A points program or other program may be provided in which account holders who receive information in electronic form rather than paper form become eligible for rewards. Thus, the receipt of information in electronic form may be an event, or the receipt of information may be an event, with the required status being receipt in electronic form. A points program may also include disincentives for account holders who elect to receive original paper checks or other documents in paper form. Receipt of documents in paper form may be an event which is processed by a rewards algorithm to create a negative rewards amount, for example. These programs and incentives will assist in the adoption of check truncation by banks, as well as reducing other costs of banks and other financial institutions.

For example, a bank provides a checking account in which payments may be made by way of paper checks. A program may be provided to furnish rewards for customers who agree not to receive originals or paper copies of their cancelled checks, but instead to have images of the checks, including both sides, available for review electronically. The checks may be available for review only at a secure website, for example. A wide variety of incentives may be provided for refraining from the receipt of original paper checks or copies of paper checks. These incentive may include a points program. A rewards algorithm may consider, for example, the number of checks processed in this manner on behalf of a particular customer, the number of billing periods that the customer agrees to have checks available only on line, the length of time that the customer agrees to have checks available only online, and other factors. The points may be redeemed, including automatic redemption, by preferential treatment in the terms and conditions of the checking account as an alternative or in addition. For example, the customer may be rewarded by lower fees, receiving for no fee certain services that otherwise require a fee; a higher number of transactions, such as checks, per billing cycle at no fee or at a flat fee; a lower minimum balance to avoid one or more fees, and other factors relating to fees.

In another aspect of the invention, a financial services provider, such as a bank, credit card provider, brokerage, mutual fund, or other service provider, furnishes an incentive for a customer to receive periodic statements only electronically. For example, the statements may be accessed through a secure website. A notification, such as by email, may be furnished to alert the customer to the availability of a statement. The receipt of a statement in this manner, and agreeing to receive statements in this manner, may both be events that are considered by an incentive algorithm. The customer may receive benefits, such as through a points program, for such items as agreeing to receive statements electronically only, the number of such statements received in electronic form only, the length of time that the statements are received in electronic form only, and other factors. The customer may also receive reduced fees, fewer fees, or discounts on fees, for receiving the statement in electronic form only.

Negative incentives may be provided for customers who rely on the use of paper documents. Such incentives may include charges, deductions of points against a reward programs, increases in fees for other services, and other variations. Negative incentives may be provided for such items as requiring the return of original checks, requiring a paper copy of checks, using a paper form for a transaction, such as a deposit, which may be accomplished electronically, using a teller or other employee for a transaction that may be accomplished by automatic teller machine, website or other process, or use of live telephone operators. All of the foregoing may be events.

Rather than being made available via a computer connection, information may be made available via telephone connection. Customers who accept this alternative in lieu of paper copies of checks and other transactions may be rewarded. Customers may also be provided an incentive to simultaneously connect to a resource, such as a web site, and a telephone connection. Checks or other items of lesser interest may be reviewed through a voice response telephone connection, and items of particular importance designated for online review.

These methods may be extended to other providers of services and products who furnish periodic paper statements to customers. Thus, any periodic bill or other documents such as are described herein and previously may be furnished electronically only in exchange for a benefit to the customer, for example.

It will also be understood that the method is not limited to documents provided to customers. Documents provided to vendors and others may also be converted to electronic form in exchange for benefits defined through a program. Thus receipt of order forms, invoices and other business documents of any description in electronic form may be an event.

The methods and systems of the invention, as noted above, may be employed in connection with incentives for preparation and authentication of documents. For example, tax preparation services may provide incentives for use of their services. Such factors as enhanced rewards for repeated use of services on a consistent basis may be included. Notaries may provide incentives for use of their services for authentication of documents. Any private or other service that provides authentication of physical or electronic documents may similarly provide rewards for use of the services.

### Text Messaging/Interactive TV Incentive Solutions

In another aspect of my invention, a number of variations and variables may be considered relevant in given circumstances may include sending text messages over wireless devices and/or over land-based telephone systems and other means of communications that may be displayed on television screens before, during and after various television programs and at other times related to particular television broadcasts and for an unlimited number of purposes including, for example, in order to enable consumers such as individuals and groups to rate the performances of individual characters, to rate various programming, to provide feedback regarding the broadcasted content and for other reasons that may be relevant to particular circumstances including the desire on the part of the consumer to have their text message or other interactive efforts displayed on television for viewers to see and react to in various ways. In alternative to a generally available program, certain consumers with celebrity cell phones (or other celebrity-endorsed communications devices) may get or obtain special access to listing messages or special rewards in all the various ways described above or in any of my other applications.

These methods and those described in all my other co-pending patent filings may include various considerations including individual background profile factors that may include consideration of the time of day when interactions occur, the length of single interactions and/or the duration of individual and multiple interaction sessions that may occur in single instances and over time, the number of text or other messages sent and/or received, the number of interactions completed within prescribed times, feedback and/or other viewer assessments regarding the popularity and/or other qualities related to the performances or content that may be displayed on interactive televisions. These assessments may be determined by voting and by other means for measuring quality of broadcasts, the quality of other viewer responses, the legitimacy and/or accuracy of viewer responses and/or based on other criteria that takes into account an infinite number of other considerations that may or may not include background factors of viewers, interactive participants and others.

### Award of Points at Outset

In alternative variation to the methods described above and in all previous filings, individuals who register in any of the various programs may be awarded a prescribed number of points at the outset of the establishment of the relationship and/or at the outset of a particular promotion. Thereafter, if individuals perform or avoid the performance of one or more tasks or activities within prescribed times, the points and/or entries in sweepstakes drawings and other rewards may then become earned and available for use and or redemption in applicable promotions, subject to other program restrictions that may or may not be deemed relevant in given circumstances. If additional tasks and activities are not achieved within prescribed time frames, the points and related opportunities associated with them may expire. This approach may be adopted in regard to the adoption of a payment card so as to inspire customers to perform various tasks and activities to motivate use of the payment card within prescribed program parameters.

A factor that may result in more or less rewards being offered and/or awarded in a given situation or of differing value may include whether participating individuals also participated in or proceeds to participate in any other activity deemed relevant for any reason by program administrators or participants or by others related in any way to the program. The activity in question may be any task and/or activity that may be considered desirable or undesirable at or within any prescribed times and for any reason. By way of example only, rewards may be offered for the activity of downloading music by preferred methods in contrast to downloading music by other methods that may or may not be deemed undesirable and, in some cases, possibly illegal.

In a variation of the method described in the preceding paragraph, individuals and groups may agree to provide time and attention to advertising interactions in exchange for free or reduced cost premium content. Premium content includes any information or entertainment for which the individual would ordinarily pay. Examples include pay per view cable television broadcasts, paid subscription content on websites, information available via telephone, and paid subscriptions to printed and e-mail periodicals. These methods may be combined or coordinated with other methods described herein.

### Preferred Status

In another aspect of the present invention, a method and system is provided for incentives available only to individuals (including individuals, organizations, sites, and other groups) that have a preferred status. The preferred status may be based on any criterion or criteria. The preferred status may be available, for example, only to those who have a version of a product, such as a software product, that meets certain criteria. The criteria may include that the version be the most recent release of the software product, or a version no older than a certain limit. For example, all registered users of the most recent release of a software program may be eligible for certain benefits. Such benefits might include points related to certain activities online, access to content online that is otherwise unavailable, discounts on products and services, and other benefits. Tools might be included within the software to activate the benefits. Other examples of products and services eligible for such preferred status might include owners of the most recent model of a certain automobile, subscribers to certain levels of services, such as telephone services, maintenance plans, insurance plans, and other types of continuing services. This status may be applied to any service or product of any description.

The availability of such benefits may expire after a certain length of time, or when the next version of the product is available. For example, the preferred status may be available only if the consumer becomes a registered user of the next upgrade of the software within a certain period of time after it becomes available. The preferred status may remain available for a selected lifetime of a product, such as four or five years for an automobile. These methods may be combined or coordinated with other methods described herein.

### Celebrity Rewards Programs

The term “celebrity” as used here may include any individual or group of individuals, whether by a collective name or separate names. The individual may be an individual who is widely known to the general public or to a segment of the general public. Such individuals may include well-known actors, athletes, musical performers and authors, by way of example. The individual may be someone known to a segment of the population, such as an individual known in a particular geographic area, or to persons having a particular interest. The group of individuals may be the members of a performing group, such as a band or group of actors known by a collective name, or a group of individuals not known by a collective name.

There are numerous benefits that may be derived by the implementation of celebrity-sponsored payment cards for payment card providers including increased sales and transactions related to increased payment card use, increased card account balances and fees related to those cards, increased donations of rewards for special causes such as celebrity-sponsored causes once rewards are earned and others. The celebrities will be inspired to participate in the program on a continuous basis by offering their time, attention and efforts to promote the payment cards in various ways that may involve efficiently leveraging the high profile of the celebrity, by offering their time and/or physical presence in various rewards programs and/or by offering various personal items or other items of interest, products and services that may be made available for redemption and/or as prizes from time to time and on a recurring basis. In addition, celebrities would also have an incentive to provide access to themselves and to encourage other celebrities to do the same in various circumstances and venues offline and online, since doing so would likely increase transaction volumes and interest on the part of consumers who adopt celebrity-sponsored payment cards.

Alternatively, consumers will be inspired to use their celebrity-sponsored payment cards to make purchases in various contexts, including online and/or offline, to pay recurring bills in various ways that may be desired in particular circumstances, possibly to verify their presence at various specific locations offline and/or online for time-sensitive marketing purposes and/or for other purposes on individual occasions and/or on a recurring basis. The amount of points and other rewards that may be awarded to an individual may be based upon any one of an endless range of considerations including individual background profile factors of individuals that may possibly result in individuals receiving points for participating in particular promotions and for an endless variety of other desirable reasons. The above described interactions and others may possibly occur at or within preferred dates, times and locations offline and/or online at websites or over telephone and interactive television networks and others, then additional benefits may be generated for the consumer, for the celebrity and for card providers, as well. In addition, consumers may be able to earn incentives that may be offered including traditional rewards such as points-based offers, entries in sweepstakes, special redemption promotions and prizes as well as discounts and other items of value.

If the celebrity in question happens to presently sponsor a clothing line or a line of other goods and services, then the incentive-based offers and rewards that are generated may be incorporated in various ways. It is well recognized that certain celebrities maintain clothing lines and other product lines. Consequently, bonus rewards may be offered to individuals for examining and/or purchasing particular goods and services that may or may not be associated with his name such as a celebrity-sponsored line of clothing or line of jewelry. The examination and/or purchases of goods and services may take place online and/or offline, possibly at or within prescribed times and/or with a celebrity-sponsored payment card online at websites and/or offline and in other contexts. The payment cards may or may include opportunities to earn rewards and/or such other similar phrases that may be related to the promotion itself and/or in the case of a celebrity that may or may not relate to the name of the celebrity in some way such as a payment card that may be referred to as the card through appropriate marketing efforts.

Some of the benefits and rewards that may be associated with the adoption and/or use of celebrity-sponsored payment cards may include special redemption offers and special rewards that may consist of various goods and services that may or may not be related to the celebrity. Other rewards designed to inspire greater participation in the program and greater payment card use may include benefits, rewards and prizes including autographs, autographed pictures and other memorabilia as well as other items that may be offered separately or in combination with traditional rewards in various promotions. Those benefits may include, among others, the award of redeemable points and/or entries in sweepstakes to win access or tickets for entry into venues and various events such as concerts and other gatherings and special access to transportation, parking and events and activities offline and special access to events and activities online at websites or over the telephone or over interactive television that may or may not be made available solely for participating consumers who achieve specified program requirements. Other rewards may include tickets for admission to events, special or preferred treatment including special parking, special or preferred access to events, access to tickets for preferred seating or other admission at events, and other promotions that may be associated with the sponsoring celebrities or other celebrities and/or other individuals and groups and events that may or may not be directly affiliated or connected with the one or more celebrities that participate in the promotion in question.

Other benefits for those participants who earn points exceeding specified targets and other goals that may or may not be limited to prescribed periods of time, may earn special access to limited seating at celebrity events, possibly once tickets are separately purchased by participants at the regular or discounted price, guaranteed access to limited numbers of tickets that may otherwise be unavailable to participants or other benefits related to any other venue and on any other occasion and any location whatsoever, other preferred treatment that may include special transportation and access to celebrity-owned clubs, VIP sections within clubs and parties that may or may not be sponsored or patronized by one or more celebrities who may or may not also be sponsors of payment cards as well as a wide range of other settings and situations. For instance, other examples of benefits, rewards and prizes may also include time-sensitive conversations and interactions with celebrities in any settings and for various lengths of time, including in-person offline and online at websites and over other communication networks including telephones, interactive television and others. Access to clubs, special access in chat rooms and other online and in-person venues, in which the celebrity is guaranteed to be present and/or available for interactions for at least some period of time during a time period, such as a certain number of hours each month as a single example, may be provided. The redeemable rewards and prizes to inspire people to participate in all of our various programs described herein and in all previous patent filings and may result in preferred access to celebrities.

In an alternative method of the invention, rather than adoption and use of a celebrity-sponsored payment card, the method may be applied to the adoption and use of other celebrity-sponsored items and devices such as cell phones, computers and any other devices or items of any type. An additional application of celebrity cell phones, or other celebrity-endorsed or branded communication devices, is described below. The celebrity relationship and member rewards program may even be extended to and include contractual relationships for goods and services of any type including cell phone access, Internet access, car loans and other payment relationships wherein there is a desire to influence the timing and method for paying recurring bills and any other scenario that lends itself to a relationship that may benefit from association with celebrities and other identified persons of interest for any reason. In additional promotions such as those described herein and in previous filings with regard to the adoption and/or use of payment cards in various ways and at various times may be applied to the consumption of airtime minutes overall within prescribed times and/or in other desirable ways, such as during off peak times rather than during times of peak demand if resources are limited and such conduct is deemed desirable from time to time, as well. Moreover, the availability of various rewards may be limited to certain television channels or networks or other defined forms of communication and content distribution.

For instance, the consumption of minutes of airtime using cell phones or other devices that involve the establishment of a connection may be at preferred times of the day and/or preferred days of the week and in based on other factors. For instance, in cases of limited availability of prizes such as tickets to events, a factor may include the first individual or group to reach established consumption targets or the most minutes consumed during or within prescribed time parameters, or among a group that purchases special items of interest, such as one or more items of a particular clothing line within one or more stores or websites within prescribed times, one or more individuals will be eligible for rewards and other factors. In return for such desirable conduct, consumers may benefit from opportunities to earn and/or redeem points or earn entries in sweepstakes to win prizes and to earn other rewards that may be generated in particular circumstances. The rewards may include redeemable points, entries in sweepstakes drawings, opportunities to win enhanced prizes, discounts and others that may include opportunities to meet and/or interact with one or more celebrities in particular ways, the identities of which may even change from time to time and a wide range of other rewards and prizes.

It should be recognized that the mere possession of celebrity sponsored goods and services at various times may generate rewards and other benefits. For instance, if a celebrity-sponsored cell phone number may be called as part of a promotion at a concert or other event. As just one example among an endless variety of others, if the owner of the cell phone is present and answers the phone, that person may be invited onto the stage or receive other benefits. Alternatively, the mere possession of a payment card or cell phone may entitle the possessor of the payment card or cell phone to priority treatment or access to venues or events or special locations within venues or events as well as discounts. An endless number of other examples of preferred treatment may be structured around the celebrity-oriented program and arrangements can be made between and among various commercial establishments offline and online that will agree to recognize the holder of celebrity payment cards or cell phones or other status that will result in preferred treatment for that person.

The celebrity may receive additional and/or independent consideration for incorporating incentives or rewards related to a particular event in the celebrity's program. For example, a celebrity may receive certain consideration for appearing in promotions for a particular event, and receive additional consideration for including some item related to the event, such as preferred, discounted or actual tickets, as a reward in a program, or for providing enhanced reward levels for program participants who attend or purchase tickets for the event. An event may require use of a celebrity card or other celebrity program for the purchase of tickets, the purchase of preferred or selected tickets, or other items. Other variations beyond attendance or purchase of tickets may readily be envisioned.

A celebrity card program could also include rewards or incentives for persons to engage in or refrain from selected tasks or activities, including making telephone calls or otherwise receiving information, making purchases, dealing with certain entities or organizations, or other tasks and activities.

The celebrity card program may include incentives to participate in any of the tasks and activities described in my prior co-pending applications listed below. These activities include the payment of bills by prescribed times and methods, blood donation, providing time in charitable or public activities, engaging in marketing-oriented activities and interactions, registering to vote, and any other type of task or activity whatsoever.

An additional incentive may be the providing of enhancement, such as multiplication by a factor, of existing points, for engaging in a particular task or activity. The enhancement may be time limited, and/or the enhanced points may be confined to redemption for particular limited rewards. For example, those who purchase tickets to a particular concert may be provided with a doubling of all of the points in their account to use for upgrades of the tickets, VIP passes for the concerts, souvenir items for purchase at the concert venues, admission to parties featuring performers, and any other time-limited items, and/or merchandise.

Particular rewards may be provided based on any number of past performance factors that may be deemed relevant such as performance in one or more incentive-based promotions or other activities. For example, for discounted or preferred tickets to an event, charitable or civic acts, such as blood donation, may be given additional weight.

In another variation of the programs described in previous filings and herein, certain issues and/or causes may be identified and made available in the program for selection by consumers from time to time as the targeted beneficiaries of the benefits generated by particular payment card use. For instance, from time to time or on a recurring basis, customers may select a particular individual, family or group to receive benefits. Examples include individuals who may need a costly operation or a family or group that may have suffered a tragedy such as a fire or for any reason to receive benefits generated through the adoption and/or use of particular payment cards. In such a case, consumers may be able to decide to donate accumulated or earned points, entries in sweepstakes drawings, prizes and other rewards into a specific fund that may be available for the benefit of a designated beneficiary or causes, efforts and programs. These methods may be combined or coordinated with other methods described herein.

### Other Services

In another alternative embodiment, rewards may be provided for particular tasks and activities in connection with a service that requires input from customers. For example, a dating service may offer incentives for tasks including registration, requests for data, such as profile data of others, receipt of data, continued membership, payment of bills by preferred methods and dates and others. These methods may be combined or coordinated with other methods described herein.

### Achievement of Health and Fitness Goals

In another alternative embodiment, the various forms of incentives including points, entries to win prizes and other forms of rewards may be made available in a program for participating in fitness activities that ma or may not be sponsored by a health club or other interested parties and achieving established weight loss goals and other health related goals that may be tracked and rewarded in various promotions geared toward maintaining good health. These are additional examples relating back to performing health related tasks and activities. Goal achievement may be verified in various ways including in person and through supply of confirmation by a third party such as a doctor or other health professional or by any other methods deemed acceptable. For example, life and health insurance companies and other parties may desire to sponsor the promotions, as well.

### Public Service Rewards

While it is well known that points programs inspire individual motivation in the commercial sector, such programs have not been traditionally connected to the military, other uniformed public service, such as police and fire, and other types of public service. However, the military personnel may also be provided incentives under programs of these types for the performance of any and all desired tasks, activities and favorable behavior that may or may not be time-sensitive in nature. Such programs may be administered by the military, with rewards either during service or in the form of additional governmental benefits at the conclusion of service, particularly in the performance of monotonous and tedious tasks and activities that represent difficult periods for maintaining motivation and attention to the task in question. Governments at any level may sponsor programs for rewards for other types of public service, such as uniformed public service or non-uniformed public service. Private organizations may also sponsor programs for rewarding military personnel, teachers in public schools, and other public servants, with rewards either during or after the conclusion of military or other public service.

In a further variation of the invention, an additional form of incentives in an incentive rewards program is furnished to members, account holders, or the like, who are affiliated with the military, civil defense or a similar service. For example, an enhanced benefit may be made available only to members of the military, police officers, fire and others. Thus, the incentive rewards algorithm will consider as a factor the status of an individual as a public servant, uniformed public servant, active duty military, reserve or National Guard military called to active duty, police, fire or similar status. In addition, rewards may be provided, possibly only to active duty military personnel and their families, and/or to reserve and National Guard personnel and their families, and/or to other uniformed entities such as the Coast Guard and Public Health Service. The program may be designed such that benefits are enhanced during times when participating members of the military are posted away from home as one example. The benefits may also be provided for any overseas posting, even a permanent posting, and other variations may be provided including mere membership in such organizations engaged in defense and security efforts among others. Additional points may be awarded for tasks and activities, such as purchases, or membership or enhanced membership in a services program such as prepaid legal services during the time that the military personnel is posted away from home by such personnel and/or by the families or designated persons connected to such personnel. Existing points may be enhanced and redeemable for greater quantities of goods and services, particularly by family members, when the military personnel are away from home. If the benefit is provided to reserve and National Guard members, then a similar enhancement may be provided at any time that the member is called to active duty as one example of a period of time deemed appropriate for special recognition and treatment. The program may provide that members of the services may designate a user of the benefit, such as a parent, girlfriend, boyfriend or other designated person may have the use of the increased benefits. These methods may be combined or coordinated with other methods described herein.

In another example, a type of coordination of technology involves a system for rewarding participation in monitoring for criminal, terrorist or other illegal and illicit activity. In the context of physical location-specific tasks and activities in a system of this type, owners of vehicles agree to installation of tracking and detection devises such as GPS, cameras, microphones or other detection equipment on their vehicles. The equipment is positioned to detect activity outside the vehicle. For example, small video cameras may be installed in the front grill of an automobile or other location to provide a field of view looking forward from the automobile. Any form of small video cameras may be installed in any craft including aircraft, such as general aviation aircraft, with a field of view in any desired direction. The coordination of images and data generated from cameras and devices at remote locations may be preferably transmitted to a central station for prompt viewing by organizations such as law enforcement. Individuals enrolled in the program may be preferably tracked, such as by GPS units in vehicles or by other tracking devices on persons, and establish time-sensitive connections with wireless communication devices, such as cellular telephones, that can receive messages that may assist in the coordination of the performance of tasks and activities. A law enforcement agency, or other entity responsible for homeland security, bail bondsmen, neighborhood watch groups and other crime prevention participants, becomes aware of a need to monitor a particular location in a coordinated fashion to avoid inefficiency by ensuring the coordinated distribution of assets or to coordinate the search for particular individuals or groups of individuals that may pose a security threat or may otherwise be targeted for detection and/or scrutiny. For example, a threat may be detected against a particular building, facility (e.g. dams, bridges, rail-yards, highways) or historic artifact (e.g., the Liberty Bell). An administrator, such as a computer system administered by the law enforcement agency, may direct a message to the communication devices of all of the approved individuals within the system, or all of the individuals detected in a certain geographic zone that may have previously registered. The message may request the individuals to activate their cameras and engage in any number of activities to collect visual or other data. For example, the individuals may be requested to travel during certain hours in a certain zone near a building, facility or artifact to which an alert pertains, or may be requested to direct vehicles and other craft toward specified locations or directions at specified times. Individuals may be requested to point cameras and other devises toward persons matching certain descriptions; face-matching and facial recognition technology may be used to determine if the person is a wanted individual, suspected criminal or terrorist, or the face may be matched manually at any point for system evaluation purposes. Points may also be awarded based on the length of time an individual participates in the program, the frequency with which the person performs the requested tasks and activities, the importance of the tasks and activities, the degree of effectiveness or reliability of individuals, special qualifications or capabilities possessed by individuals who contribute those capabilities and other factors. The severity of the current threat level may be one of the factors that may be considered. The leveraging of existing fleets of vehicles, such as trucks and taxi fleets and delivery vehicle fleets, may be enrolled as a group in such a program. The incorporation and coordination of commercial watercraft, pleasure watercraft, private aircraft and other assets that may already be within existing activity infrastructures may be coordinated in ways that accomplish valuable security related tasks and activities. This principle may be extended to the collection of other types of information from individuals distributed over an area. Individuals could be enrolled in a system for collection of weather data, for detection of airborne pollutant levels, for the scale of a spill or leak of oil or other chemicals, for flood level monitoring, and numerous other goals. Points may be awarded for furnishing information as to illegal activity, such as information as to unauthorized use of cable television and other conduct that generates inefficiencies.

Similarly, incentives may be provided for reporting of illegal activity on the Internet. The identity of websites being used for criminal activities, such as distribution of child pornography, providing false identification, engaging in fraud, terrorist activities and the like, are very difficult for law enforcement agencies to catalog and enforce for a variety of reasons. By providing an organized program and approach for members of the public or members of other defined groups that may be coordinated on a by-invitation-only basis to report information pertaining to such sites to law enforcement, such as at a designated e-mail address or website, and providing incentives for accurate information through a points program, the resources of law enforcement may be better expended.

Programs may be provided to increase communication to the general public of information needed to be disseminated quickly, such as information about terrorist threats, weather (such as hurricanes and tornadoes), floods, releases of poisonous or radioactive material, and other time-sensitive information. The program would enroll providers of communications and content. Enrolled providers could be website administrators, cable television providers, broadcast television providers, landline and cellular telephone service providers, paging service providers, and other service providers. By enrolling in the program, the provider receives communications from a government agency, or a private agency (such as the Red Cross) with a public purpose. In response to the message, the provider may communicate the message. In the case of a website owner, this may be by a pop-up or other text message. In the case of telephone service providers, this may be by generating telephone calls, by providing audible messages during open communication links, or by generating text messages to telephones equipped for such messages. Participants in such emergency message redistribution programs may be sufficiently incentivized by being permitted to advertise and promote their voluntary participation in the alert system; however, monetary or other direct rewards may also be provided for participation by individuals, groups and entities. Color-coding of threats may be included in such a system; for example, participating websites and other communication providers may periodically provide reminders of the threat level by displaying permanently or at specific times or upon request, a traffic signal or other display indicator with the appropriate color illuminated and a time indicator to display when the heightened alert was issued, why it was issued and what conduct is called for by targeted individuals and groups.

In any of the foregoing programs alerts and other indicators relating to illegal activities, assistance in emergencies, and the like, the award of points may be provided or enhanced depending on the level of importance or priority. Thus the algorithm may be altered depending on the urgency of the need. For reports about suspicious activity, the award may increased depending on the terrorism alert level, or on a local basis if there are dangerous fugitives in a particular area. Rewards for assisting in medical emergencies may be increased if there is a high rate of infections in a particular area, for example. Rewards for other activities benefiting the public good, such as blood donations, may be altered depending on the degree of need determined by a government agency or other administrator of a program.

Programs of the invention may be used to provide incentives for physical relocation of persons, to various sites, regions, or destinations, either on a temporary or permanent basis and may be tracked in time-sensitive ways and rewarded in time-sensitive ways. Purposes might include volunteer programs, or government, developers or community groups promoting development of a particular geographic area and the timing of availability or delivery of rewards. These methods may be combined or coordinated with other methods described herein.

In another aspect of the invention, persons with responsibilities relating to inspection, searching or screening of persons, items, documents, activities and other circumstances, such as security screening, observation of locations, conformity with screening and other security protocols, quality control in manufacturing processes and other businesses, and auditors of businesses including accounting practices, charitable and governmental, civilian, military and other operations and activities, may be enrolled in a program as part of the invention. Such persons are referred to generally herein as “inspectors.” Such persons may include, for example security screeners in airports, security personnel and other individuals within prisons, at border checkpoints and elsewhere. Enrolled persons such as security personnel may be tracked and rewarded with points for identifying items that are classified within categories of items that may be deemed to be on a list of identified and prohibited items, such as weapons, explosives, drugs and other contraband, as well as identification of fugitives and other persons who may be wanted for questioning by law enforcement or who may be sought for other reasons not involving law enforcement purposes. Knowledge of and conformity to screening device usage such as bomb detection technologies and others may be rewarded. Thus, the detection of any of the foregoing, as well as conformity to procedures, constitute events to be considered in an incentive rewards algorithm. In other contexts, points may be awarded or deducted for such items as accounting errors, potential or actual fraud, the failure to conform to established procedures, defective products and others. Discovery of listed items, conformity to knowledge or conduct-related protocols or other desired behavior may be rewarded and included in individual background profiles. A program may be designed to reward particularly adept screeners and other personnel who may be identified rewarded, promoted or provided other benefits. Persons may also view a profile that identifies them as adept in a particular skill as an asset and include that information on other contexts for value. An announced increase in the relative degree of perceived threat may correspond to an increase in the number of points that may be awarded to individuals who locate specified items or individuals. If, for example, the government, business, a private entity or an individual were to use a numerical or color-coding system to identify different levels of attention as being required or threat of danger posed in a particular situation such as in the case of the degree of terrorist threats posed that constitute and signal a heightened degree of threat posed, the number or value of points rewarded may vary and increased or decrease in number or individual value depending on the level of attention, scrutiny or threat as indicated by color-coded methods. The use of visible signals may be provided at security screening locations of changes in threat levels through signals of different colors, for example. Individuals may be enrolled and rewarded with points separately or as members of teams or groups of individuals at particular screening or security check points and other locations and may be enrolled individually, as a single participating group, multiple groups, multiple groups and other status assignments. The use of a team approach within the context of searching for specified items and persons within defined classes and categories during prescribed periods of time inspires a common interest in achieving maximum performance and an effective concerted effort for individuals in all relevant categories of tasks and activities to remain vigilant in the search for specified items, persons, processes, methods of operation and other activities, particularly during times of heightened security or need. In order to assure timely processing of individuals and traffic at specified locations, screeners and examiners may also be rewarded for processing individuals, passengers, items or other units of goods on a consistently timely basis or on other grounds and, in particular, for the timely and efficient, inoffensive and acceptable processing of individuals or groups or others, including those who may be taken aside for more intensive background checks and searches and items that may warrant closer inspection for any reason. In this context, participants including screeners or teams of screeners and individuals who are subject to inspection may, under various circumstances, receive points collectively and in other ways depending on, for example, meeting goals for single, multiple time and/or average time to completion of processing, or for checking persons within a maximum time threshold permitted individually and over time, time of inconvenience or delay individuals experience during the process and on other grounds. Supervisors or others may be able to suspend the time measurement feature with or without notice so as to exclude particular passengers who are determined to require more time for background evaluations and who justify a departure from the applicable time-sensitive guidelines that may be in place to determine the number of credits or points to award in the program or the value or type of available prizes for redemption. It will be understood that this principle may be applied to any security searching and screening process and in other circumstances wherein scrutiny of items and location of specified items may be desired on a recurring basis in which timely, yet thorough processing of individuals and materials may be desired.

The number of points awarded or the types of rewards may be adjusted for a variety of reasons. For example, the Federal government currently issues terrorism alerts with various gradations or levels of severity to indicate the relative degree of threat posed during a given period of time that may be reflected in the choice of a color within a color-coded alert system. Other variations and alternative approaches may be envisioned. Additional points may be awarded or enhanced rewards may be provided and offered to individuals who make themselves available or who otherwise perform in accordance with applicable existing or heightened standards during periods of high threat alert levels. An algorithm for determining the number of points awarded for identifying a particular specified item or categories of items that may include contraband and the current terrorism threat assessment level that may be considered as a factor. Other factors may be provided in response to terrorism information that may be increased or reduced as updated information is received on an ongoing basis over time. For example, if a heightened security alert is issued as to an attack on one or more particular types of facilities, such as stadiums, airports, or government offices, enhanced points may be available during the duration of that alert for screeners at that type of facility and for the coordination of presence and focus of individuals. Participation at each level and on a consistent or repetitive basis by individuals may result in enhanced value status during particular times or thereafter at all times to motivate individuals as needed. Similarly, if an alert includes information about the type of contraband or location, such as explosives in the shoe of the individual, or knives, then additional points may be awarded for identifying contraband of that type during specified periods. Random contraband items may be included by supervisory personnel or a program administrator to provide incentives on an as needed basis in the event that items or persons are identified or events occur or are avoided that warrant exceptional awards to accommodate exceptional circumstances within or outside of prescribed rules of conduct or program participation. Restrictions regarding entitlement to an award of points in any circumstance may require certain conditions be met such as an arrest and conviction of individuals who may be discovered to possess contraband to ensure system integrity.

Individuals may be surveyed shortly after passing through security screening for their satisfaction with the screening process and incentives may be awarded for the screening team that receives the fewest complaints from such individuals who proceed through the interaction process. For example, surveys may be presented to passengers after they board the plane. The identification of individuals or groups of personnel may be accomplished by individual or group identification methods such as a number system. The results of such surveys may be included as events in calculating incentive awards. Survey participants may also be targeted, such as by surveying only the most valuable passengers, i.e., frequent fliers who may have greater familiarity with processes than occasional system users. Individuals or groups may be surveyed on both the speed and the quality of the personal interaction and regarding other criteria.

In the context of searching for items, such as in the context of airport security screeners and guards, an incentive may be provided by notifying several teams within specified areas that an attempt will be made to take a known item of contraband or an item made to appear as contraband through a randomly selected checkpoint at a randomly selected time, possibly during periods of heightened threat levels or during any other specified time-frames. An additional bonus may be offered to an individual, or all members of a team, that identify the contraband or other specified items. This use of prior notifications and random selection of the time and precise person or team may be used for other types of inspections, such as inspections for product defects, inspections for fraud in documents, and other types of security inspections.

The incentives may be provided at all times or only for or within certain times of the day or during certain days of the week; the times may be withheld from the screeners until later so that there is an incentive for high quality of service at all times. The screening location may be videotaped, so that the video may be reviewed to verify passenger complaints; the video may also be reviewed on a spot check basis by persons reviewing the quality of screening and in conjunction with the determination to award or withhold the award of points. The use of such surveys alone or in conjunction with video records may be extended to monitoring of employees and other individuals in other types of situations and handling other types of transactions that may extend beyond purchases at check-out counters within stores and elsewhere.

The incentives may be provided at all times or only for or within certain times of the day or during certain days of the week; the times may be withheld from the screeners until later so that there is an incentive for high quality of service at all times. The screening location may be videotaped, so that the video may be reviewed to verify passenger complaints; the video may also be reviewed on a spot check basis by persons reviewing the quality of screening and in conjunction with the determination to award or withhold the award of points. The use of such surveys alone or in conjunction with video records may be extended to monitoring of employees and other individuals in other types of situations and handling other types of transactions that may extend beyond purchases at check-out counters within stores and elsewhere. These methods may be combined or coordinated with other methods described herein.

### Conformity with Laws

Incentives may be provided for adhering to rules, regulations and laws such as speed limits and other traffic laws and for conformity with other desired behavior patterns. For example, average speed between an entry point and an exit point on a toll road may be readily calculated at each exit or at other locations. Points may be awarded to individuals in various ways. For example, participants who maintain an average speed at, near or below a certain threshold or within multiple thresholds, and/or points may be deducted from an account for individuals who may exceed one or more applicable thresholds one time, one time for a certain length of time, repeatedly within prescribed times and in other ways. Points assigned to individuals in existing systems such as points that are assessed to drivers who incur speeding violations may be incorporated into the system directly or indirectly so that even if drivers have accumulated points on their driving record, they may reduce those balances by conforming to prescribed driving requirements and such conduct may result in an adjustment of the background status of individuals.

Incentives may be provided for adhering to established governmental or private rules, regulations, bylaws and laws such as traffic laws, condominium association rules and others. For example, points may be awarded to individuals at various points in time, such as on passing a road location within the speed limit or for maintaining a home in condition mandated by condominium or neighborhood association bylaws, or for maintaining assigned responsibility for neighborhood watch activities including videotaping areas and locations for assistance in coordinated safety efforts, surveillance efforts and other activities by law enforcement and others. Upon attaining a certain account level, the individuals may then redeem points for some type of benefit, which may be contracted for from a third party, or may come from a sponsoring private organization or government. Of course, even a program encouraging adherence to governmental regulation may be administered or underwritten by a private entity that wishes to encourage, for example, safe driving, through the use of a sweepstakes or other redemption method.

Similar to all of these methods described herein, these methods for rewarding conformity to rules, laws, regulations, protocols and the like may be combined and intermingled with other programs described herein. For example, a provider of rewards to members of prepaid legal services plans may provide rewards for members who do not commit violations of laws, rules, etc. within a prescribed time parameter, such as every 6 months may be rewarded. Avoidance of conflicts such as disputes related to transactions such as auctions and others as well as illegal file sharing such as music files and other behavior may be rewarded. Additionally, the provision of legal services or membership in a defined plan for legal services may be provided in a program, possibly on a free or discounted or alternate payment or other favorable or preferred basis. Alternatively, a file sharing network provider or others may provide legal services if participants engage in conduct related to tasks and activities that may be deemed illegal and potentially subject participants to fines and other penalties. Insurance may be provided for such risks, as well. These methods serve the interest of all participants for different reasons. Rewards may be provided for compliance with steps to avoid becoming a victim of a crime or involved in disputes as reduced exposure to ID theft and consequences of identity theft will benefit all participants and others. Rewards for making payments by preferred methods, possibly by or within preferred dates may be included, possibly in a single promotion. These methods may be combined or coordinated with other methods described herein.

### Conformity with Desired Conduct Including Protocols

Incentives for any civic-engagement behavior may be provided. These may be sponsored by foundations, companies, government or others. Behavior to be rewarded may include voting, expressions of opinion, attending community or political meetings, or other conduct evidencing civic engagement.

Such procedures may include submission of various types of reports and documentation, confirming that patients have been advised of certain required information, adhering to protocols for certain situations, and other tasks and activities across other industries may be employed to provide incentives for conforming by participants. For example, professionals in connection with their practices with activities, policies and as determined by employers, clients, insurers and others may be rewarded. Conformity with screening practices and procedures, knowledge of standards and other performance-based factors may be rewarded. Other protocols and guidelines may be established. For example, attorneys who handle medical malpractice cases may be evaluated based on outcomes in cases subject to review, possibly by organizations such as bar associations and others that may assess points as rewards, possibly in the form of performance scores and/or in the form of penalties for negative outcomes in cases that may have been resolved by alternative means such as dispute resolution or others. These methods may be combined or coordinated with other methods described herein.

Points may be awarded on a highly granular basis for particular practices, such as for attorneys to perform such tasks as prompt compliance with requirements for submission of billing records, possibly within preferred accuracy parameters as described herein, devoting time and effort to projects which may not be counted as billable time, such as pro bono or volunteer efforts, and other requirements. These methods may be combined or coordinated with other methods described herein. For example, law firms typically reward attorneys based on numbers of hours billed and billings to clients. An incentive system may be designed to provide rewards to partner and employee attorneys for a wide variety of tasks, such as prompt submission of time records, promptness in reviewing and dispatching bills, performance of internal administrative tasks, participation in bar-related tasks and activities, participation in marketing activities, and other desirable behavior. These methods may be combined or coordinated with other methods described herein. In addition, attorneys and law firms that participate and provide legal services under legal service plans may be rewarded with higher fees and other benefits and rewards in a separate program that targets the provider law firms based on meeting goals such as providing legal services to a prescribed number of participants under legal service plans, possibly without exceeding desired coverage guidelines, among others.

Incentives may be provided for persons within organizations to propose changes or provide suggestions for process improvements that create benefits or eliminate inefficiencies, or to report a failure to abide by proper procedures, even when those suggestions or changes would cost the organization money in the short term to implement, or if the reports of failure may cause a supervisor embarrassment or criticism of job performance. Incentives may be provided directly to employees to report problems and made appropriate suggestions for change. Customers, patients and other observers may also be entitled to participate. Locations such as nursing homes and hospitals could post invitations to participate in such programs. Managers may be provided with an incentive based on the number of expected comments and/or whistle blowing and other reporting incidents. Individuals such as managers who support lower-level employees who report suggestions for immediate outlays or support those who report inefficiencies, waste, fraud and abuse may be rewarded through an incentive rewards program n ways that may translate into direct or indirect financial incentives, job performance assessments, re-evaluation of previously assessed conduct in a retroactive consideration-approach to enable individuals to redeem previous status and others. Reprisals against such lower level employees are discouraged by deducting points and altering existing status, rank, position or other current standing. Points may be awarded to the lower level employees depending on the accuracy and quality of the suggestion or information and/or a change in the status quo leading up to the reporting incident. Observers other than employees may also be awarded points, with appropriate rules to require some level of verification or credibility to reports. These methods may be combined or coordinated with other methods described herein.

In another example, prisons may use points programs with both negative and positive elements to alter behavior of prison guards and by prisoners. This method may be applied to other detention facilities, such as immigration detention and juvenile detention, as well to responsibilities of parolees and those under other restrictions on their movements and activities. Redemption may be through the granting of privileges, such as additional time in recreational areas or more desirable work assignments, entries in system wide programs including sweepstakes drawings and other activities in which benefits may be obtained by participants on a calculated or random basis. These methods may be combined or coordinated with other methods described herein such as access to legal services, tutoring services and others for defined reasons that may generate incentives for conformity to desired behavior within these settings and within other organizations, generally.

### Volunteerism Online and Offline

Programs may also be provided to reward individuals for being available on the internet and elsewhere to provide services that may be desired or required. The services may be needed immediately on request, such as in the manner that physicians have “on call” or “active watch status” and in other ways. The services may be provided in person or remotely, such as by telephone, over the internet, or in other manners. Rewards may be provided for watching anything deemed relevant in any context described herein. Individuals may be rewarded for volunteering to sign up to be on call, possibly for the amount of time spent on call, for the actual availability of the individuals to perform requested task and activities when requested and additional points may be awarded when on active status and in other ways. Any of the foregoing may be events that are considered by an incentive rewards algorithm. By way of example, persons with specific language skills may be on call online or in physical locations such as at hospital emergency rooms, or available to police or other law enforcement personnel. Medical staff or law enforcement contact a program administrator, identify the language skill required, and the administrator may send a message to those on call having the appropriate language skills, for example. Appropriate persons responding are tracked and rewarded. Those persons responding then provide translation services, which may be real-time verbal translations. The translations may be between medical personnel and patients, or between law enforcement personnel and members of the public, for example. These methods may be combined or coordinated with other methods described herein.

### Rewards and Redemption Improvements and Enhancements

The redemption feature of the invention explained in the patent applications incorporated by reference above may also be enhanced within the contexts described herein. Individuals may receive email, phone or instant messages advising of a time-limited and/or geographically specific opportunity to obtain enhanced items of value by redemption. Either offers of points or rewards may be enhanced, or the number of points available may be increased if, for example, an individual redeems points within a certain prescribed time period after issuance of the offer on networks and in other ways. Redemption of points at particular brick and mortar locations, through telephone sales or through Internet retailers and other methods may also result in the award of enhanced quantities of points and enhanced value of points that may be redeemed and enhanced value of prizes that may be awarded.

Redemption for use of automated cash withdrawal, transaction and bill payment technologies may include awards of points that may be redeemed for reduced bill payment amounts, cash or other value.

If an individual is using a device such as a computer, graphics, such as a clock counting down, may be provided as a visual reminder that may indicate the limited opportunity to benefit from enhanced points redemption that may be limited in time.

Coupons or point slips may be issued at existing automated teller machines that may be valid for use in a limited time, such as within an hour, within several hours, or within the same day, at a brick and mortar retail location near the automated teller machine. The coupon may also be for redemption elsewhere.

Formulas may be provided for a wide variety of incentives to participate in such programs. For example, higher rates may be provided to those who are among the first adopters of a program who stay with the program for at least a specified period of time, and first responders in emergency situations. Awards may be enhanced for frequency of participation, the most timely response to a request, the most consistent responses to requests, the greatest improvement in participation over a selected time period, the best performance as determined objectively or subjectively, the most valuable performance as determined objectively or subjectively and other measures.

### Adoption and/or Use of Wireless Payment Technologies

Tasks and activities that are rewarded may include the use of wireless devices, such as cell phones, personal digital assistants, and portable computers with wireless modems, to transfer funds among accounts or to make a purchase, payment independently and/or combined with or other desirable tasks and activities and other methods. Any and all previously described variations and methods relating to the performance of tasks and activities including purchases, payments, time and/or attention spent engaged in interactions including marketing-oriented interactions and all other tasks and activities in every respect including time and the timing of the occurrence of tasks activities and events. In addition, points and prizes and other benefits may or may not expire at specified points if not redeemed in all of the scenarios described herein, a separate person, organization or other entity may be designated to identify the proposed beneficiaries who may be targeted to receive benefits such as from payment card or cell phone use, for example. Limited time frames and other restrictions may be established in this and all of the other described methods to protect the integrity of the program from fraud and abuse.

A further variation, particularly useful to combat identity theft and illegal use of stolen payment cards, is a special class of payment cards that may be created with extra restrictions, extra verification levels and other features for purposes of protecting consumers and assuring them of adequate security and protection. For instance a special “Internet Payment Card” may be created that may be specifically limited to use on the Internet and possibly limited to one or more identified websites on the internet, as well. If desired, one or more of the features of the Internet payment card may be applied in conjunction with a separated purchase/payment approach as described in prior filings. For example, individuals may obtain a purchase code or other identifying feature from a website related to a desired product and before the payment card is authorized, consumers may be required to accomplish one or more additional a steps in a process such as visiting a separate card-sponsored website so that a separate authorization code may be obtained. The payment authorization code related to the particular transaction may be provided to consumers, possibly directly, by email, over the telephone or by other means so that consumers can present the authorization code at the original website where the transaction was originally initiated in order to complete the transaction. These methods may be combined or coordinated with other methods described herein.

### Comments Applicable to All Embodiments

In the context of any programs including any of the incentive programs described above or in any of my prior filings, the following factors may affect the availability and value and type of rewards: (1) Engaging in or viewing or responding to or providing time and attention for any form of advertising and/or marketing interactions of any type; (2) Performance of any desirable tasks or activities of any type including all tasks and activities set forth in previous filings and in any other endeavor including, but not limited to, transferring funds and/or submitting, receiving transmitting or otherwise paying or processing bills, possibly by preferred dates and/or by preferred methods, moving money into accounts, out of accounts, retaining prescribed account balances and other variations, accepting cancelled checks electronically or by performing any other type of task or activity in any desired ways and/or at any desired times and for any reason; (3) Performance of any tasks or activities of any type including maintaining prescribed account balances in any form of account, opening or otherwise maintaining any preferred scribed forms of financial accounts or services, obtaining and/or maintaining insurance of any type, including through a particular provider and particular types of insurance and other services; (4) Earning of credits as described above may entitle participants to entries in sweepstakes and direct discounts and/or percentage discounts that may or may not be available and awarded for prescribed periods of time and for other benefits related to the fees that are otherwise assessed for any products and services that may be offered to anyone for any reason including, but not limited to prepaid legal and/or other professional services; (5) Earning credits in any prescribed ways that may or may not be subject to thresholds before benefits become available to individuals; (6) Earning credits by any prescribed means may entitle the individuals to free or discounted professional services such as legal services, free or discounted legal related tasks and/or activities and/or for free and/or discounted legal related tasks and activities for prescribed periods of time and any other preferred benefits deemed desirable for any reason.

Payment may be made in accordance with the invention using magnetic stripe cards, chip cards, and other traceable or untraceable digital money. These transactions may be accomplished at any time and at any place including a physical commerce location that accepts payment in the form of such digital money, or otherwise.

Points (or the equivalent) may be awarded on a suitable basis, based on such factors as the dollar amount of transactions, the frequency of transactions as well as other factors. In one example, points may be are redeemed for the cost of a plan with a level, periodic payment, such as a membership fee. When the periodic payment is due, all points available may be automatically redeemed, up to the equivalent for the period payment, for example. If the periodic payment amount exceeds the amount for which the points are redeemed, then the account may be is charged to make up the difference. For example, a consumer pays a fee of $9.95 on the first of each month for a legal services plan. In one month, the consumer's point account has 800 points, which may be redeemed on the basis of one cent per point. The consumer's point account is reduced to zero, crediting the consumer with $8.00 of the payment. The remaining $1.95 is charged to the account. It will be appreciated that numerous variations, including on a fee per event payment method for subscriber services such as legal plan subscriptions and others may include a prescribed parameter for provision of legal services such as protection or assistance in dealing with the consequences of identity theft, online transaction protection and others are possible.

The methods of the invention may be applied to any forms of payment now in use, now known but not in use at all or not widely in use, or forms of payment not yet discovered or fully developed. The methods of the invention may be applied to any type of transaction, including purchase, bill payment, loan application, or otherwise, involving the transmission of information or other transactions and/or avoidance of transmission or downloading of music and other data that may be considered improper or illegal. The transmission of information may be over a network of types now in use, now known but not in use at all or not widely in use, or networks not yet discovered or fully developed. The methods may also be applied to any type of transaction, including transactions of types now in use, now known but not in use at all or not widely in use, or transactions not yet discovered or fully developed. Any reference to credit cards or debit cards in this document should be understood as including any and all types of payment cards as well as cardless payment accounts.

Incentives may be provided for a wide variety of conditions on tasks and activities, including combining tasks and activities and other events such as the performance of tasks and activities online or tasks and activities offline, telephone or in-person and other interactions, the performance of tasks at preferred times of day, days of the week, or the like, and possibly on a repeated and regular basis and others.

Incentives may be provided for registration, and initiation or other steps in a registration process or described processes, including but not limited to those that are related to new forms of accounts as described previously and herein. In this variation of the invention, the recorded event is in the nature of performance of various tasks, activities and events such as the process of registration of some type, or of applying for loans, including those that may include rewards programs for timely bill payments and/or with optional limitations such as that only the successful completion of a registration process or approval for a loan results in rewards. The adoption of existing and new forms of accounts, various forms, quantities and types of loans, investment vehicles and/or various forms of fund retention and movement, and/or other financial transactions, and the adoption, use and movement of various forms of credit and the use of money directly and indirectly and others may all be rewarded or considered as factors for rewards. Suitable algorithms may be used to calculate rewards based on any of the above events.

As described previously and herein, incentives in the form of a point program may be combined with methods of the present application to encourage adoption and continued use or participation in programs. For example, repeated use of methods of the invention may be encouraged. Other tasks and activities and events, including downloading of data, documents, interactions and other items over a network may be provided with incentives and may be included.

It will be understood that a wide variety of technologies may be employed for the transmission and display of information. For example, checks and other images may be transmitted as e-mail, displayed on cell phones, PDA's and other devices having such capability, and in other manners.

Any and all methods may be combined with any of the incentives described any of my above-noted co-pending applications. The methods described here may be rewarded directly, or only in combination with the performance of other tasks and activities, or rewards may be increased depending on the particular tasks and activities and numerous combinations of conditions for accumulating points, earning points, and redemption may be envisioned.

The invention may be implemented as a business method or system, and one or more steps in the process may be carried out by computer software, stored on media readable by computer hardware and/or transmitted electronically, running on computer hardware and containing instructions causing the hardware to execute the steps of the method. The invention may also be embodied in a computer system having means, in the form of computer hardware and software, for accomplishing the steps of the method.

It will be appreciated that the foregoing inventions may be implemented in a wide variety of technologies, including technologies not yet commercially available and not yet developed. These methods may be combined or coordinated with other methods described herein. All forms of incentives may be awarded in all of the various described methods including discounts on related and unrelated services, sweepstakes entries, redeemable points and all other items of value and all other forms that may be deemed valuable now or in the future.

The invention has been described with respect to an exemplary method, but variations within the scope and spirit of the invention will be apparent to those of skill in the art, and the invention is not limited to any exemplary method described herein.

What is claimed is:

1. A method for altering behavior involving events related to the use of assets, comprising the steps of:
recording information associated with a first event related to the use of an asset and a first identified individual associated with said first event; determining a status of said first event in connection with a rewards algorithm, and calculating reward information in accordance with the rewards algorithm, and notifying the identified first individual of the calculated reward information.

2. The method of claim 1, wherein said first event is a payment of money, said payment of money occurs a selected time prior to use of resources, and the algorithm bases a reward on the length of the selected time.

3. The method of claim 1, further comprising the steps of: recording information associated with a second event related to the use of a second asset and a second identified individual associated with the second event, determining a status of the second event in accordance with the rewards algorithm, calculating rewards information in accordance with the incentive algorithm, the status of the first event and the status of the second event, and storing the calculated rewards information.

4. The method of claim 3, wherein the first asset and the second asset are money.

5. The method of claim 1, wherein the first event pertains to movement of the first asset.

6. The method of claim 5, wherein the first asset comprises money.

7. The method of claim 5, wherein said algorithm requires use of a selected transmitting agency.

8. The method of claim 6, wherein said event is accomplished using electronic transmissions.

9. The method of claim 6, wherein said algorithm provides for increased awards for repeated use of the selected funds transmitting agency.

10. The method of claim 5, wherein said event comprises a transfer of money from an individual in a first location to a recipient in a second location.

11. The method of claim 1, wherein the first asset comprises money, and the event relates to retention of money.

12. The method of claim 11, wherein the event comprises the purchase of an electronic funds item.

13. The method of claim 11, wherein the event comprises the use of the electronic funds item in connection with a purchase.

14. A method of providing accelerated payment accounts, comprising the steps of: receiving a selection of an accelerated or conventional account from a customer; providing enhanced benefits to a customer, and requiring preferential payment conditions based on a selection of an accelerated account, and providing standard benefits and requiring conventional payment conditions based on selection of a conventional account.

15. The method of claim 14, wherein the preferential payment conditions comprise a due date earlier than a due date in a conventional payment account.

16. A method for entering into a transaction, comprising the steps of receiving first transaction request information from a transaction party in a first mode, prompting the transaction party for second transaction request information to be provided in a second mode, if the second transaction information is received in a suitable manner, then entering into the transaction, and otherwise terminating the transaction.

17. The method of claim 16, wherein said first mode is a first communications medium, and said second mode is a second communications medium.

18. The method of claim 17, wherein said first communications medium comprises a computer network, and second communications medium comprises a telephone network.

19. The method of claim 17, wherein said second mode comprises an interaction at a physical commerce location.

20. The method of claim 16, wherein said second transaction information comprises payment information.

21. The method of claim 16, wherein said step of prompting comprises identifying one or more physical commerce locations.

22. A method of providing incentives for events related to a status of an account, comprising the steps of: recording information associated with an event related to a status of an account, determining a status of the event in connection with a rewards algorithm, calculating reward information in accordance with the rewards algorithm, and storing the calculated reward information.

23. A method for providing incentives for adoption and/or use of currency, comprising the steps of recording information associated with an event related to the transfer of money and an individual associated with said event, determining a form of currency employed in connection with the event, calculating reward information in accordance with a rewards algorithm, the rewards algorithm employing as a factor the form of currency.

24. The method of claim 23, wherein said factor comprises a use of digital currency.

25. The method of claim 23, wherein said factor comprises a use of a selected legal currency.

26. A method for providing incentives for use of selected procedures for reporting of events, comprising the steps of recording information associated with an event, determining a status of the event with respect to an incentive algorithm, calculating reward information in accordance with the incentive algorithm, and storing the calculated reward information.

27. The method of claim 26, wherein said event is a bill payment.

28. The method of claim 26, wherein said incentive algorithm includes bill format factors.

29. The method of claim 26, wherein said incentive algorithm includes timing factors.

30. The method of claim 27, wherein said incentive algorithm includes bill payment manner factors.

31. A method of providing incentives for events related to use of resources of an organization, comprising the steps of: receiving a request for use of resources of an organization from an individual, providing a marketing presentation to the individual, and only providing the requested resource after completion of the marketing presentation.

32. The method of claim 31, wherein the resource is time of a live telephone representative.

33. A method for providing incentives for events related to securities-related transactions, comprising the steps of: recording information associated with an event related to a securities-related transaction and an identified individual associated with said event; determining a status of the event in connection with an incentive algorithm, calculating rewards information in accordance with the incentive algorithm, and storing the calculated incentive information.

34. The method of claim 33, wherein said event is related to a transfer of rights in securities.

35. The method of claim 33, wherein said event is related to trading indexes.

36. A method of providing incentives relating to third party behavior in connection with a transaction between a first party and a second party, comprising the steps of: recording information relating to the transaction, determining a status of the recorded information in connection with an incentive algorithm, calculating incentive information in accordance with the status and the incentive algorithm, and storing the calculated incentive information.

37. The method of claim 36, wherein the transaction comprises a loan, the first party is a lender, the second party is a borrower and purchaser, the third party is a seller, and the information comprises manner of loan processing agreed upon the purchaser.

38. The method of claim 37, wherein said manner of loan processing is a manner of loan acquisition.

39. The method of claim 37, wherein said manner of loan processing is a manner of loan repayment.

40. The method of claim 39, wherein the manner of loan repayment is periodic electronic transfer.

41. The method of claim 40, wherein a factor in the algorithm is the timing of the periodic transfer.

42. A method for providing incentives to participants in a services plan, comprising the steps of: recording information relating to an event associated with the services plan, determining a status of the recorded information in connection with an incentive algorithm, calculating incentive information in accordance with the status and the incentive algorithm, and storing the calculated incentive information.

43. The method of claim 42, wherein, in accordance with the algorithm, incentives are provided for increasing length of continuous time periods of membership.

44. The method of claim 42, wherein the services plan is for professional services.

45. The method of claim 44, wherein the professional services comprise legal services.

46. The method of claim 42, wherein, in accordance with the algorithm, incentives are provided for avoiding use of resources of the services plan.

47. A method for providing incentives related to events, comprising the steps of recording information related to an event, determining a status of the recorded information in connection with an incentive algorithm, calculating incentive information in accordance with the status and the incentive algorithm, storing the calculated incentive information, and providing a reward based on calculated incentive information, wherein the reward is in the nature of services provided with preferences compared to standard services.

48. The method of claim 47, wherein the services are provided at no cost.

49. The method of claim 47, wherein the services are in the nature of professional services.

50. The method of claim 49, wherein the professional services are in the nature of legal services.

51. The method of claim 47, wherein the services are provided in the form of a services plan.

52. The method of claim 51, wherein services furnished through the services plan comprise global change to identity theft-related services.

53. The method of claim 52, wherein the identity theft-related global change services comprise identity-theft prevention services.

54. The method of claim 52, wherein the identity theft-related services comprise identity theft recovery services.

55. The method of claim 52, wherein the identity theft recovery services comprise legal services.

56. The method of claim 47, wherein the reward in the nature of services is in the nature of a specified activity.

57. The method of claim 52, where in an incentive is provided to minimize use of said identity theft-related services.

58. A method of providing an incentive to enter into a business relationship comprising the steps of offering a business relationship and identity theft-related services simultaneously.

59. The method of claim 58, further comprising the step of entering into the business relationship and making the identity theft-related services available in response to an acceptance.

60. The method of claim 59, wherein the identity theft-related services comprise identity-theft prevention services.

61. The method of claim 59, wherein the identity-theft services comprise identity-theft recovery services.

62. The method of claim 59, wherein the identity-theft recovery services comprise legal services.

63. The method of claim 59, wherein the business relationship comprises real estate price insurance related services.

64. The method of claim 59, wherein the step of offering identity theft-related services comprising offering the identity theft related services for use in relation to identity theft-related events that may arise out of the business relationship.

65. The method of claim 58, wherein the business relationship is an employment relationship.

66. The method of claim 58, wherein the business relationship is an interaction at a website.

67. The method of claim 58, wherein the identity theft-related services are available for purchase on a per event basis.

68. A method of providing services to business, comprising the steps of: providing to a business, in exchange for consideration, legal representation in connection with claims related to allegations of loss of personal information of individuals by the business, the amount of consideration being determined at the commencement of a defined period of providing service.

69. A method for providing incentives related to events in connection with services of an intermediary to transactions, comprising the steps of recording information related to an event in connection with services of an intermediary to transactions, determining a status of the recorded information in connection with an incentive algorithm, calculating incentive information in accordance with the status and the incentive algorithm, and storing the calculated incentive information.

70. The method of claim 69, wherein the services of an intermediary related to transactions comprise online auction services.

71. The method of claim 70, wherein incentives are provided for placing items for bid.

72. The method of claim 70, wherein incentives are provided for placing successful bids.

73. The method of claim 70, further comprising the steps of providing a reward in accordance with the calculated incentive information, the reward being in the nature of online dispute resolution services.

74. The method of claim 70, further comprising the steps of providing a reward in accordance with the calculated incentive information, the reward being in the nature of legal services.

75. A method for providing incentives related to consent obtained from an individual, comprising the steps of: recording information related to an event pertaining to monitoring of conduct of an individual, determining a status of the recorded information in connection with an incentive algorithm, calculating incentive information in accordance with the status and the incentive algorithm, and storing the calculated incentive information.

76. The method of claim 75, wherein the event comprises a waiver of privacy of information submitted via a communications network.

77. The method of claim 75, wherein the event comprises agreeing to monitoring of location of an individual.

78. The method of claim 75, wherein the event comprises agreeing to monitoring of location of a vehicle.

79. The method of claim 75, wherein the event comprises consent to a waiver of certain legal rights.

80. The method of claim 79, wherein the event comprises a waiver of a right to bring a lawsuit.

81. A method for providing incentives related to in-vehicle communications systems, comprising the steps of: recording information relating to an event pertaining to in-vehicle communications systems, determining a status of the recorded information in connection with an incentive algorithm, calculating incentive information in accordance with the status and the incentive algorithm, and storing the calculated incentive information.

82. The method of claim 81, wherein the event relates to the providing of marketing information to a recipient via an in-vehicle communications system.

83. The method of claim 81, wherein the event relates to a response to an invitation to visit a physical commerce location communicated via an in-vehicle communications system.

84. The method of claim 81, further comprising the step of providing rewards based on the calculated incentive information, wherein the reward comprises receipt of preferred customer service.

85. The method of claim 81, wherein the incentive algorithm employs as a factor vehicle model information.

86. The method of claim 83, wherein the incentive algorithm employs as a factor a time of the response.

87. A method for providing targeted offers, comprising the steps of: receiving a request related to geographical information, providing responsive geographical information, identifying a business having physical proximity to the responsive geographical information, and providing an offer associated with the provided responsive geographical information and pertaining to the identified business.

88. The method of claim 87, wherein the request is for travel services.

89. The method of claim 87, further comprising the steps of providing identifying information associated with the offer, and providing the business with the identifying information, whereby the business can confirm the offer.

90. The method of claim 87, wherein the offer is limited in time based on the time of the request.

91. A method of providing incentives related to energy, comprising the steps of: recording information relating to an event pertaining to energy, determining a status of the recorded information in connection with an incentive algorithm, calculating incentive information in accordance with the status and the incentive algorithm, and storing the calculated incentive information.

92. The method of claim 91, wherein said event pertains to energy consumption.

93. The method of claim 92, wherein said event pertains to modification in energy consumption.

94. The method of claim 91, wherein the event comprises the use of energy-efficient technology.

95. The method of claim 94, wherein the event comprises the consumption of energy from one or more renewable sources.

96. The method of claim 91, wherein the event comprises the timing of the consumption of energy.

97. A method of providing incentives associated with access to an electronic database, comprising the steps of recording information relating to an event pertaining to access to an electronic database, determining a status of the recorded information in connection with an incentive algorithm, calculating incentive information in accordance with the status and the incentive algorithm, and storing the calculated incentive information.

98. The method of claim 97, wherein said event comprises payment of charges for the access to an electronic database.

99. The method of claim 98, wherein said incentive algorithm provides an incentive based on timing of the payment.

100. The method of claim 97, wherein the event comprises a search request submitted to the electronic database.

101. The method of claim 97, wherein the event comprises a search result received from the electronic database.

102. A method for providing offers targeted to potential customers, comprising the steps of: receiving from a potential customer a request pertaining to products or services, determining, in accordance with an algorithm, an offer, and communicating the offer to the potential customer.

103. The method of claim 102, further comprising the step of, prior to said step of determining an offer, receiving personal information from the potential customer.

104. The method of claim 102, further comprising the step of, prior to said step of determining an offer, providing advertising information to the potential customer.

105. The method of claim 102, further comprising, prior to said step of determining an offer, receiving identification information from the potential customer, identifying the potential customer, and employing in the algorithm stored data associated with the potential customer.

106. The method of claim 102, wherein said step of determining an offer comprises the step of determining a plurality of offers, said offers provided by a plurality of offerors.

107. The method of claim 100, wherein said offer comprises conditions of acceptance within a defined time period.

108. A method of providing incentives for forwarding of electronic information, comprising the steps of: recording an event related to the forwarding of electronic information, determining the status of the event in connection with an incentive algorithm, calculating an incentive amount based on the status and the incentive algorithm, and recording the calculated incentive amount.

109. The method of claim 108, wherein the electronic information is in the form of an e-mail message.

110. The method of claim 109, wherein the incentive algorithm in calculating an incentive amount for a first individual, considers an event in the nature of performance by a recipient of an e-mail from the first individual.

111. A method of providing incentives for events related to delivery services, comprising the steps of: recording information associated with an event related to a delivery, determining a status of the event in connection with an incentive algorithm, and calculating incentive information in accordance with the incentive algorithm, and storing the calculated incentive information.

112. The method of claim 111, wherein said delivery service comprises delivery of physical documents.

113. A method of providing incentives for events related to the electronic transmission of documents, comprising the steps of: recording information associated with an event related to a transmission of an electronic document, determining a status of the event in connection with an incentive algorithm, calculating incentive information in accordance with the incentive algorithm, and storing the calculated incentive information.

114. The method of claim 113, wherein, in accordance with the incentive algorithm, the use of an enhancement to the transmission results in positive incentive results.

115. The method of claim 114, wherein at least said enhancement relates to use of security in connection with the transmission.

116. A method of providing incentives for events related to documents, comprising the steps of: recording information associated with an event related to a document, determining a status of the event in connection with an incentive algorithm, calculating incentive information in accordance with the incentive algorithm, and storing the calculated incentive information.

117. The method of claim 116, wherein said recorded information comprises format information.

118. The method of claim 116, wherein the documents comprise checks, and the format comprises making a record of check activity available electronically to account holders for review.

119. The method of claim 116, wherein the documents comprise statements provided by a financial services provider to a customer, and the format comprises making the statements available electronically to the customer for review.

120. The method of claim 116, wherein the event is in the nature of services related to a document.

121. The method of claim 114, wherein the event comprises preparation of the document.

122. The method of claim 114, wherein the event comprises authentication of the document.

123. The method of claim 116, wherein the event comprises receipt of the document.

124. A method of providing incentives for the sending of text messages for display, comprising the steps of: recording an event related to the sending of a text message intended for visual display to multiple simultaneous viewers, determining the status of the event with respect to an incentive algorithm, calculating an incentive amount based on the status and the incentive algorithm, and recording the calculated incentive amount.

125. The method of claim 124, wherein the event relates to sending text messages from a wireless device for display in connection with a television broadcast.

126. The method of claim 125, wherein the incentive algorithm comprises factors comprising the number of messages sent.

127. A method of providing incentives for performance, comprising the steps of: enrolling an individual in an incentive rewards program having a rewards account, providing the individual with an initial incentive reward in the rewards account prior to performance by the individual in connection with the incentive rewards program, notifying the individual that the initial incentive reward may be redeemed only upon performance in accordance with selected requirements, and making the initial incentive reward available for redemption only upon performance in accordance with the selected requirements.

128. A method of providing incentives for performance, comprising the steps of: determining if the individual has a preferred status based upon selected criteria, and enrolling an individual in an incentive rewards program only if the individual has been determined to possess a product having certain characteristics.

129. The method of claim 128, wherein the product characteristics comprise model and age.

130. A method of providing services, comprising the steps of: providing services, comprising the steps of receiving a right from a celebrity to associate the celebrity with the services, providing services associated with the celebrity, and providing incentive rewards program based on events associated with the service.

131. The method of claim 130, wherein rewards provided by said program may be redeemed for products and services associated with the celebrity.

132. The method of claim 131, wherein the products and services associated with the celebrity comprise preferred access to tickets to events featuring the celebrity.

133. The method of claim 130, wherein the service is a payment card service.

134. A method of providing incentives related to membership programs encouraging active participation by users, comprising the steps of: recording an event related to membership in the program, determining the status of the event in connection with an incentive algorithm, calculating an incentive amount based on the status and the incentive algorithm, and recording the calculated incentive amount.

135. A method of providing incentives related to health and fitness goals, comprising the steps of: recording an event related to health and fitness activity, determining the status of the event in connection with an incentive algorithm, calculating an incentive amount based on the status and the incentive algorithm, and recording the calculated incentive amount.

136. A method for providing incentives for volunteers to assist public agencies, comprising the steps of: recording an event pertaining to assistance by a volunteer to a public agency, determining the status of the event in accordance with an incentive algorithm, calculating an incentive in accordance with the incentive algorithm, and storing the calculated incentive.

137. The method of claim 136, wherein the event is an act of monitoring in accordance with instructions of a law enforcement agency.

138. The method of claim 136, wherein the act of monitoring is conducted simultaneously with actions of a plurality of volunteers.

139. The method of claim 136, wherein the event comprises responding to instructions during an emergency.

140. A method for providing incentives for inspectors, comprising the steps of: recording an event relating to the activities of an inspector, determining the status of the event in accordance with an incentive algorithm, calculating an incentive amount based on the event and the algorithm, and recording the calculated incentive amount.

141. The method of claim 140, wherein the event is the identification of a prohibited item.

142. The method of claim 140, wherein the event is treatment of persons inspected, and the algorithm includes a factor for whether treatment is in accordance with established procedures.

143. The method of claim 140, wherein the event is the identification of a person sought for law enforcement purposes.

144. The method of claim 140, wherein a level of security alert is a factor in the incentive algorithm.

145. The method of claim 140, wherein the calculated incentive amount is recorded in an account for a team of inspectors.

146. A method for providing incentives related to events pertaining to conformity with regulations, comprising the steps of: recording information related to an event subject to one or more regulations, determining a status of the recorded information in connection with an incentive algorithm, calculating incentive information in accordance with the status and the incentive information, and storing the calculated incentive information.

147. The method of claim 146, wherein the regulations comprise laws.

148. The method of claim 146, wherein the regulations comprise condominium association regulations.

149. The method of claim 146, further comprising the step of providing a reward based on the calculated incentive information, wherein the reward comprises access to a legal services plan at no cost or reduced cost.

150. A method of providing incentives for adhering to rules within an organization, comprising the steps of: recording an event related to rules within an organization, determining the status of the event in connection with an incentive algorithm, calculating an incentive amount based on the status and the incentive algorithm, and recording the calculated incentive amount.

151. The method of claim 150, wherein the event is in the nature of the use of resources of the organization.

152. The method of claim 151, wherein the use of resources is an inefficient use.

153. The method of claim 150, wherein the event is in the nature of conformity to rules of a penal institution.

154. The method of claim 150, wherein the event is in the nature of a report of avoidance of misconduct.

155. A method for providing incentives to individuals to make themselves available to provide volunteer services upon request, comprising the steps of: recording an event relating to an individual making himself available to provide volunteer services upon request, determining a status of the event in accordance with an incentive algorithm, calculating incentive information in accordance with the incentive algorithm, and storing the calculated incentive information.

156. The method of claim 155, wherein the event comprises an agreement of the individual to make himself available.

157. The method of claim 156 wherein the event comprises being available to provide volunteer services upon request for a specified time period.

158. The method of claim 156, wherein the event comprises being available to provide real-time translation services for a medical facility.
